(19) United States
(12) Patent Application Publication
(10) Pub. No.: US 2020/0369547 A1
(43) Pub. Date: Nov. 26, 2020

(54) Systems, methods and Apparatuses for Water Treatment

(71) Applicant: Econse Water Purification Systems Inc., Toronto (CA)

(72) Inventors: Derek Davy, Toronto (CA); Andrew Hooshang Amiri, North Yorh (CA); Alan Neil Sosebee, Youngsville, NC (US)

(21) Appl. No.: 16/623,520

(22) PCT Filed: Jun. 29, 2018
(86) PCT No.: PCT/CA2018/050805

§ 371 Date: Dec. 17, 2019

Related U.S. Application Data
(60) Provisional application No. 62/527,111, filed on Jun. 30, 2017.

(51) Int. Cl. C02F 9/00; C02F 1/38; C02F 1/44; C02F 1/461; C02F 1/463; C02F 1/465; C02F 1/467; C02F 3/30

(52) U.S. Cl. CPC C02F 9/00; C02F 1/38; C02F 1/441; C02F 1/46176; C02F 2103/32; C02F 1/465; C02F 1/4672; C02F 1/4676; C02F 3/30; C02F 1/463

(57) ABSTRACT

A system for treating an effluent stream from a food production facility may include a first reactor unit including a first reactor tank and an electrical treatment reactor that is fluidly connected to the first reactor tank. When the reactor assembly is in use the effluent may travel along a reactor circulation flow path in which effluent is drawn from the first tank, flows through the electrical treatment reactor and is subjected to an electrical charge and then returns to the first tank, whereby a reaction initiated in the effluent by the electrical charge within the electrical treatment reactor continues when the effluent is returned to the first tank. A second processing unit may be downstream from the first reactor unit to receive the partially treated effluent stream and configured to further process the partially treated effluent.

### CROSS-REFERENCE TO RELATED APPLICATION

This application claims the benefit of 35 USC 119 based on the priority of co-pending U.S. Provisional Patent Application No. 62/527,111, filed Jun. 30, 2017 and entitled Systems, Methods and Apparatuses for Water Treatment, which is incorporated herein in its entirety by reference.

### FIELD

The present subject matter of the teachings described herein relates generally to systems, methods and apparatuses for treating water and other liquids.

### BACKGROUND

US Patent Publication No. 2011/0315561 discloses a method for treating a liquid to be treated stream containing organic material or inorganic material comprising passing the liquid to be treated stream to an anode or a cathode of a bioelectrochemical system to thereby alter the pH of the liquid to be treated stream to: a) reduce the pH of the stream passed to the anode to minimize or suppress precipitation of dissolved cations; or b) increase the pH of the stream passed to the cathode to produce an alkaline stream; or c) reduce the pH of the stream passed to the anode to produce an acid containing stream. In one embodiment, a caustic soda solution is produced at the cathode and recovered for storage and subsequent use.

U.S. Pat. No. 8,828,240 (Schranze) discloses a method to purify water and includes the steps of providing a septic tank to hold unpurified water and having an outlet to provide a water stream for processing, and processing the water in an electrocoagulation and flocculation reactor that uses electrical energy to convert dissolved solid material in the water stream into suspended particulate form that can be subsequently filtered and separated out. The method continues with introducing air into the water stream to promote aerobic processing of contaminants and to assist in agglomeration and flocculation of suspended solid material, filtering the water stream to separate suspended solid material from the stream and to adsorb some of its dissolved contaminants, and processing the water stream with a reverse osmosis processor that provides a reject stream that provides water back to the septic tank and a recycle stream that provides unpurified water back to the water stream exiting the septic tank.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

Referring to one broad aspect of the teachings disclosed herein, a water treatment system may include a balancing unit. The balancing unit may contain a large volume of water relative to what is flowing in and out.

In accordance with another broad aspect of the teaching described herein, a system for treating liquid to be treated from a source can include a first processing unit. The first processing unit may include at least a first holding tank having a first tank inlet for receiving an incoming stream of liquid to be treated and preferably a first mechanical separator configured to separate solid particles from the liquid to be treated flowing through the mechanical separator. The first mechanical separator may be fluidly connected to the first holding tank via a first flow path whereby the liquid to be treated can circulate between the first holding tank and the first mechanical separator along the first flow path. A first electrical treatment apparatus may be operable to apply an electric charge to the liquid to be treated flowing through the first electrical treatment apparatus thereby converting incoming organic molecules in the liquid to be treated into intermediate organic molecules. The first electrical treatment apparatus may be fluidly connected to a first holding tank via a second flow path whereby the liquid to be treated can circulate between the first holding tank and the electrical treatment apparatus along the first flow path. A second processing unit may be downstream from the first processing unit and may include at least a second holding tank for receiving the liquid to be treated containing the intermediate organic molecules from the first processing unit and at least a first biological processing unit in fluid communication with the second holding tank via a third flow path whereby the liquid to be treated containing the intermediate organic molecules can circulate between the second holding tank and the first biological processing unit. The biological processing unit may be operable to breakdown the intermediate organic molecules via at least one of aerobic and anaerobic digestion to produce a treated output stream. The output liquid may be recycled through any or all of the processing units multiple times throughout the process and may be allowed to settle in one or more holding tanks throughout the process so as to facilitate precipitation of undesirable particles out of the liquid after treatment.

The first electrical treatment apparatus may include an electrolysis reactor that is operable to subject the liquid to be treated to electrolysis.

The electrolysis reactor may include a housing having a lower end, an upper end spaced apart from the lower end along a reactor axis, and a sidewall extending therebetween. A reactor inlet through which the liquid to be treated can enter the electrolysis reactor may be provided at the lower end and a reactor outlet through which the liquid to be treated can exit the electrolysis reactor may be provided at the upper end whereby the liquid to be treated flows generally upwardly through the electrolysis reactor when in use. As already recited, the present invention may aim to facilitate linear motion of the liquid.

Liquid to be treated entering the electrolysis reactor via the reactor inlet may travel substantially in the axial direction.

The sidewall may include an upper portion having a generally constant cross-sectional area and a tapered portion disposed toward the lower end and generally expanding from the reactor inlet toward the upper portion.

Liquid that has been treated exiting the electrolysis reactor via the reactor outlet may travel in a generally radial direction that is orthogonal to the reactor axis.

The reactor outlet may be provided in the upper portion of the sidewall.

When the electrolysis reactor is in use the reactor axis may be inclined relative to the horizontal direction by a reactor angle that is between about 20 degrees and about 70 degrees, and may be between about 30 and 60 degrees and may be 45 degrees.

The electrolysis reactor may include a galvanic cell that is removably mounted to the second end of the housing and that includes a cathode assembly and an anode assembly. When the galvanic cell is mounted to the second end of the housing the cathode assembly and anode assembly may be positioned within the housing and when the galvanic cell is removed the cathode assembly and anode assembly may be removed from the housing.

The galvanic cell may be removable from the housing without reconfiguring the reactor inlet or reactor outlet.

The galvanic cell may include an axially extending cathode sleeve and a plurality of axially extending anode rods positioned around an optional axially extending central cathode rod itself positioned within the cathode sleeve within an annular region defined between the cathode rod and an inner surface of the cathode sleeve and spaced apart from each other.

The galvanic cell may include a flow directing surface which, when the galvanic cell is mounted to the housing, faces the reactor inlet and is configured to direct the flow of the liquid to be treated entering the reactor inlet into the annular region in a laminar manner.

The flow directing surface may include a generally convex, dome-shaped tip of the central cathode rod.

The first mechanical separator may include at least one hydrocyclone configured to separate solid particles from the liquid to be treated.

The biological processing unit may be operable to break down the intermediate organic molecules using a combination of both aerobic and anaerobic digestion.

The first flow path may be at least partially separate from the second flow path, whereby liquid to be treated circulating through the first flow path travels between the first holding tank and the mechanical separator without passing through the first electrical treatment apparatus, and liquid to be treated circulating through the second flow path travels between the first holding tank and the first electrical treatment apparatus without passing through the mechanical separator

A changeover apparatus may be operable to selectably direct the liquid to be treated through the first flow path or the second flow path.

A balancing tank may be located upstream from the first processing unit and may have a balancing inlet configured to receive the liquid to be treated from the source and a balancing outlet fluidly connected to the first tank inlet to transfer the liquid to be treated from the balancing tank to the first holding tank.

The first processing unit further may include a sludge removal apparatus fluidly connected to a lower end of the first holding tank to extract sludge from the lower end of the first holding tank.

A second electrical treatment apparatus may be provided in the second flow path and may be operable to apply an electric charge to the liquid to be treated flowing through the second electrical treatment apparatus thereby converting incoming organic molecules in the liquid to be treated into intermediate organic molecules.

The second electrical treatment apparatus may be arranged in parallel with the first electrical treatment apparatus.

In accordance with another broad aspect of the teachings described herein, an electrolysis reactor may include a housing having a lower end, an upper end spaced apart from the lower end along a reactor axis, and a sidewall extending therebetween. A reactor inlet through which the liquid to be treated can enter the electrolysis reactor may be provided at the lower end. A reactor outlet through which the liquid can exit the electrolysis reactor may be provided at the upper end whereby the liquid to be treated flows generally upwardly through the electrolysis reactor when in use. A galvanic cell may be positionable within the housing to subject the liquid to electrolysis.

Liquid to be treated entering the electrolysis reactor via the reactor inlet may travel substantially in the axial direction.

The sidewall may have an upper portion having a generally constant cross-sectional area and a tapered portion disposed toward the lower end and generally expanding from the reactor inlet toward the upper portion.

Liquid to be treated exiting the electrolysis reactor via the reactor outlet may travel in a generally radial direction that is orthogonal to the reactor axis.

The reactor outlet may be provided in the sidewall.

When the electrolysis reactor is in use the reactor axis may be inclined relative to the horizontal direction by a reactor angle that is between about 20 degrees and about 70 degrees, and may be between about 30 and 60 degrees and may be 45 degrees.

The galvanic cell may be removably mounted to the second end of the housing and may include a cathode assembly and an anode assembly. When the galvanic cell is mounted to the second end of the housing the cathode assembly and anode assembly may be positioned within the housing and when the galvanic cell is removed the cathode assembly and anode assembly may be removed from the housing.

The galvanic cell may be removable from the housing without reconfiguring the reactor inlet or reactor outlet.

The galvanic cell may include an axially extending cathode sleeve and a plurality of axially extending anode rods positioned around an optional axially extending central cathode rod itself positioned within the cathode sleeve within an annular region defined between the cathode rod and an inner surface of the cathode sleeve and spaced apart from each other.

The cathode sleeve may have an open lower end that is positionable proximate the reactor inlet and through which the liquid to be treated can flow into the annular space, and a sleeve outlet port that is positionable proximate the reactor outlet and through which the liquid can flow out of the annular space.

The galvanic cell may include a flow directing surface which, when the galvanic cell is mounted to the housing, faces the reactor inlet and directs the flow of the liquid to be treated entering the reactor inlet into the annular region in a substantially laminar manner.

The central cathode rod may have a length in the axial direction and each of the anode rods may have respective lengths in the axial direction that are less than the length of the central cathode rod.

The flow directing surface may include a generally convex, dome-shaped tip of the central cathode rod.

The flow directing surface may be axially spaced between the anode rods and a lower end of the cathode sleeve.

In accordance with another broad aspect of the teachings described herein, a system for treating an effluent stream from a food production facility may include a first reactor unit with a first reactor tank having a tank inlet for receiving an incoming stream of effluent containing at least one of a variety of contaminants. These contaminants may include long-chain organic molecules, cleaning chemicals, yeasts, plant material, and other substances base organic molecules. The tank may have an interior for holding a volume of effluent, and an electrical treatment reactor that is fluidly connected to the first reactor tank, whereby when the reactor assembly is in use the effluent may travel along a reactor circulation flow path in which effluent may be drawn from the first tank, may flow through the electrical treatment reactor and may be subjected to an electrical charge to breakdown the base organic molecules into intermediate organic molecules. The effluent may then return to the first tank, whereby a reaction initiated in the effluent by the electrical charge within the electrical treatment reactor may continue when the effluent is returned to the first tank, wherein a partially treated effluent stream containing the intermediate organic molecules exits the first reactor unit. The system may further include a second processing unit downstream from the first reactor unit to receive the partially treated effluent stream. This second processing unit may be configured to further process the partially treated effluent to eliminate at least a portion of the intermediate organic molecules thereby producing a treated output stream.

The effluent may travel through the reactor circulation flow path at least twice before exiting the first reactor unit.

The effluent may be circulated through the reactor circulation flow path for at least 15 minutes before exiting the first reactor unit.

The reactor circulation flow path may be free from physical filter media.

The second processing unit may comprise a biological treatment unit configured to process the partially treated effluent stream via at least one of aerobic and anaerobic digestion to produce the treated output stream.

The biological treatment unit may comprise at least a second holding tank for receiving the partially treated stream and at least a first biological reactor in fluid communication with the second holding tank via a bio flow path whereby the partially treated stream can circulate between the second holding tank and the first biological reactor.

The second processing unit may comprise a reverse osmosis apparatus.

The system may further comprise at least a first mechanical separator configured to separate solid particles from the incoming stream of effluent flowing through the mechanical separator before the effluent flows into the electrical treatment unit.

The first mechanical separator may be fluidly connected to the first reactor tank via a mechanical flow path whereby the effluent can circulate between the first holding tank and the first mechanical separator along the mechanical flow path.

The effluent may circulate through the mechanical flow path, and the first mechanical separator therein, at least twice before flowing into the electrical treatment unit.

The first mechanical separator may comprise a hydrocyclone apparatus.

Effluent circulating through the mechanical flow path may travel between the first reactor tank and the first mechanical separator without passing through the electrical treatment reactor, and effluent circulating through the reactor circulation flow path may travel between the first reactor tank and the electrical treatment reactor without passing through the first mechanical separator.

The system may further comprise a changeover apparatus operable to selectably direct the effluent through the mechanical flow path or the reactor circulation flow path.

The system may further include a balancing tank located upstream from the first reactor unit and may have a balancing inlet configured to receive the effluent from the food production facility and a balancing outlet fluidly connected to the first reactor tank to transfer the effluent from the balancing tank to the first reactor tank.

The first reactor unit may further comprise a sludge removal apparatus fluidly connected to a lower end of the first reactor tank to extract sludge from the lower end of the first reactor tank.

The system may further comprise a second electrical treatment reactor provided in the reactor circulation flow path and operable to apply an electric charge to the effluent flowing through the second electrical treatment reactor.

The second electrical treatment reactor may be fluidly connected in parallel with the first electrical treatment reactor.

The electrical treatment reactor may comprise: a housing having a lower end, an upper end spaced apart from the lower end along a reactor axis, and a sidewall extending therebetween; a reactor inlet provided toward the lower end and through which effluent can enter the housing, the reactor inlet being in fluid communication with the first tank interior to receive effluent from the first tank; a reactor outlet provided toward the upper end through which effluent can exit the housing, whereby the effluent flows generally axially through the housing from the lower end to the upper end, the reactor outlet being in fluid communication with the tank to return effluent to the first tank; and a galvanic cell positionable at least partially axially between the reactor inlet and the reactor outlet within the housing to subject the liquid within the housing to the electrical charge, the galvanic cell comprising an elongate, axially extending cathode assembly and an anode assembly including at least one elongate, axially extending anode rod that is positioned generally parallel to and laterally spaced apart from the cathode assembly, wherein the anode assembly is at least partially consumed when the reactor is in use

The incoming effluent stream may comprise organic or inorganic molecules or polymers and the first reactor unit may be configured to convert these molecules via any of the following processes: electro-oxidation, electro-reduction, electro-flotation, electrocoagulation, electro-crystalization, or electrolysis.

The system may be configured to process at least 10 m³/d of effluent and covers an area of less than 9 m².

The liquid may circulate through the reactor circulation flow path at least twice during an electrical treatment sub-cycle.

The electrical treatment sub-cycle may have a duration of about 15 minutes.

The reaction initiated by exposure to the electrical charge within the water treatment reactor may continue to completion while the liquid is in the tank.

The reaction initiated by exposure to the electrical charge within the water treatment reactor may comprise an electrocoagulation reaction configured to induce coagulation of particles within the liquid and coagulated particles may settle within the tank.

The system may further comprise a first mechanical separator configured to separate solid particles from the liquid flowing through the mechanical separator, the first mechanical separator being fluidly connected to the tank.

When the reactor assembly is in use liquid may selectably travel through a mechanical separation flow path in which liquid may be drawn from the tank, may flow through the first mechanical separator and then may return to the tank.

The first mechanical separator may comprise at least one hydrocyclone configured to separate solid particles from the liquid.

The liquid may circulate through the mechanical separation flow path at least twice during a mechanical separation sub-cycle.

The electrical charge may be applied to the liquid while it is flowing through the housing.

The tank may further comprise a sludge removal apparatus fluidly connected to a lower end of the tank to selectably extract sludge from the lower end of the tank.

The reactor circulation flow path may be free from physical filter media.

The reactor assembly may cover an area of less than about 1 square meters and is operable to treat at least 10 m³/d of liquid from the source.

The liquid may be subjected to the electrical charge while flowing from the liquid inlet to the liquid outlet.

Liquid entering the reactor inlet may travel in the axial direction and liquid exiting via the reactor outlet may travel in a generally radial direction that is orthogonal to the reactor axis.

The reactor outlet may be provided in the sidewall.

When the treatment reactor is in use the reactor axis may be inclined relative to a vertical direction by a reactor angle that is between about 20 degrees and about 70 degrees, and may be between about 30 and 60 degrees and may be 45 degrees.

When the treatment reactor is in use the reactor outlet may be provided on a generally upwardly-facing portion of the reactor.

The reactor axis may intersect the reactor inlet and may be spaced apart from the reactor outlet.

The system may further comprise a lid removably mounted to the upper end of the housing. The galvanic cell may have a proximate end mounted to an inner surface of the lid and an axially opposing distal end, and when the lid is mounted to the upper end the galvanic cell may be suspended within the housing and the distal end may be spaced apart from the lower end of the housing. When the lid is removed from the housing the galvanic cell may also be removed from the housing.

The galvanic cell may be removable from the housing while preserving fluid communication between the reactor inlet and reactor outlet.

The cathode assembly may further comprise an axially extending central cathode rod positioned within the cathode sleeve, and the anode rods may be disposed laterally between the central cathode rod and the cathode sleeve.

The anode rods may have an anode length in the axial direction, and the central cathode rod may have a cathode length that is greater than the anode length.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may comprise a generally convex, dome-shaped tip of the central cathode rod.

The flow-directing surface may be axially spaced between the anode rods and a lower end of the cathode sleeve.

The galvanic cell may be configured so that liquid flowing through the housing travels substantially axially from the reactor inlet to the reactor outlet.

The elongate, axially extending anode rod may be solid.

The sidewall may comprise an upper portion having a generally constant cross-sectional area and a tapered portion disposed toward the lower end and generally expanding from the reactor inlet toward the upper portion.

Liquid entering the reactor inlet may travel in the axial direction and liquid exiting via the reactor outlet may travel in a generally radial direction that is orthogonal to the reactor axis.

The system may further comprise a lid removably mounted to the upper end of the housing. The galvanic cell may have a proximate end mounted to an inner surface of the lid and an axially opposing distal end and when the lid is mounted to the upper end the galvanic cell may be suspended within the housing and the distal end may be spaced apart from the lower end of the housing. When the lid is removed from the housing the galvanic cell may be removed from the housing.

The galvanic cell may be removable from the housing while maintaining fluid connections at the reactor inlet and reactor outlet.

The flow-directing surface may be removable from the housing with the lid and galvanic cell.

The lid and galvanic cell may be removable by translating in the axial direction.

The system may further comprise a second galvanic cell connected to an inner surface of a second lid that may be configured to replace the lid and galvanic cell and may be mountable to seal the upper end of the housing.

The housing may be configured to retain a quantity of liquid while the lid and galvanic cell are removed from the housing.

In accordance with another broad aspect of the teachings described herein, a reactor assembly for use in a system for treating a liquid from a source may comprise a settling or treatment tank with a tank inlet for receiving an incoming stream of liquid and a tank interior for holding a volume of the liquid. That assembly may further comprise an electrical water treatment reactor with a housing that has a lower end, an upper end spaced apart from the lower end along a reactor axis, and a sidewall extending therebetween. That assembly may also have a reactor inlet provided toward the lower end and through which liquid can enter the housing, where that reactor inlet may be in fluid communication with the tank interior to receive liquid from the tank, and a reactor outlet provided toward the upper end through which liquid can exit the housing. The liquid may flow generally axially through the housing from the lower end to the upper end, the reactor outlet being in fluid communication with the tank to return liquid to the tank. The assembly may further contain a galvanic cell that is positionable at least partially axially between the reactor inlet and the reactor outlet within the housing so as to subject the liquid within the housing to an electrical charge. The galvanic cell may comprise an elongate, axially extending cathode assembly and an anode assembly including at least one elongate, axially extending anode rod that may be positioned generally parallel to and laterally spaced apart from the cathode assembly, and the anode assembly may be at least partially consumed when the reactor is in use. When the reactor assembly is in use liquid may travel through a reactor circulation flow path in which liquid is drawn from the tank, flows through the water treatment reactor and then returns to the tank, where a reaction initiated in the liquid by exposure to the electrical charge within the water treatment reactor may continue a coagulation reaction while the liquid is in the tank.

The liquid may circulate through the reactor circulation flow path at least twice during an electrical treatment sub-cycle.

The electrical treatment sub-cycle may have a duration of about 15 minutes.

The reaction initiated by exposure to the electrical charge within the water treatment reactor may continue to completion while the liquid is in the tank.

The reaction initiated by exposure to the electrical charge within the water treatment reactor may comprise an electrocoagulation reaction configured to induce coagulation of particles within the liquid and coagulated particles may settle within the tank.

The system may further comprise a first mechanical separator configured to separate solid particles from the liquid flowing through the mechanical separator, the first mechanical separator being fluidly connected to the tank.

When the reactor assembly is in use liquid may selectably travel through a mechanical separation flow path in which liquid may be drawn from the tank, may flow through the first mechanical separator and then may return to the tank.

The first mechanical separator may comprise at least one hydrocyclone configured to separate solid particles from the liquid.

The liquid may circulate through the mechanical separation flow path at least twice during a mechanical separation sub-cycle.

The electrical charge may be applied to the liquid while it is flowing through the housing.

The tank may further comprise a sludge removal apparatus fluidly connected to a lower end of the tank to selectably extract sludge from the lower end of the tank.

The reactor circulation flow path may be free from physical filter media.

The reactor assembly may cover an area of less than about 1 square meters and is operable to treat at least 10 m³/d of liquid from the source.

The effluent may travel through the reactor circulation flow path at least twice before exiting the first reactor unit.

The effluent may be circulated through the reactor circulation flow path for at least 15 minutes before exiting the first reactor unit.

The reactor circulation flow path may be free from physical filter media.

The system may further comprise at least a first mechanical separator configured to separate solid particles from the incoming stream of effluent flowing through the mechanical separator before the effluent flows into the electrical treatment unit.

The first mechanical separator may be fluidly connected to the first reactor tank via a mechanical flow path whereby the effluent can circulate between the first holding tank and the first mechanical separator along the mechanical flow path.

The effluent may circulate through the mechanical flow path, and the first mechanical separator therein, at least twice before flowing into the electrical treatment unit.

The first mechanical separator may comprise a hydrocyclone apparatus.

Effluent circulating through the mechanical flow path may travel between the first reactor tank and the first mechanical separator without passing through the electrical treatment reactor, and effluent circulating through the reactor circulation flow path may travel between the first reactor tank and the electrical treatment reactor without passing through the first mechanical separator.

The system may further comprise a changeover apparatus operable to selectably direct the effluent through the mechanical flow path or the reactor circulation flow path.

The system may further include a balancing tank located upstream from the first reactor unit and may have a balancing inlet configured to receive the effluent from the food production facility and a balancing outlet fluidly connected to the first reactor tank to transfer the effluent from the balancing tank to the first reactor tank.

The system may further comprise a second electrical treatment reactor provided in the reactor circulation flow path and operable to apply an electric charge to the effluent flowing through the second electrical treatment reactor.

The second electrical treatment reactor may be fluidly connected in parallel with the first electrical treatment reactor.

The incoming effluent stream may comprise organic or inorganic molecules or polymers and the first reactor unit may be configured to convert these molecules via any of the following processes: electro-oxidation, electro-reduction, electro-flotation, electrocoagulation, electro-crystalization, or electrolysis.

The reactor assembly may be configured to process at least 10 m³/d of effluent and may cover an area of less than 9 m².

The liquid may be subjected to the electrical charge while flowing from the liquid inlet to the liquid outlet.

Liquid entering the reactor inlet may travel in the axial direction and liquid exiting via the reactor outlet may travel in a generally radial direction that is orthogonal to the reactor axis.

The reactor outlet may be provided in the sidewall.

When the treatment reactor is in use the reactor axis may be inclined relative to a vertical direction by a reactor angle that is between about 20 degrees and about 70 degrees, and may be between about 30 and 60 degrees and may be 45 degrees.

When the treatment reactor is in use the reactor outlet may be provided on a generally upwardly-facing portion of the reactor.

The reactor axis may intersect the reactor inlet and may be spaced apart from the reactor outlet.

The system may further comprise a lid removably mounted to the upper end of the housing. The galvanic cell may have a proximate end mounted to an inner surface of the lid and an axially opposing distal end, and when the lid is mounted to the upper end the galvanic cell may be suspended within the housing and the distal end may be spaced apart from the lower end of the housing. When the lid is removed from the housing the galvanic cell may also be removed from the housing.

The galvanic cell may be removable from the housing while preserving fluid communication between the reactor inlet and reactor outlet.

The cathode assembly may further comprise an axially extending central cathode rod positioned within the cathode sleeve, and the anode rods may be disposed laterally between the central cathode rod and the cathode sleeve.

The anode rods may have an anode length in the axial direction, and the central cathode rod may have a cathode length that is greater than the anode length.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may comprise a generally convex, dome-shaped tip of the central cathode rod.

The flow-directing surface may be axially spaced between the anode rods and a lower end of the cathode sleeve.

The galvanic cell may be configured so that liquid flowing through the housing travels substantially axially from the reactor inlet to the reactor outlet.

The elongate, axially extending anode rod may be solid.

The sidewall may comprise an upper portion having a generally constant cross-sectional area and a tapered portion disposed toward the lower end and generally expanding from the reactor inlet toward the upper portion.

The reactor angle may be between about 30 and 60 degrees and may be 45 degrees.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may be removable from the housing with the lid and galvanic cell.

The cathode assembly may further comprise an axially-extending central cathode rod positioned within the cathode sleeve. The anode rods may be disposed laterally between the central cathode rod and the cathode sleeve, and the flow-directing surface may comprise a generally convex, dome-shaped tip of the central cathode rod.

The flow-directing surface may be axially spaced between the anode rods and a lower end of the cathode sleeve.

The lid and galvanic cell may be removable by translating in the axial direction.

The reactor assembly may further comprise a second galvanic cell connected to an inner surface of a second lid that may be configured to replace the lid and galvanic cell and may be mountable to seal the upper end of the housing.

The housing may be configured to retain a quantity of liquid while the lid and galvanic cell are removed from the housing.

In accordance with another broad aspect of the teachings described herein, a liquid treatment reactor may comprise a housing with a lower end, an upper end spaced apart from the lower end along a reactor axis, and a sidewall extending therebetween. The liquid treatment reactor may further comprise a reactor inlet provided toward the lower end through which a liquid can enter the housing and a reactor outlet provided toward the upper end through which the liquid can exit the housing, whereby the liquid may flow generally axially through the housing from the lower end to the upper end. The reactor may further comprise a galvanic cell that is positionable at least partially axially between the reactor inlet and the reactor outlet within the housing to subject the liquid within the housing to an electrical charge, and the galvanic cell may comprise an elongate, axially extending cathode assembly and an anode assembly including at least one elongate, axially extending anode rod that may be positioned generally parallel to and laterally spaced apart from the cathode assembly. The anode assembly may be at least partially consumed when the reactor is in use.

The liquid may be subjected to the electrical charge while flowing from the liquid inlet to the liquid outlet.

Liquid entering the reactor inlet may travel in the axial direction and liquid exiting via the reactor outlet may travel in a generally radial direction that is orthogonal to the reactor axis.

The reactor outlet may be provided in the sidewall.

When the treatment reactor is in use the reactor axis may be inclined relative to a vertical direction by a reactor angle that is between about 20 degrees and about 70 degrees, and may be between about 30 and 60 degrees and may be 45 degrees.

When the treatment reactor is in use the reactor outlet may be provided on a generally upwardly-facing portion of the reactor.

The reactor axis may intersect the reactor inlet and may be spaced apart from the reactor outlet.

The system may further comprise a lid removably mounted to the upper end of the housing. The galvanic cell may have a proximate end mounted to an inner surface of the lid and an axially opposing distal end, and when the lid is mounted to the upper end the galvanic cell may be suspended within the housing and the distal end may be spaced apart from the lower end of the housing. When the lid is removed from the housing the galvanic cell may also be removed from the housing.

The galvanic cell may be removable from the housing while preserving fluid communication between the reactor inlet and reactor outlet.

The anode assembly may comprise a plurality of axially extending anode rods laterally spaced apart from each other. The cathode assembly may comprise an axially extending cathode sleeve laterally surrounding the anode rods. The cathode sleeve may have an open lower end comprising a sleeve liquid inlet that may be in fluid communication with the reactor inlet and an upper end having a sleeve liquid outlet that may be in fluid communication with the reactor outlet. The liquid may flow through the cathode sleeve and along the length of the anode rods when the reactor is in use.

The cathode assembly may further comprise an axially extending central cathode rod positioned within the cathode sleeve, and the anode rods may be disposed laterally between the central cathode rod and the cathode sleeve.

The anode rods may have an anode length in the axial direction, and the central cathode rod may have a cathode length that is greater than the anode length.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may comprise a generally convex, dome-shaped tip of the central cathode rod.

The flow-directing surface may be axially spaced between the anode rods and a lower end of the cathode sleeve.

The galvanic cell may be configured so that liquid flowing through the housing travels substantially axially from the reactor inlet to the reactor outlet.

The elongate, axially extending anode rod may be solid.

The sidewall may comprise an upper portion with a generally constant cross-sectional area and a tapered portion disposed toward the lower end and generally expanding from the reactor inlet toward the upper portion.

In accordance with yet another broad aspect of the teachings described herein, a liquid treatment reactor may comprise a housing with a lower end, an upper end spaced apart from the lower end along a reactor axis, and a sidewall extending therebetween. When the treatment reactor is in use the reactor axis may be inclined relative to a vertical direction by a reactor angle that is between about 20 degrees and about 70 degrees. The reactor may further contain a reactor inlet through which a liquid can enter the housing. The reactor inlet may be provided at the lower end and may be intersected by the reactor axis. The reactor may further contain a reactor outlet through which the liquid can exit the housing in a second flow direction that is different than the first flow direction, the reactor outlet provided toward the upper end and in a portion of the sidewall that is, when the treatment reactor is in use, generally upwardly facing. The reactor may further contain a galvanic cell positionable at least partially axially between the reactor inlet and the reactor outlet within the housing to subject the liquid within the housing to an electrical charge.

The liquid may be subjected to the electrical charge while flowing from the liquid inlet to the liquid outlet.

Liquid entering the reactor inlet may travel in the axial direction and liquid exiting via the reactor outlet may travel in a generally radial direction that is orthogonal to the reactor axis.

The system may further comprise a lid removably mounted to the upper end of the housing. The galvanic cell may have a proximate end mounted to an inner surface of the lid and an axially opposing distal end, and when the lid is mounted to the upper end the galvanic cell may be suspended within the housing and the distal end may be spaced apart from the lower end of the housing. When the lid is removed from the housing the galvanic cell may also be removed from the housing.

The galvanic cell may be removable from the housing while preserving fluid communication between the reactor inlet and reactor outlet.

The anode assembly may comprise a plurality of axially extending anode rods laterally spaced apart from each other. The cathode assembly may comprise an axially extending cathode sleeve laterally surrounding the anode rods. The cathode sleeve may have an open lower end comprising a sleeve liquid inlet that may be in fluid communication with the reactor inlet and an upper end having a sleeve liquid outlet that may be in fluid communication with the reactor outlet. The liquid may flow through the cathode sleeve and along the length of the anode rods when the reactor is in use.

The cathode assembly may further comprise an axially extending central cathode rod positioned within the cathode sleeve, and the anode rods may be disposed laterally between the central cathode rod and the cathode sleeve.

The anode rods may have an anode length in the axial direction, and the central cathode rod may have a cathode length that is greater than the anode length.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may comprise a generally convex, dome-shaped tip of the central cathode rod.

The flow-directing surface may be axially spaced between the anode rods and a lower end of the cathode sleeve.

The galvanic cell may be configured so that liquid flowing through the housing travels substantially axially from the reactor inlet to the reactor outlet.

The elongate, axially extending anode rod may be solid.

The sidewall may comprise an upper portion having a generally constant cross-sectional area and a tapered portion disposed toward the lower end and generally expanding from the reactor inlet toward the upper portion.

The reactor angle may be between about 30 and 60 degrees and may be 45 degrees.

In accordance with another broad aspect of the teachings described herein, a liquid treatment reactor may comprise a housing having a closed lower end, an open upper end spaced apart from the lower end along a reactor axis, and a sidewall extending therebetween. The reactor may further comprise a reactor inlet through which a liquid can enter the housing in a first flow direction, the reactor inlet being provided toward the lower end. The reactor may further comprise a reactor outlet through which the liquid can exit the housing in a second flow direction that is different than the first flow direction, the reactor outlet provided in a portion of the sidewall that is, when the treatment reactor is in use, generally upwardly facing. The reactor may further comprise a lid removably mounted to the housing and having an inner surface such that, when the lid is mounted to the housing, the lid seals the upper end and the inner surface faces the reactor inlet. The reactor may further comprise a galvanic cell positionable at least partially axially between the reactor inlet and the reactor outlet within the housing to subject the liquid within the housing to an electrical charge. The galvanic cell may comprise a plurality of elongate anode rods that extend generally axially from the inner surface of the lid and may be laterally spaced apart from each other and a cathode sleeve extending axially from the inner surface and laterally surrounding the anode rods. When the lid is mounted to the upper end the galvanic cell may be suspended within the housing and cathode sleeve and anode rods may be spaced apart from the lower end of the housing. When the lid is removed from the housing the galvanic cell may be removed from the housing. The lid and galvanic cell may be removable from the housing while maintaining fluid connections at the reactor inlet and reactor outlet.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may be removable from the housing with the lid and galvanic cell.

The cathode assembly may further comprise an axially-extending central cathode rod positioned within the cathode sleeve. The anode rods may be disposed laterally between the central cathode rod and the cathode sleeve, and the flow-directing surface may comprise a generally convex, dome-shaped tip of the central cathode rod.

The flow-directing surface may be axially spaced between the anode rods and a lower end of the cathode sleeve.

The lid and galvanic cell may be removable by translating in the axial direction.

The system may further comprise a second galvanic cell connected to an inner surface of a second lid that may be configured to replace the lid and galvanic cell and may be mountable to seal the upper end of the housing.

The housing may be configured to retain a quantity of liquid while the lid and galvanic cell are removed from the housing.

The reactor may further comprise a sludge removal apparatus fluidly connected to a lower end of the first reactor tank to extract sludge from the lower end of the first reactor tank.

The incoming effluent stream may comprise organic or inorganic molecules or polymers and the first reactor unit may be configured to convert these molecules via any of the following processes: electro-oxidation, electro-reduction, electro-flotation, electrocoagulation, electro-crystalization, or electrolysis.

The system may be configured to process at least 10 m³/d of effluent and may cover an area of less than 9 m².

The electrical treatment cycle may have a duration of about 15 minutes.

The reactor may further comprise a first mechanical separator configured to separate solid particles from the liquid flowing through the mechanical separator. The first mechanical separator may be fluidly connected to the tank. When the reactor assembly is in use liquid may travel through a mechanical separation flow path in which liquid may be drawn from the tank, may flow through the first mechanical separator and then may return to the tank.

The first mechanical separator may comprise at least one hydrocyclone configured to separate solid particles from the liquid.

The liquid may circulate through the mechanical separation flow path at least twice during a mechanical separation sub-cycle.

The electrical charge may be applied to the liquid while it is flowing through the housing.

The reactor assembly may cover an area of less than about 1 square meters and is operable to treat at least 10 m³/d of liquid from the source.

The liquid may be subjected to the electrical charge while flowing from the liquid inlet to the liquid outlet.

Liquid entering the reactor inlet may travel in the axial direction and liquid exiting via the reactor outlet may travel in a generally radial direction that is orthogonal to the reactor axis.

The reactor outlet may be provided in the sidewall.

When the treatment reactor is in use the reactor axis may be inclined relative to a vertical direction by a reactor angle that is between about 20 degrees and about 70 degrees, and may be between about 30 and 60 degrees and may be 45 degrees.

When the treatment reactor is in use the reactor outlet may be provided on a generally upward-facing portion of the reactor.

The reactor axis may intersect the reactor inlet and may be spaced apart from the reactor outlet.

The system may further comprise a lid removably mounted to the upper end of the housing. The galvanic cell may have a proximate end mounted to an inner surface of the lid and an axially opposing distal end, and when the lid is mounted to the upper end the galvanic cell may be suspended within the housing and the distal end may be spaced apart from the lower end of the housing. When the lid is removed from the housing the galvanic cell may also be removed from the housing.

The galvanic cell may be removable from the housing while preserving fluid communication between the reactor inlet and reactor outlet.

The anode assembly may comprise a plurality of axially extending anode rods laterally spaced apart from each other. The cathode assembly may comprise an axially extending cathode sleeve laterally surrounding the anode rods. The cathode sleeve may have an open lower end comprising a sleeve liquid inlet that may be in fluid communication with the reactor inlet and an upper end having a sleeve liquid outlet that may be in fluid communication with the reactor outlet. The liquid may flow through the cathode sleeve and along the length of the anode rods when the reactor is in use.

The cathode assembly may further comprise an axially extending central cathode rod positioned within the cathode sleeve, and the anode rods may be disposed laterally between the central cathode rod and the cathode sleeve.

The anode rods may have an anode length in the axial direction, and the central cathode rod may have a cathode length that is greater than the anode length.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may comprise a generally convex, dome-shaped tip of the central cathode rod.

The flow-directing surface may be axially spaced between the anode rods and a lower end of the cathode sleeve.

The galvanic cell may be configured so that liquid flowing through the housing travels substantially axially from the reactor inlet to the reactor outlet.

The elongate, axially extending anode rod may be solid.

The sidewall may comprise an upper portion having a generally constant cross-sectional area and a tapered portion disposed toward the lower end and generally expanding from the reactor inlet toward the upper portion.

The liquid may be subjected to the electrical charge while flowing from the liquid inlet to the liquid outlet.

Liquid entering the reactor inlet may travel in the axial direction and liquid exiting via the reactor outlet may travel in a generally radial direction that is orthogonal to the reactor axis.

The cathode assembly may further comprise an axially extending central cathode rod positioned within the cathode sleeve, and the anode rods may be disposed laterally between the central cathode rod and the cathode sleeve.

The anode rods may have an anode length in the axial direction, and the central cathode rod may have a cathode length that is greater than the anode length.

The galvanic cell may comprise a flow-directing surface which, when the galvanic cell is mounted to the housing, may face the reactor inlet and may be configured to direct the flow of liquid entering the reactor inlet into cathode sleeve.

The flow-directing surface may comprise a generally convex, dome-shaped tip of the central cathode rod.

The flow-directing surface may be axially spaced between the anode rods and a lower end of the cathode sleeve.

The galvanic cell may be configured so that liquid flowing through the housing travels substantially axially from the reactor inlet to the reactor outlet.

The elongate, axially extending anode rod may be solid.

The sidewall may comprise an upper portion having a generally constant cross-sectional area and a tapered portion disposed toward the lower end and generally expanding from the reactor inlet toward the upper portion.

In accordance with yet another broad aspect of the teachings described herein, a process for treating a liquid may include receiving an incoming stream of liquid from a source in a reactor tank and performing an electrical treatment sub-cycle, which may include circulating the liquid between the reactor tank and an electrical treatment reactor at least twice. The electrical treatment reactor may be configured to subject the liquid to a first treatment process in which an electrical charge may be applied to the liquid to convert the incoming stream of liquid into a partially treated stream. The process may further comprise receiving the partially treated stream in a second processing unit and subjecting the partially treated stream to a different, second treatment process to convert the partially treated stream to a treated outlet stream.

The electrical treatment sub-cycle may comprise passing the liquid generally upwardly through the electrical treatment reactor whereby reaction products created by exposure to the electrical charge may be carried from the electrical treatment reactor into the reactor tank.

The electrical treatment reactor may have an axially extending housing extending in a direction of liquid flow through the electrical treatment reactor with at least one elongate axially extending cathode and at least one elongate axially extending anode rod positioned adjacent to the cathode. The anode rod may be at least partially consumed during the electrical treatment sub-cycle.

The electrical treatment sub-cycle may last at least 10 minutes and/or may include at least 2 circulations through the electrical treatment reactor.

The process may further comprise extracting sludge that has accumulated during the electrical treatment sub-cycle from the reactor tank.

The process may further comprise performing a mechanical separation sub-cycle prior to performing the electrical treatment sub-cycle. The mechanical separation sub-cycle may include circulating the incoming stream of liquid through at least a first mechanical separation unit that may be configured to extract physical particles from the liquid at least twice.

The process may further comprise performing the mechanical separation sub-cycle after performing the electrical treatment sub-cycle and before the partially treated stream is received by the second processing unit.

The partially treated stream may be re-circulated through the first mechanical separation unit at least twice before being received by the second processing unit

The second treatment process comprises subjecting the partially treated stream to at least one of aerobic and anaerobic digestion.

The process may further comprise circulating the partially treated stream between a second holding tank and at least a first biological reactor in fluid communication with the second holding tank via a bio flow path.

The partially treated stream may be circulated through the bio flow path at least twice before being discharged as the treated output stream.

In accordance with yet another broad aspect of the teachings described herein a process for treating surface water (ie: lake, stream, canal, river or other waterway or body of water) may include receiving an incoming stream of liquid from a source in a reactor tank and performing an electrical treatment sub-cycle lasting at least 5 minutes. The electrical treatment sub-cycle may include circulating the liquid between the reactor tank and an electrical treatment reactor at least twice where the electrical treatment reactor may be configured to subject the liquid to a first treatment process in which an electrical charge may be applied to the liquid to convert the incoming stream of liquid into a partially treated stream.

The process may further comprise receiving the partially treated stream in a second processing unit and subjecting the partially treated stream to a different, second treatment process to convert the partially treated stream to a treated outlet stream.

The electrical treatment sub-cycle may comprise passing the liquid generally upwardly through the electrical treatment reactor whereby reaction products created by exposure to the electrical charge are carried from the electrical treatment reactor into the reactor tank.

The electrical treatment reactor may have an axially extending housing extending in a direction of liquid flow through the electrical treatment reactor. The elongate axially extending cathode and elongate axially extending anode rod may be positioned adjacent to the cathode, and the anode rod may be at least partially consumed during the electrical treatment sub-cycle.

The process may further comprise extracting sludge that has accumulated during the electrical treatment sub-cycle from the reactor tank.

The process may further comprise performing a mechanical separation sub-cycle prior to or after performing the electrical treatment sub-cycle. The mechanical separation sub-cycle may include circulating the incoming stream of liquid through at least a first mechanical separation unit that may be configured to extract physical particles from the liquid.

The second treatment process may comprise subjecting the partially treated stream to at least one of a sterilization and a pH correction process.

### DRAWINGS

FIG. 1 is a schematic representation of one example of a treatment system in combination with a source of liquid to be treated;

FIG. 2 is another schematic representation of the liquid treatment system of FIG. 1;

FIG. 3 is a schematic representation of a portion of the liquid treatment system of FIG. 2;

FIG. 4 is a schematic representation of a first processing unit portion of the system of FIG. 2;

FIG. 5 is a partially exploded perspective view of another example of a first processing unit portion of the system of FIG. 2;

FIG. 6 is a perspective view of a portion of the first processing unit of FIG. 5;

FIG. 7 is a side elevation view of the portion of the first processing unit of FIG. 6;

FIG. 8 is a partially exploded view of one example of an electrical treatment apparatus for use with the first processing unit of FIG. 5;

FIG. 9 is a side view of a portion of the electrical treatment apparatus of FIG. 8;

FIG. 10 is a side view and an end view of a portion of the electrical treatment apparatus of FIG. 8;

FIG. 11 is a side view and an end view of a portion of the electrical treatment apparatus of FIG. 8;

FIG. 12 is a schematic representation of a portion of the electrical treatment apparatus of FIG. 8;

FIG. 13 is a perspective view of a portion of the electrical treatment apparatus of FIG. 8;

FIG. 14 is a schematic representation of one example of a second processing unit suitable for use with the system of FIG. 2;

FIG. 15 is a schematic representation of another example of a second processing unit suitable for use with the system of FIG. 2;

FIG. 16 is a schematic representation of another example of a second processing unit suitable for use with the system of FIG. 2;

FIG. 17 is a schematic representation of another example of a second processing unit suitable for use with the system of FIG. 2;

FIG. 18 is a flow chart showing one example of a method of treating liquid;

FIG. 19 is a schematic representation of another example of a liquid treatment system;

FIG. 19a is an enlarged view of a portion of FIG. 19;

FIG. 20 is another schematic representation of the liquid treatment system of FIG. 19;

FIG. 21 is a schematic representation of another example of a liquid treatment system;

FIG. 22 is a schematic representation of another example of a liquid treatment system;

FIG. 23 is a schematic representation of yet another example of a liquid treatment system;

FIG. 24 is a schematic representation of yet another example of a liquid treatment system;

FIG. 25 is a schematic representation of yet another example of a liquid treatment system;

FIG. 26 is a schematic representation of yet another example of a liquid treatment system;

FIG. 27 is flow chart showing another example of a method of treating a liquid using the system of FIG. 26;

FIG. 28 is a schematic representation of yet another example of a liquid treatment system;

FIG. 29 is flow chart showing another example of a method of treating a liquid using the system of FIG. 28;

FIG. 30 is flow chart showing another example of a method of treating a liquid using the system of FIG. 26;

FIG. 31 is a schematic representation of yet another example of a liquid treatment system;

FIG. 32 is flow chart showing another example of a method of treating a liquid using the system of FIG. 31;

FIG. 33 is a schematic representation of yet another example of a liquid treatment system; and

FIG. 34 is flow chart showing another example of a method of treating a liquid using the system of FIG. 33.

Unless otherwise specifically noted, articles depicted in the drawings are not necessarily drawn to scale.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Water that is used as part of an industrial or commercial process can be contaminated with a variety of organic and inorganic contaminants. In some processes, the water exiting the process is contaminated to the point that it is undesirable to discharge the water into the surrounding environment and/or into existing sewer and water treatment facilities. For example, the water may include high levels or concentrations of biochemical oxygen demand (BOD), total Kjeldahl nitrogen (TKN), total phosphorus (TP), and total suspended solids (TSS), heavy metals, arsenic, phosphorous and may have undesirable pH levels and the like. Water of this nature can be referred to as wastewater, effluent and sometimes merely as liquid, even though it includes dissolved and/or suspended contaminants and could be referred to as a solution, mixture, emulsion, slurry or the like. It is understood that the terms wastewater, effluent and/or liquid include such streams.

In some circumstances, it can be desirable to further treat/process the wastewater before discharging it from the industrial and/or commercial facility. Some examples of industrial and/or commercial processes that can produce contaminated liquid include food and beverage production facilities (such as breweries, distilleries, wineries craft brewery, cider, dairy and the like), agricultural facilities (such as farms, food washing and processing facilities and the like), chemical production facilities, mining facilities, pharmaceutical production facilities, pulp & paper production facilities.

Similar challenges can be faced when processing wastewater from residential sources, and wastewater from residential sources can be treated using the systems and processes described herein.

The system used to treat liquid to be treated from a particular source may be selected and configured to treat the type of contaminants that are expected to be generated by the source, and a given wastewater treatment system may be suitable to treat some types of contaminants and may be less suitable for treating other types of contaminants. In such instances, more than one treatment system may be provided to treat different aspects or portions of the liquid to be treated, and/or some of the waste from the source may be routed through the treatment system while other portions of the waste are diverted and do not flow through the liquid to be treated treatment system.

For the purpose of describing the processes and systems herein, a brewery is used as one example of an industrial process that creates liquid (specifically wastewater) for treatment. For the purposes of this discussion, the waste products that are generated by a given system, such as the brewery described herein, can be classified into three types of waste streams, which may include water, based on the nature of the waste/contaminants present: red water, yellow water, and green water.

As used herein, the term “red water” refers to liquid to be treated that is not suitable for treatment using the treatment system and processes described herein. “Green water” is used to describe waste streams leaving the source that are already sufficiently clean as to be discharged to the surrounding environment and/or into an available municipal sewer system without further treatment. There may be little to no need to send such waste streams through the liquid treatment systems described herein, although some of the green water streams may be directed through the liquid to be treated treatment system if desired by a user (for example to help dilute other waste products and/or to help provide a desired volume of water flow through the system and the like).

“Yellow water” is therefore used to describe waste streams from the source that are too contaminated to be directly discharged and which are suitable for treatment using the systems and processes described herein. The terms red, yellow and green are casual terms that are used for the purpose of describing/classifying the waste products emanating from a given source, and are not indicative of the actual colour of the waste streams or their contents, and are not intended to be limiting. Other terms can be used to classify waste streams in other embodiments, such as non-treatable, treatable and clean and the like. Further, the specific contaminants included in a given type/class of liquid to be treated stream may vary based on the source and the type of liquid to be treated treatment system used. Contaminants that are classified as “red” for one embodiment of the treatment system may be considered “yellow” for another embodiment of the treatment system that has been configured to treat a given type and/or concentration level of contaminants.

Optionally, a system can be provided to help treat liquid coming from a brewery or other type of industrial, commercial and/or residential source. The system may be configured as a multi-step treatment system, and can include the steps of removing some or all of the suspended solids from the liquid to be treated (i.e., reducing the total suspended solids, TSS, levels) via mechanical separation means and then treating the wastewater stream with any suitable mechanism, including electrolysis, to help process organic molecules in the liquid to be treated. For example, the system can include an electrolysis reactor to process the liquid to be treated and help break down relatively long chain molecules such as flavor-contributing compounds and ring structures like phenols, complex sugars and starches from grains in a brewery process, into relatively simpler structures and relatively simple sugars.

The simpler compounds can then be processed to reduce the biochemical oxygen demand (BOD) concentration of the water stream being treated. The water can be treated using an organic reactor and the like to help in this treatment step. Water that has been sufficiently treating using the process/system can then be discharged from the system and sent for further treatment if desired (i.e., to a municipal sewer system or other post-processing treatment) or discharged in another manner (e.g., discharging into a septic system or weeping system, irrigating crops or other land and the like).

While water and waste water are used for convenience as examples of the liquids that can be treated using the systems and apparatuses described herein, other liquid, slurries and the like may also be treated in an analogous manner and using the same or analogous equipment and methods. For example, some aspects of the teachings described herein may be used to treat oils, aqueous solutions, non-aqueous solutions, coolants and the like.

Some examples of prior art reactors include a method of partial self-cleaning in the form of a collection of porous balls designed to agitate in the liquid (primarily water) being treated. The scraping action of these balls against the electrodes serves to remove plaque as it builds up over time in the exemplary prior art. As the present invention is discussed in more detail below, one or more advantages it provides over some of these existing reactors may become apparent. One possible advantage may be related to the geometry of the electrolysis processing unit itself. Because the liquid entering the unit is able to proceed in generally a linear path from the lower inlet to the upper outlet, aided by the smooth rod electrodes, the flow of the liquid may be relatively uninterrupted (as compared to a flow blocked by internal cleaning balls, interning plate-like electrodes or other such obstructions), meaning less plaque will build up over time. The removable and replaceable nature of the galvanic assembly in question further means there will be reduced need to clean the device and so no cumbersome arrangement of self-cleaning balls need be introduced into the processing unit. Insofar as some agitation of the liquid is necessary for the cleaning action as described herein, the convex, dome-shaped tip of the central cathode rod extending farther in length than the anode rods provides the necessary turbulence.

Several examples of systems, methods and apparatus for treating a variety of contaminated fluid streams are described herein. Some embodiments are configured for treating the effluent or wastewater from food production facilities (such as breweries, wineries, distilleries, bakeries and dairies). Other embodiments can be configured to the processing effluent streams from restaurants, rendering facilities, machine shops, industrial facilities and the like, where the effluent streams include water contaminated with fats, oils, greases and the like. In other embodiments, the systems and apparatuses described herein can be used to treat surface water (i.e. water from a lake, stream, canal, river, ocean or the like), or any other suitable source, in which the incoming water is contaminated with phosphorous. Agricultural facilities, such as produce processing and washing facilities, greenhouses, and the like, are another example of installations that may utilize some of the systems and apparatus described herein. For example, some embodiments of the teachings described herein may be configured to process, recover and/or dewater soil/dirt or other debris from the wastewater stream, optionally along with other contaminants, and may optionally be configured to recycle/repurpose at least some of the recovered dirt and at least some of the recovered water. For example, dirt and water recovered from processing the effluent stream of a produce washing facility may be re-applied to the fields to help grow subsequent crops.

Optionally, the systems and apparatuses described herein may be configured to help reduce their overall, physical size (i.e. the area required to accommodate the system components) as compared to some existing water processing systems. For example, a combination of at least one tank and a flow-through type reactor and/or processing unit may be configured to receive the liquid to be treated and to re-circulate the liquid through a suitable flow path (such as a reactor circulation flow path) from the tank, through the reactor to initiate treatment, and then back into the tank. The liquid can be recirculated through the flow path two or more times, and optionally generally continuously for a period of at least 10 minutes (and optionally 15, 20, 25, 30, 40, 45 or more minutes) which may help further process the liquid. This type of recirculation through the tank/reactor pair may help embodiments of the systems described herein process volumes of effluent that would otherwise require physically larger reactors (if all the liquid were to be fully processed in a single pass/treatment session of the reactor), holding tanks, settling pools and the like. This may be advantageous in circumstances where physical floor space/area is constrained or could be preferably utilized for other purposes. For example, some of the systems described herein can be arranged to occupy and area that is less than about 15 m² and may be sized to occupy less than about 12, 10, 8, 6, 5, 1 or less m².

Optionally, a reaction initiated in the reactor may continue after the liquid has returned to the tank. For example, if the liquid is subjected to an electric charge when flowing through the reactor a process, such as electrocoagulation may be initiated. As the liquid continues to flow through the reactor it may actually exit the reactor before the effects of the electrocoagulation have taken effect (i.e. prior to material precipitation of particles out of the liquid). In such examples, the liquid may flow back into the tank and aspects of the processing step, such as allowing for settling/precipitation of coagulated particles initiated by the electrocoagulation process, can occur in the tank rather than within the confines of the reactor or other processing unit itself. This may help reduce the accumulation of debris within the reactor or processing unit in some embodiments.

For ease of description, several different embodiments of systems and apparatus for treating wastewater or other suitable liquids (such as an oil stream carrying contaminants) are described herein. It is understood that some aspects of one such embodiment may be combined with suitable/compatible aspects of another embodiment, and vice versa, to provide a variety of different embodiments beyond those described herein, and that features of one embodiment are not to be considered to be exclusive or inconsistent with another embodiment. For example, a second processing unit from one embodiment may be swapped with, or added as supplemental to a second processing unit from a different embodiment.

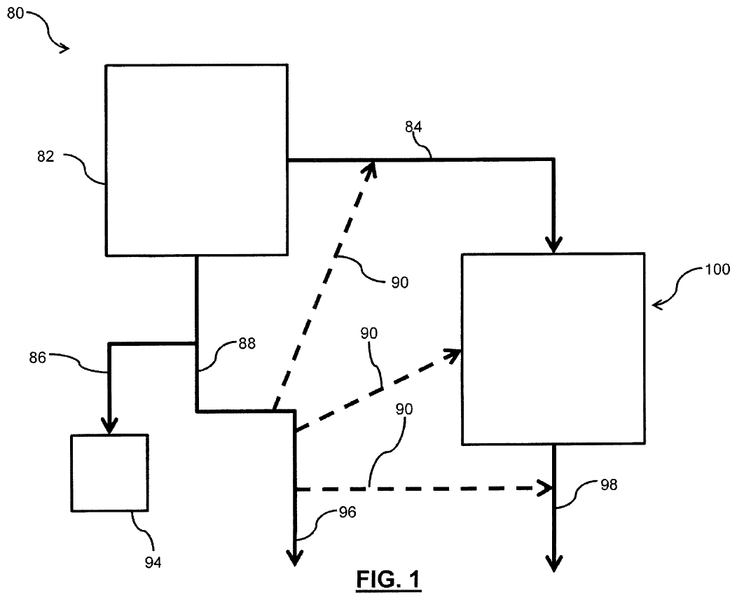

Referring to FIG. 1, a first example of a liquid treatment system 100 that is configured to treat effluent from a brewery is shown in combination with one example of a source 80 of various liquid to be treated streams. In this example, the source 80 is a conventional brewery 82 that is operating to produce beer, but the system 100 could be used in combination with other sources in other embodiments.

In this example, the brewery 82 can produce red wastewater streams 86 from various steps in its processes. These red wastewater streams 86 may not be suitable for processing using the treatment system 100 and are instead diverted to a suitable drain or disposal apparatus 94. The wastewater streams 86 to be treated in this example may a variety of contaminants, such as relatively long-chain organic molecules, cleaning chemicals, yeasts, plant material, and other substances. For example, the red wastewater streams 86 in this example may include streams that contain more than 10,000 mg/L of BOD and/or the components of old stock beer (including yeast, trub, grain, and solids). The brewery 82 may also generate yellow wastewater streams 84 that can be directed to the wastewater treatment system 100. Examples of such yellow liquid to be treated streams 84 may include wastewater containing between 500 and 10,000 mg/L of BOD and/or brew house and fermentation by-products and may be treated using the wastewater treatment system 100 described herein.

The brewery 82 may also generate one or more green wastewater streams 88, such as wastewater coming from the packaging and bottling operations, as well as any other streams that contain less than 500 mg/L of BOD and that would not require treatment by the herein described water treatment system 100 before flowing into the local municipal sewer systems 96 (i.e., that are within local regulatory limits). Optionally, any such green wastewater streams 88 may be combined with the yellow wastewater streams 84 upstream from the treatment system 100, with the final output or discharge of the treatment system 100 prior to disposal via drain/sewer 98, or at one or more locations within the treatment system 100, such as are shown using optional dashed connection lines 90.

As used herein, the term “influent” can be understood to refer to streams prior to entering the treatment system 100 (e.g., this may include the different types of streams 84, 86 and 88) whereas the term “effluent” is generally used to refer to liquid to be treated or being treated at any point within the treatment system 100, and thus may refer to liquid at varying stages of treatment.

As used herein, the term “sludge” refers to solids, semi-solids and other such debris that may tend to collect at the bottom of a tank that contains liquid to be treated with entrained and/or dissolved solid contaminants. Sludge is typically created by the deposition and/or precipitation of such solids and semi-solids debris from the liquid to be treated under the influence of gravity.

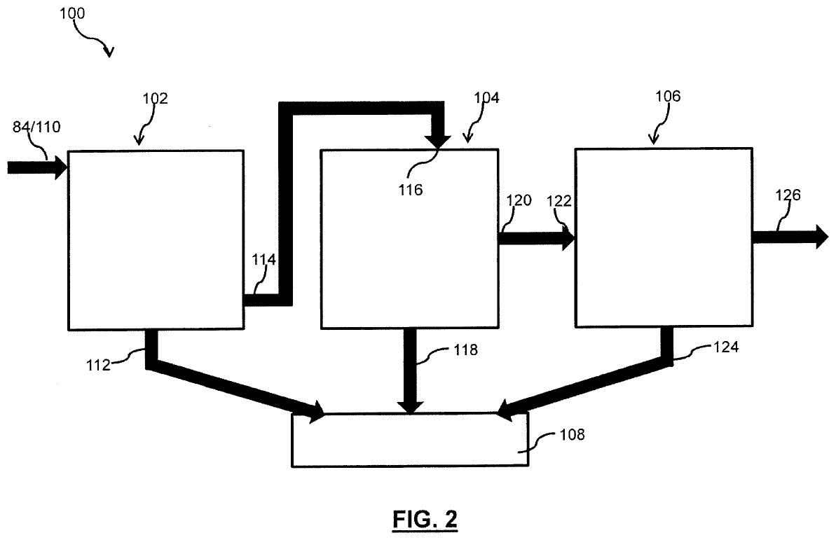

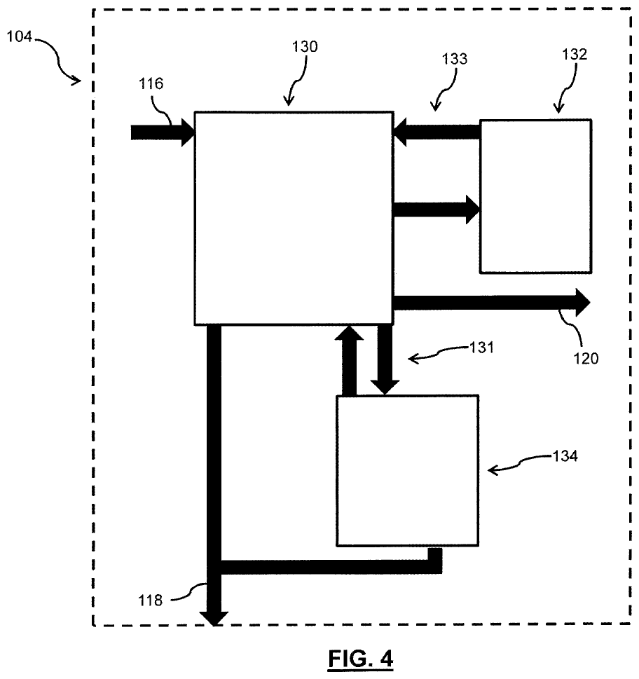

Referring to FIG. 2, in this embodiment the treatment system 100 includes several units or stations and in the illustrated example includes an optional balancing unit 102 (optionally with a mechanical separator), a first processing unit 104 downstream from the balancing unit 102, and a second processing unit 106. Preferably, the second processing unit 106 is arranged in series with the first processing unit 104, such that it is downstream from the first processing unit 104 and receives an incoming flow that has already been at least partially treated using the first processing unit 104. Alternatively, in some examples the second processing unit 106 can receive some input flows that did not first pass through the first processing unit 104. In this arrangement, the incoming liquid feed can flow through each of the balancing unit 102, the mechanical separator (see separator 134 in FIG. 4), first processing unit 104, and second processing unit 106.

Optionally, the processing units 104 and 106 can be the same and/or can perform similar treatments on the incoming liquid to be treated. Alternatively, the first and second processing units 104 and 106 may be different and may be configured to perform different treatments and/or processes on the liquid to be treated stream. Further, each processing unit 104 and 106 may include more than one treatment apparatus and/or treatment stage, and may perform two or more processing steps. For example, each of the first and second processing units 104 and 106 may include at least one mechanical separator or filter, along with at least one electrical, chemical or other type of treatment stages. Optionally, one of the first and second processing units 104 and 106 may also include at least one biological treatment stage. For example, referring to FIG. 4, the first processing unit 104 may include a physical or mechanical separator 134 to help separate solid particulate from the liquid to be treated stream, an electrical treatment apparatus 132 to break down organic molecules in the liquid to be treated stream, and a holding tank 130. In other arrangements, the mechanical separator 134 does not have to be physically proximate to the electrical treatment apparatus, and could be provided separately or could be located upstream from the first processing unit 104. The second processing unit 106, in this example, includes a biological treatment apparatus to further treat the filtered and electrically-treated liquid to be treated.

Optionally, each unit 102, 104 and 106 may include a respective waste output stream 112, 118 and 124 that is used to convey sludge and other waste products away at various points throughout the treatment system 100. These waste streams 112, 118 and 124 may be substantially separate as shown in FIG. 2, or alternatively may at least partially overlap each other. These waste streams 112, 118 and 124 may be directed to a suitable drain or sewer or to any other suitable waste storage and/or removal unit shown schematically at 108. Optionally, the waste removal unit 108 may include two or more separate waste collection and/or processing modules as appropriate for a given liquid management system 100.

In this example, the system 100 includes an influent inlet 110 that is configured to receive the treatable “yellow” influent stream 84 from the brewery 82. In the illustrated example, liquid to be treated flowing through the inlet 110 is directed into the balancing unit 102.

### Balancing Unit

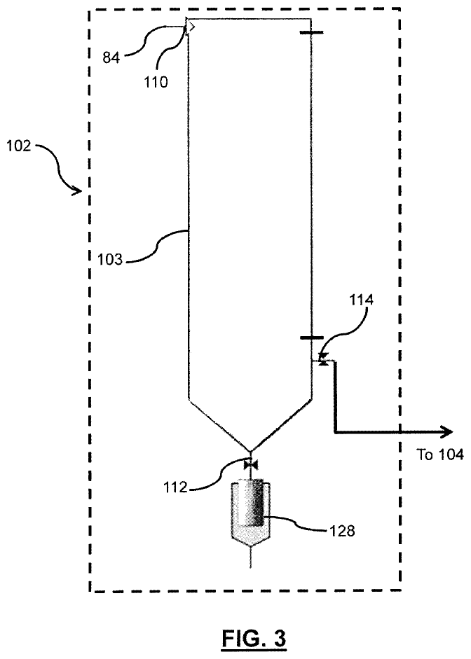

Referring also to FIG. 3, in this example the balancing unit 102 includes a balancing or equalization (EQ) tank 103 that is adapted to receive and hold a relatively large, predetermined quantity of liquid to be treated, and preferably has a storage capacity that is greater than the individual storage capacities of the first and second processing units 104 and 106.

For example, in this embodiment the EQ tank 103 may be configured to hold at least 5000 L or more, and may be configured to hold at least one day's worth of treatable liquid to be treated that is expected to be generated by the source (i.e. brewery 82). The use of the EQ tank 103 may help average out the swings and spikes in the quantity and/or composition of the influent liquid to be treated coming from stream 84, which may help provide a more consistent liquid to be treated that is relatively easier to manage and treat using the system 100. The EQ tank 103 may include one or more initial screens and/or filters for the liquid to be treated.

Holding the liquid to be treated in the EQ tank 103 for a predetermined period of time, which may be selected based on a number of factors including the specific gravity of contaminants/particles entrained in the liquid to be treated and/or its pH, may help permit large objects and other solid and/or semi-solid debris to settle to the bottom of the EQ tank 103 and to be removed through a bottom-mounted outlet as a waste stream 112. Optionally, a dewatering/sludge removal apparatus 128 may be provided in the waste stream 112, and may be either manually activated or automatically controlled using a suitable system controller.

When a satisfactory settling period has been completed, at least a portion of the liquid to be treated contained in the EQ tank 103, but preferably not the entirety of the contents of the EQ tank 103, can be removed and sent to the first processing unit 104 for treatment. In the illustrated example, the wastewater outlet 114 of the EQ tank 103 is provided toward a bottom end of the EQ tank 103, below the location of the influent inlet 110 but is spaced above the location of the outlet for the waste stream 112. While not illustrated, the EQ tank 103 may have other ports and flow control components, and may include one or more recycle lines to recirculate the liquid to be treated within the EQ tank 103.

### First Processing Unit

Referring to FIG. 4, one example of a first processing unit 104 includes an inlet 116 to receive the effluent stream, a holding tank 130, an electrical treatment apparatus 132 and an optional first mechanical separator 134. In the illustrated example the inlet 116 is connected to the outlet coming from the balancing unit 102, but in other configurations, the balancing unit 102 may be omitted and the inlet 116 may directly receive the incoming influent streams from the source.

In the illustrated example, the inlet 116 is connected to a holding tank 130 that is configured to receive and hold a predetermined quantity of liquid for treatment. The first processing unit 104 in this embodiment also includes at least a first mechanical separator 134 that is configured to help further separate solid and/or semi-solid particles and debris from the liquid to be treated, and at least one electrical treatment apparatus 132. Alternatively, the first processing unit 104 need not include a mechanical separator and/or a mechanical separator may be provided in other suitable locations within the system, including as part of the balancing unit 102, upstream from the balancing unit 102, in the flow path between the balancing unit 102 and the first processing unit 104 and/or downstream from the first processing unit 104.

In this embodiment, the first mechanical separator 134 is fluidly connected to the first holding tank 130 as part of a mechanical flow path or first flow path or circuit 131 whereby the liquid to be treated can circulate between the holding tank 130 and the first mechanical separator 134. As the liquid to be treated flows through the first mechanical separator 134 debris can be separated from the liquid to be treated and disposed of via waste stream 118. In this arrangement, the liquid can be circulated through the first mechanical separator 134 two or more times, and may be circulated any desired number of times to help separate physical debris from the stream. This may help facilitate the use of a relatively, physically smaller mechanical separator (and/or less efficient separator) than would be utilized in a system in which the liquid stream passes through a mechanical separator only once. This may help reduce the overall size of the system 100.

Optionally, the liquid to be treated can be circulated through the first mechanical separator 134 multiple times as part of a mechanical separation sub-cycle that is part of an overall first treatment cycle that is performed on the liquid to be treated while being treated by the first processing unit 104. In this arrangement, the mechanical separation sub-cycle can be performed for a predetermined period of time and/or until a desired degree of mechanical separation has been achieved. During this sub-cycle, the liquid to be treated may flow within the first flow path between the holding tank 130 and the mechanical separator 134 without passing through the electrical treatment apparatus 132. This may help ensure that a suitable amount of solid and/or semi-solid debris has been removed from the liquid to be treated before it is fed into the electrical treatment apparatus 132. This may help reduce fouling and/or damage to the electrical treatment apparatus 132 caused by solid debris entrained in the liquid to be treated. As described further herein, the mechanical separation sub-cycle may be configured to last for approximately one-third of the overall first treatment cycle. For example, if the first treatment cycle is configured to last for about 1 hour, the mechanical separation sub-cycle may be configured to run for about 5, 10, 15, 20, 25, 30, 35, 40, 45 or more minutes.

The mechanical separator 134 may be any suitable type of apparatus that can help filter and/or separate solid and semi-solid debris from the stream of liquid to be treated. This can include physical, porous filter media such as screens, foams, grills, nets and the like, as well as momentum separators, cyclonic separators and the like. In some embodiments of the system 100, the mechanical separator 134 may include at least one hydrocyclone that can help separate debris from the stream based on differences in their centripetal force and fluid resistance.

Optionally, the mechanical separator 134 may include two or more separating apparatuses arranged in series with each other. For example, the mechanical separator 134 may include two hydrocyclones arranged in series with each other, and/or a filtering screen positioned upstream or downstream from a hydrocyclone. This may help to increase the amount of debris that is separated from the liquid to be treated during each pass through the mechanical separator 134—i.e. during each mechanical separation sub-cycle and/or each pass through the mechanical flow path.

Optionally, the mechanical separator 134 may include two or more separating apparatuses arranged in parallel with each other. For example, the mechanical separator 134 may include two hydrocyclones connected in parallel with each other. As each hydrocyclone will have a maximum flow-through capacity, connecting two or more hydrocyclones in parallel may help increase the total flow-through capacity of the mechanical separator 134. This may help increase the volume of liquid to be treated that can be mechanically treated during a given mechanical separation sub-cycle.

### Electrical Treatment Apparatus

The electrical treatment apparatus 132 is provided as part of a reactor circulation flow path or a second flow path or circuit 133 whereby the liquid to be treated can circulate from the holding tank 130 to the electrical treatment apparatus 132, and vice versa, as part of an electrical treatment sub-cycle, which is also part of the overall first treatment cycle performed by the first processing unit 104. Preferably, the reactor circulation flow path may be free from physical filter media (screens, foam, mesh, grates and the like) or other such mechanical separators that may become fouled and/or may partially obstruct the flow of liquid through the reactor circulation flow path.

In the illustrated example, the second flow path 133 is generally separate from the first flow path 131, which can allow the liquid to be recirculated through the electrical treatment apparatus 132 several times if desired, without passing through the mechanical separator 134. For example, the liquid to be treated can be cycled through the second flow path 133 repeatedly during the course of the electrical treatment sub-cycle, which may be configured to last for approximately one-third of the overall first treatment cycle. For example, if the first treatment cycle is configured to last for about 1 hour, the electrical treatment sub-cycle may be configured to run for about 15, 20, 25, 30, 35, 40, 45 minutes or other suitable times. The duration of the electrical treatment cycle may be about the same as the duration of the other sub-cycles, such as the mechanical separation sub-cycle, or may be different.

The electrical treatment apparatus 132 may include one or more suitable processing units that are operable to treat the liquid via the application of an electric charge to the liquid to be treated. This may include one or more electrolysis processing units that can subject the liquid to be treated to electrolysis. Such treatments may promote flocculation and/or agglomeration in the liquid to be treated stream, such that relatively smaller contaminant particles can be urged to coagulate and/or clump together to form larger clusters that can be relatively easier to separate from the liquid being treated.

Optionally, the electrical treatment apparatus 132 can be configured as a flow-through apparatus, such that the liquid to be treated is generally continuously flowing through the electrical treatment apparatus 132 while it is being treated, rather than being held in a generally still, or static, tank for treatment. This may help reduce the likelihood that debris and/or reactor by-products (such as hydrogen gas, oxygen, foam and the like) may accumulate within the electrical treatment apparatus 132. Instead, such materials may tend to be drawn out of the electrical treatment apparatus 132 via the flowing liquid stream, and may be transported to the holding tank 130 where they may be collected and/or vented to atmosphere in the case of by-product gases.

Preferably, the first processing unit 104 can include a suitable changeover apparatus that is operable to selectably direct the liquid to be treated through the first flow path or the second flow path as desired. This changeover apparatus may include one or more valves, and may be manually actuatable and/or may be automatically controlled by a suitable system controller that can also include the related pumps and other flow apparatus. Automated control may be preferable, as it may allow the first processing unit 104 to progress through each of its sub-cycles in a desired order and/or for a desired duration without requiring an operator to manually adjust the apparatus.

Optionally, in addition to the mechanical separation and electrical treatment sub-cycles, the overall first treatment cycle may also include other sub-cycles, such as a settling sub-cycle, in which the liquid to be treated is held in the holding tank 130 for a predetermined settling time. This may allow further debris, as well as flocculate and/or contaminant clusters formed via the electrical treatment process to precipitate out of the liquid to be treated and collect as sludge at the bottom of the holding tank 130. The settling sub-cycle can be configured to last for approximately one-third of the overall first treatment cycle. For example, if the first treatment cycle is configured to last for about 1 hour, the settlement sub-cycle may be configured to run for about 20 minutes. The duration of the settlement sub-cycle may be about the same as the duration of the other sub-cycles, such as the mechanical separation sub-cycle and the electrical treatment cycle, or may be different.

When the first treatment cycle is complete—i.e. when all of the desired treatment steps and sub-cycles of the first treatment reactor 104 have been completed, the some or all of the batch of water contained in the first processing unit 104 can be pumped downstream to the second processing unit 106 for further treatment. As explained with respect to the balancing unit 102, it may be desirable in some instances to transfer only a portion of the liquid to be treated contained in the first processing unit 104 at any given time, as this may help dilute the relatively dirtier incoming liquid to be treated from the balancing unit 102 with some relatively cleaner, partially-treated liquid to be treated remaining in the holding tank 130, which may help regulate the contaminant levels in the liquid to be treated that is to be processed in the first processing unit 104. When at least some of the liquid to be treated has been pumped to the second processing unit 106, the next batch of liquid to be treated to be treated can be transferred from the balancing unit 102 to the first processing unit 104. The first and second processing units 104 and 106 may be configured to operate simultaneously, each treating its respective batch of liquid to be treated.

While described generally as a batch process, in some embodiments the liquid treatment system 100 can be operated as a continuous flow process, where at least some liquid to be treated is generally continuously flowing through the system (from the balancing unit 102 and through processing units 104 and 106) while treatment is ongoing.

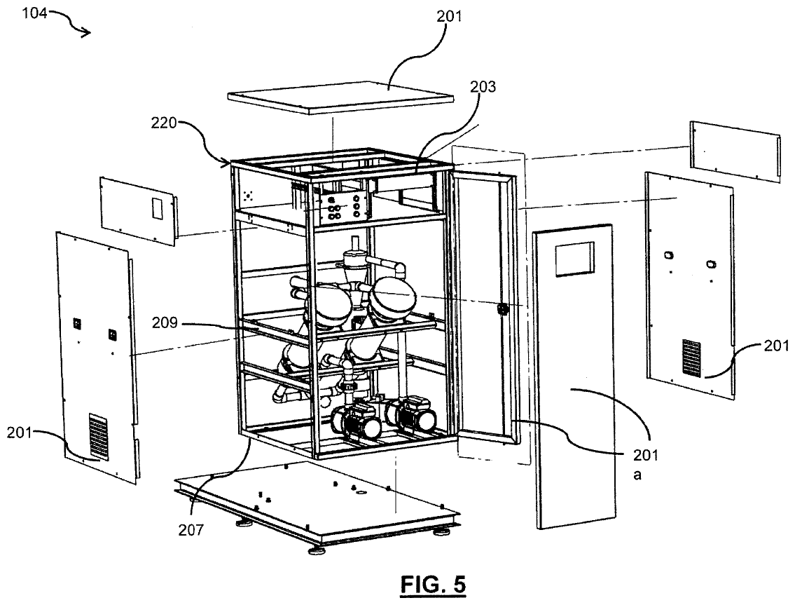

Referring to FIGS. 5 to 7, an example of a first processing unit 104 is configured as a generally modular cabinet 220 that includes a base 207 supporting a generally upstanding frame 209. The frame 209 can be at least partially and preferably substantially enclosed, by a plurality of panels 201 (shown in an exploded configuration to reveal the interior of the unit and the frame 209) that can help protect the interior of the unit. Optionally, one or more of the panels 201 can be configured as an openable door 201a to allow a system operator to access the interior of the unit and the components contained therein. Preferably, the openable doors 201a are located so as to provide access to at least the electrical treatment apparatus 134 when the doors 201a are opened. This may help facilitate access to the electrical treatment apparatus 134 for inspection, maintenance, and the like. The cabinet 220 can be sized to hold one or more of the sub-components of the first processing unit 104, but need not contain all components. As previously recited, the apparatus may be configured so as to occupy a substantially smaller physical footprint than the exemplary prior art cited and referred to in this document.

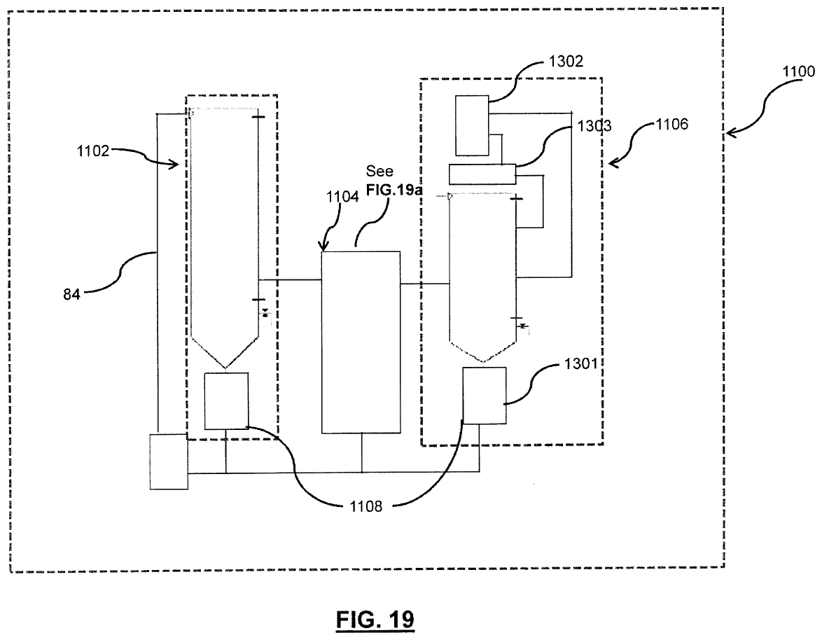

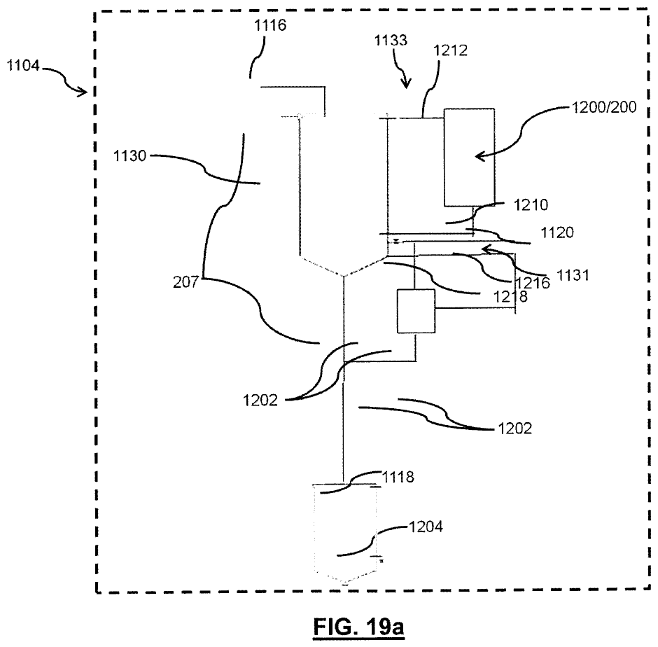

In this example, the holding tank 130 is not contained within the confines of the frame 209, and instead is external to the frame 209. This may help the frame 209 to remain relatively smaller (i.e. may have a footprint of approximately 4′×8′) which may help with transportation, installation, and placement of the processing unit components supported by the frame 209. The holding tank 130 may be relatively remote from the frame 209, if it is plumbed in fluid communication with the other processing unit components (such as shown schematically in the embodiment of the first processing unit 1104 in FIG. 19a). When in use, the modular cabinet 220 has a generally upright configuration, wherein the base 207 rests on and is substantially parallel to the ground or other surface supporting the cabinet 220. This can be the bottom or lower end of the cabinet 220 when in use. The frame 209 extends from the base 207 and with the panels 201, helps to define external boundaries of the cabinet 220 and to contain the one or more mechanical separators 132, electrical separation apparatuses 134 and the related piping, valves, pumps and other flow equipment as well as further apparatus corresponding to further possible cycles and sub-cycles. The modular cabinet 220 can also house the system controller unit 203, which could alternatively be located remote from the cabinet 220 or in the cloud or in any other suitable location where it can be communicably linked to the components of the system 100.

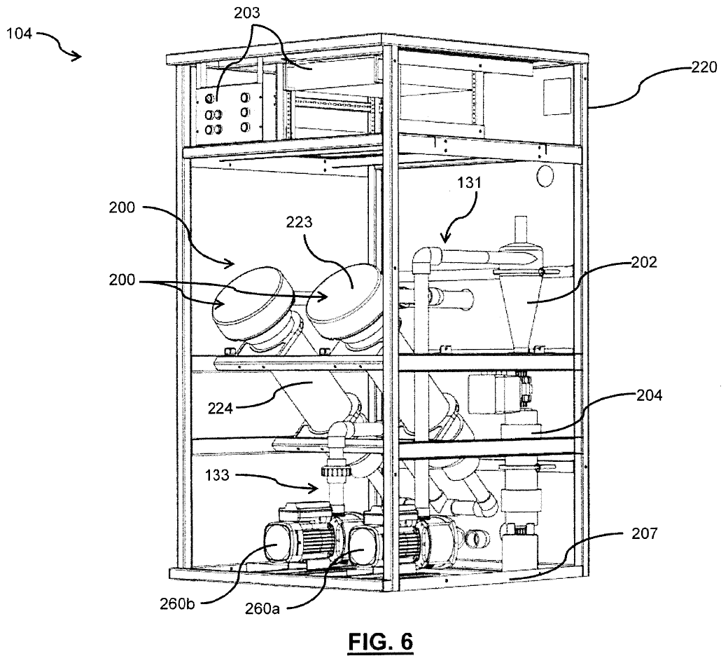

Referring to FIG. 6, in this example, the mechanical separator 134 includes one hydrocyclone 202 that is connected in the first flow path 131. In other examples, two or more hydrocyclones 202 may be provided, in series or in parallel with each other. The hydrocyclone 202 may be of any suitable size and configuration, and in the illustrated example is a Model 74HC6 hydrocyclone manufactured by Netafim,

A suitable pump 260a is also provided in the first flow path 131 to pump the liquid to be treated through the first flow path 131, and in this example, includes an electric drive motor. A sludge removal pod 204 is provided in association with the hydrocyclone 202, to help remove the solid and semi-solid debris separated by the hydrocyclone 202.

In this example the electrical treatment apparatus 132 includes two electrolysis processing units (ERUs) 200 that are arranged in parallel with each other in the second flow path 133. A suitable pump 260b is also provided in the second flow path 133 to pump the liquid to be treated through the second flow path 133, and in this example, includes an electric drive motor. Alternatively, a single ERU 200, or two or more ERUs 200 may be used based on the desired flow rates and treatment requirements of a given liquid to be treated treatment system 100. For example, the systems described herein may be operated to process between about 5 and about 20 m³/d of effluent per day, or more, and optionally may be configured to process about 10 m³/d of effluent per day. The reactor of this nature may cover less than 5 square meters, and may cover less than about 4, 3, 2, or 1 square meters. In some embodiments, the complete system 100 may be configured process 10 m³/d of effluent and to cover an area of less than about 20 square meters, and may cover less than 15, 10, 9, 8 or fewer square meters.

The electrolysis reactor units 200 may be of any suitable configuration operable to treat the liquid and to apply an electric charge to the liquid flowing through the ERUs 200. This may, in some embodiments, help convert incoming, relatively long-chain organic molecules, which may be referred to as base organic molecules in their native condition in the untreated liquid, to be treated into intermediate organic molecules. Optionally, an electrolysis reactor unit can be utilized in a variety of different embodiments of treatment and/or processing systems. Such electrolysis processing units may have generally analogous physical construction/arrangement to the ERU 200 but may utilize different functional components (such as the metallic composition of the electrodes and the like) and/or may be operated in different ways to perform a variety of suitable treatment operations on the water (or any other fluid) being treated.

For example, embodiments of the electrolysis reactor described herein may be configured to perform at least one of the following operations: electrocoagulation, electroflotation, electrooxidation, electroreduction, and/or a combination thereof.

Electrolysis reactors configured to perform electrocoagulation may be useful in processing water or other liquids containing physical particulate (such as dirt and debris), suspended solids, heavy metals and the like. In this process an electrical charge driven through the liquid causes a deterioration of the anode(s), which releases charged ions into the liquid. These ions react with other charged particles in the liquid causing them to bind together and create larger or denser particles which will sink in the liquid being treated. Optionally, the anodes utilized in such reactors may be aluminum, or include a relatively higher concentration of aluminum than standard anodes, which may help facilitate the electrocoagulation process as metal from the anodes is consumed during use. Other anodes may be or contain other metals such as magnesium, nickel, zinc, iron, or manganese. The metal content of the anode will influence the electrocoagulation reaction and some metals may be preferable for certain contaminants.

Electrolysis reactors configured to perform electroflotation may be useful in treating liquids containing emulsified fats, oils, grease and the like. Applications of this embodiment of an electrolysis reactor may include: treatment of wastewater from dairy processing facilities, treatment of wastewater prior to entering a septic bed, treatment of grease traps (such as those found at restaurants and other commercial establishments) and the treatment of industrial oil/coolant and particle separation (such as the treatment of coolant fluid extracted from CNC machines). In this process the electrolysis caused by passing electricity through water will split some water molecules into Hydrogen gas and hydroxide ions. The hydrogen gas adheres to emulsified fats, oils, or greases and causes them to float to the top portion of a tank where they can be removed. The metals released from the anode also have a destabilizing effect on the emulsified oil. When the emulsion is broken, the oil particles can join together to form larger and more buoyant particles which will also float. As compared to electrolysis reactors configured for other uses, the electrolysis reactors configured for electroflotation may be operated at lower power levels because some applications such as dairies have relatively high levels of dissolved salts, which make the water more conductive for electricity. For example, a reactor configured for electrocoagulation in a dirt-removal system may operate at 3000 Watts. A reactor configured for electroflotation in a dairy may operate at 1500 Watts, but treat an equivalent amount of effluent.

Electrolysis reactors configured to perform electrooxidation or electroreduction (that is, an oxidation or reduction reaction induced by the application of electrolysis) may be useful in treating liquids for the purposes of disinfection and/or dissolved metal treatment. The hydrogen and hydroxide ions created in the electrolysis reaction can react with dissolved metals to oxidize or reduce them. This oxidation or reduction can cause these dissolved metals to become insoluble. Once they become insoluble, the metal released from the anode(s) can produce an electrocoagulation effect, causing the solids to sink for collection. Such reactors may also be configured to help break down relatively large, long-chain molecules and other biological or organic materials through the creation of chlorine, which is generated by the electrolysis reaction in the presence of chloride ions. As compared to electrolysis reactors configured for other uses, the electrolysis reactors configured for electrooxidation or electroreduction may utilize a combination of anode materials. Some anodes containing a higher proportion of magnesium may deteriorate faster, while other alloys of aluminum such as 6061 deteriorate slower. This combination can contribute relatively more metal ions into the liquid, while retaining other anodes for the electrolysis reaction.

Referring again to the embodiment of FIG. 6, preferably the incoming organic molecules (in the stream received from the balancing unit 102) can be broken down by the ERUs 200, such that the relatively long-chain large organic contaminant molecules, such as flavor-contributing compounds and ring structures like phenols, complex sugars and starches from grains are broken down via electrolysis and converted into relatively simpler structures and simple sugars. Such relatively simple, intermediate organic compounds may be more easily digested/treated by, for instance, the biological treatment processes in the second processing unit 106.

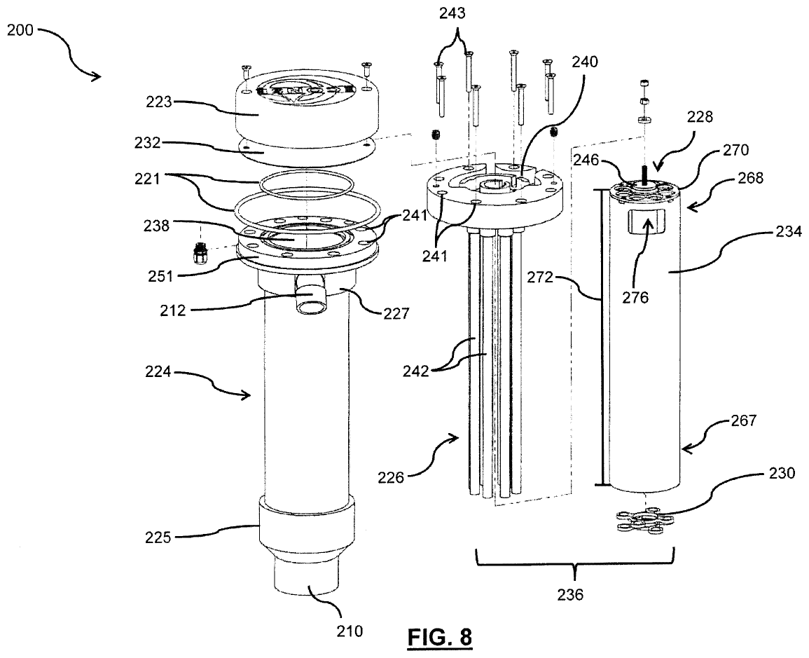

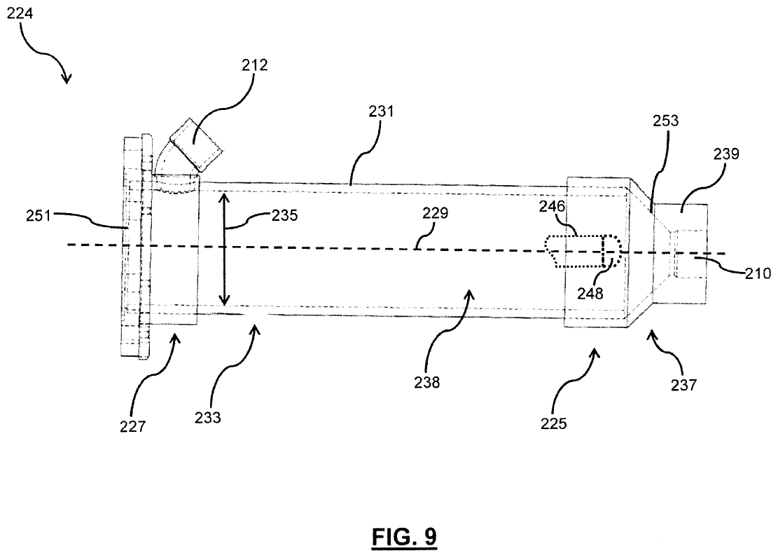

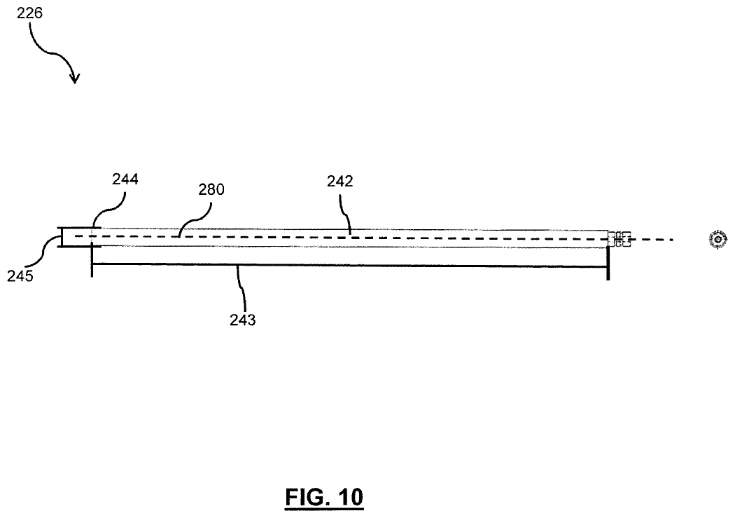

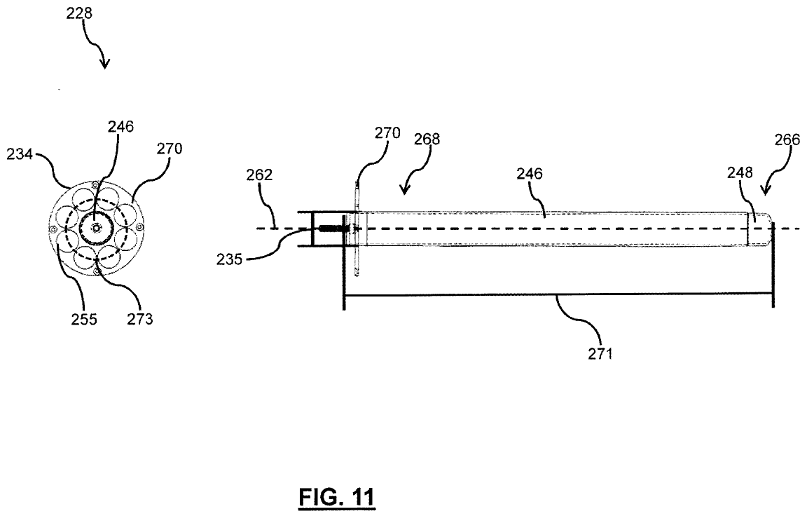

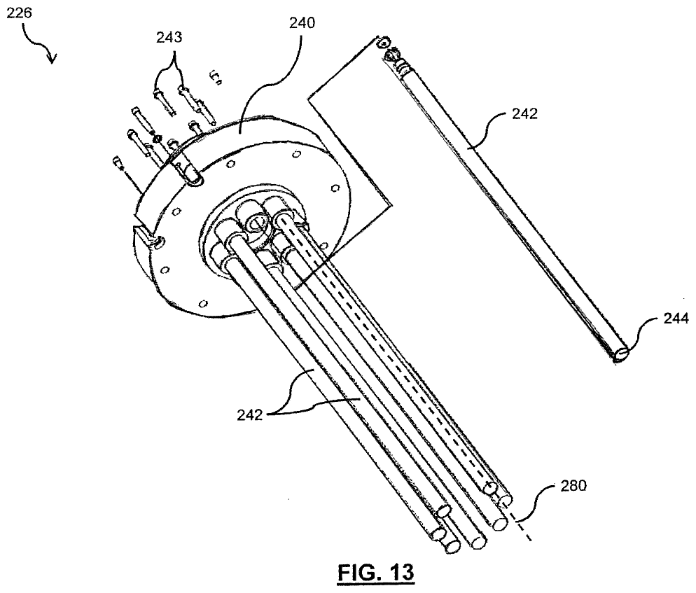

Referring also to FIGS. 8-13, one example of an ERU 200 includes a housing 224 that has a lower end 225, an upper end 227 that is spaced apart from the lower end 225 along a reactor axis 229 and a sidewall 231 extending therebetween (FIG. 9). In this example the sidewall 231 includes an upper portion 233 that is generally cylindrical in configuration and has a generally constant diameter 235 (FIG. 9) and a lower portion 237 that has a generally tapered interior surface 253. The lower portion 237 is disposed toward the lower end 225 of the housing 224 and expands from the lower end 225 toward the upper portion 233.

A reactor inlet 210 is provided at the lower end 225 of the housing 224, and in this example is provided in a lower end wall 239 that caps the lower end of the housing 224. The lower end wall 239 may be integrally formed with the sidewall 231 or, as illustrated, may be provided as part of a separate cap member (which also includes the lower, tapered portion 253 in this example). In this configuration, liquid to be treated flowing into the housing 224 via the reactor inlet 210 travels generally axially, i.e. generally parallel to the reactor axis 229.

A reactor outlet 212 is provided in the housing 224 at a location that is axially spaced apart from the reactor inlet 210. In this example, the reactor outlet 212 is provided as an aperture in the sidewall 231 and is located at the upper end 227 of the housing 224. In this arrangement, liquid to be treated can flow generally axially through the hollow interior 238 of the housing 224, from the reactor inlet 210 to the reactor outlet 212, and can travel in a generally lateral/radial direction when exiting via the reactor outlet 212 (i.e. generally orthogonal to the reactor axis 229).

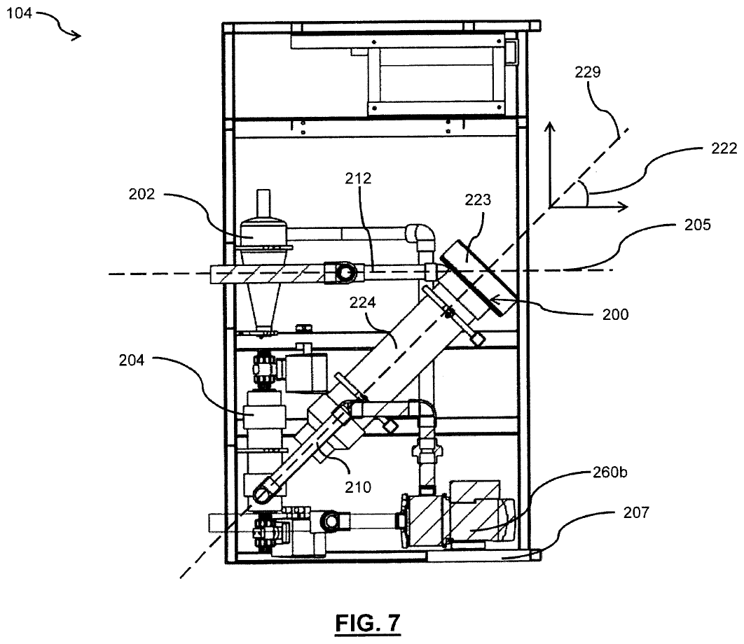

When installed in the cabinet 220 and in use, the ERU 200 is preferably mounted so that the upper end 227 is above the lower end 225, such that liquid to be treated travels generally upwardly through the ERU 200. More preferably, the ERU 200 can be mounted in an inclined position, such that when in use the reactor axis 229 is inclined relative to the horizontal direction at a reactor angle 222 (FIG. 7) that can be between about 20 degrees and about 70 degrees, and may be between about 30 and 60 degrees and may be about 45 degrees.

Orienting the ERU 200 in this manner may help cause gas bubbles and/or foam generated within the ERU 200 to bubble toward the upper end 227 due to their inherent buoyancy in the liquid, and they may be further assisted by the flow of the liquid to be treated.

In the illustrated example, the ERU 200 is also rotationally oriented (about the reactor axis 229) so that the reactor outlet 212 is provided in the upwardly facing portion of the sidewall 231, and is at a relative highpoint of the interior 238 of the housing. In this configuration, the reactor outlet 212 lies in a superior plane 205 that is generally parallel to and spaced above the cabinet base 207, and is at the highpoint of the housing interior 238. Positioning the reactor outlet 212 in this location may help facilitate the removal of accumulated gas and/or foam from the interior 238, as the gas and/or foam may tend to be urged by the flowing liquid to be treated to exit via the reactor outlet 212.

Optionally, the ERU 200 may also include at least one galvanic cell, having at least one cathode assembly and at least one compatible anode assembly that is positionable within the housing 224 and is operable to generate the desired electrolysis reaction within the ERU 200. The galvanic cell may have any suitable configuration and may be sized based on the expected type of organic contaminants in a given liquid to be treated stream. When the ERU 200 is in use, the components in the galvanic cell may tend to be at least partially consumed and/or fouled over time, which may impact the performance/efficiency of the ERU 200. This is a deliberate departure from what is taught some conventional uses of such reactors, where consumption of the electrodes is generally taught as something to be avoided.

Optionally, the ERU 200 can be configured so that substantially the entire galvanic cell, and preferably at least the cathode and anode components/assemblies that are immersed in the liquid to be treated, can be removable from the housing 224 as a single unit/cartridge. This may allow relatively quick and easy access to the components of the galvanic cell for inspection and/or maintenance if needed. Optionally, more than one galvanic cell can be provided to a user of the system 100, and the galvanic cells can be generally interchangeable with each other such that a used/fouled galvanic cell can be removed from the housing 224 and replaced with a new, replacement galvanic cell. This may help reduce the amount of downtime experienced by the ERU 200, as the new galvanic cell can be installed in the housing 224 and the ERU 200 restarted while the original galvanic cell is inspected or repaired offline.

Preferably, the galvanic cell can be removable and/or replaceable without having to disconnect any of the fluid supply lines on the ERU, and without having to change or reconfigure other aspects of the housing 224. For example, the galvanic cell is preferably removable from the housing 224 without interrupting or reconfiguring the connections at either the reactor inlet 210 and/or reactor outlet 212. In such embodiments, the reactor inlet and outlet 210 and 212 can be spaced apart from the galvanic cell and its connecting members, such that the galvanic cell is independently removable. This may help facilitate changing/replacement of the galvanic cell. That is, this may tend to make the apparatus more efficient for the user to clean and or replace than some conventional reactor designs that would require disconnecting of the liquid supply lines (i.e. re-plumbing), valving or other changes to the liquid flow path, i.e. while maintaining the fluid connections to the reactor, in order to open the reactor housing and/or to allow removal of the galvanic cell.

Referring also to FIGS. 8 to 13, in the illustrated example the ERU 200 includes a galvanic cell 236 that has a base member 240 that supports an anode assembly 226 and a compatible cathode assembly 228. The anode assembly 226 and cathode assembly 228 are both insertable into the interior 238 of the housing 224 and the base member 240 can rest on and seal the open upper end 227 of the housing 224. In this example, the housing 224 can include a mounting flange 251 to support the base member 240, and both the flange 251 and base member 240 can include a plurality of apertures 241 to receive mounting fasteners 243. Optionally, one or more suitable sealing members, such as gaskets or O-rings 221 can be provided to ensure a seal that is sufficiently liquid-tight and optionally substantially airtight at the upper end 227.

When connected in this manner, the anode assembly 226 and cathode assembly 228 are both suspended from the base member 240 and are cantilevered within the interior 238 of the housing 224. Neither the anode assembly 226 nor the cathode assembly 228 is directly, physically mounted to the housing 224 or other portions of the ERU 200. This may help facilitate removal of the galvanic cell 236.

A removable reactor lid 223 can be provided to cover the exposed end of the galvanic cell 236 when it is inserted into the housing 224. The lid 223 can help protect and enclose the galvanic cell 236 cell and its components. In the illustrated example, the galvanic cell 236 has a proximate end (upper end in this case) that is mounted to an inner surface of the lid 233 and an axially opposing distal end that is spaced form the lid 233. In this configuration, when the lid 223 is mounted to the upper end 227 the galvanic cell 236 is suspended within the housing 224 and its distal end is spaced apart from the lower end of the housing 224, and when the lid 223 is removed from the housing 224 the galvanic cell 236 is removed from the housing 224.

When access to the galvanic cell 236 is desired, an operator can remove the lid 223 to expose the base member 240, and remove the fasteners 243. The base unit 240, along with the anode assembly 226 and cathode assembly 228 suspended there from, can be removed from the housing 238 by translating the galvanic cell 236 at least substantially axially relative to the housing 224 (i.e. parallel to the reactor axis 229).

Referring to FIGS. 8, 10 and 11, in this example the cathode assembly 228 includes an optional inner, central cathode rod 246 that has one end that is connectable to the base 240 and an opposing free end that is spaced from the connecting end by a cathode rod length 271 along a cathode rod axis 262. In this example, the cathode rod axis 262 is substantially parallel to the reactor axis 229, but need not be in all configurations.

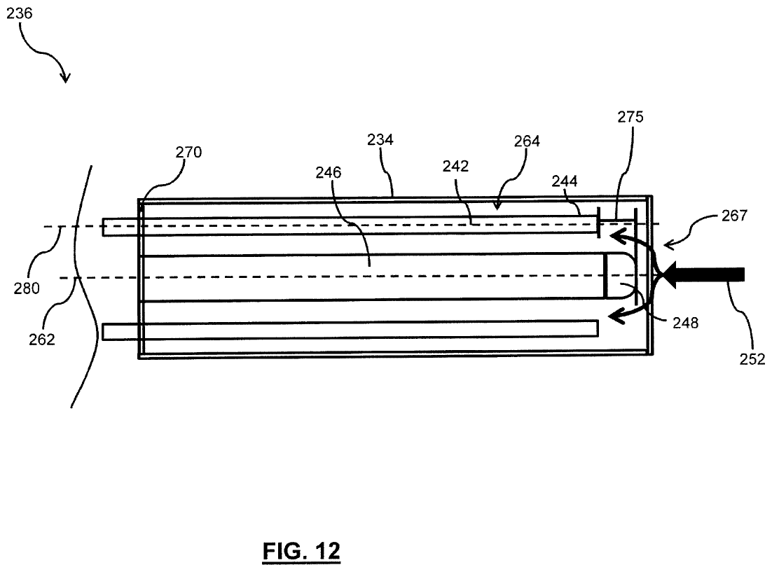

Referring also to FIG. 12, the cathode assembly 228 also includes an outer cathode sleeve 234 that laterally surrounds the central cathode rod 246 (and the anode assembly 226), such that a generally annular flow region 264 is created between an outer surface of the central cathode rod 246 and an opposing inner surface of the cathode sleeve 234. A lower end 267 of the cathode sleeve 234 is open to receive incoming liquid to be treated, and an opposing upper end 268 is capped with a cover plate 270. The cover plate 270 includes a plurality of spaced apart anode holes 255 spaced to align with and receive portions of the anode assembly 226. The anode holes 255 are spaced apart from each other around a spacing circle 273. The cathode sleeve 234 has a length 272 in the axial direction that is generally equal to, and preferably slightly greater than the length 271 of the central cathode rod 246. In some embodiments, the ERU 200 can be configured such that it only includes the cathode sleeve 234, and need not include the central cathode rod 246. This may provide less flow resistance to liquids flowing inside the cathode sleeve 234 and along the length of the anode rods 242 provided therein.

Optionally, the ERU 200 can be configured to help limit and/or reduce the turbulence of the liquid to be treated flowing through the ERU 200. This may help reduce foam creation and/or improve the ERU 200 performance/efficiency. Optionally, the ERU 200 can be configured so that the liquid flow is generally laminar as it passes through the ERU 200. Optionally, the galvanic cell 236 or other suitable portion of the ERU 200 can include a flow directing surface which, when the ERU 200 is in use, can help direct the incoming flow of liquid to be treated entering via the reactor inlet 210 and help reduce turbulence caused at the reactor inlet 210. Optionally, the flow direction surface may be positioned proximate the reactor inlet 210, and may face and at least partially (or optionally completely) overlie the reactor inlet 210. The flow directing surface may be integrally formed with and/or fixedly connected to the housing 224, or may be removable from the housing 224.

Optionally, the cathode rod may have a tip such that turbulent flow is caused in the liquid being treated. As already recited, this may help provide a cleaning action as the liquid flows turbulently against the electrodes. This may also help enhance the degree of mixing with the ERU 200 and may enhance the contact between the liquid and the electrodes, which may help facilitate the desired reactions.

In the illustrated example, the lower end 266 of the cathode rod 246 has a generally rounded tip 248 that provides a flow directing surface. The tip 248 may be of any suitable configuration, and as illustrated is a generally convex, dome-like surface. When the galvanic cell 236 is positioned within the housing 224, the tip 248 is positioned proximate and generally facing the reactor inlet 210 (as shown in phantom in FIG. 9). In this position, an incoming liquid to be treated flow, shown using arrows 252 in FIG. 12, may contact the tip 248 and be gently diverted into the annular flow region 246 within the cathode sleeve 234.

To help facilitate removal of the liquid to be treated from within the annular flow region 246, the cathode sleeve 234 may include one or more outlet ports. Preferably, any such outlet ports can be positioned proximate, and optionally generally registered with, the reactor outlet 212 in the housing 224. This may help facilitate a relatively easy flow path for the liquid to be treated from the outlet port to the reactor outlet 212, which may help improve flow efficiency and/or reduce losses and/or inhibit turbulence. In the illustrated example, the cathode sleeve 234 includes a generally radially oriented outlet port 276 that is provided at its upper end 268. When the galvanic cell 236 is inserted, it can be oriented so that the outlet port 276 generally faces and overlies the reactor outlet 212.

Referring to FIGS. 8, 10, 12 and 13, in the illustrated example the anode assembly 226 includes a plurality of anode rods 242 that are mounted to, and extend from the base member 240 to respective tips 244. Each anode rod 242 extends along a respective anode axis 280 and has a length 243 in the axial direction and a diameter 245. The anode length may be any suitable length, and may be between about 16 inches and about 36 inches or more, and in the illustrated example is about 24 inches. Eight anode rods 242 are used in the present example, but different numbers may be used in other embodiments.

When the galvanic cell 236 is assembled, the anode rods 246 are inserted through respective ones of the anode holes 255 in the cover plate 270, and are positioned inside the annular flow region 264 to be submersed in the liquid to be treated flowing therethrough.

Referring to FIG. 12, optionally, the anode rods 242 may be shorter than the central cathode rod 246, such that the tip 248 of the cathode rod 246 extends beyond the tips 244 of the anode rods 246 by an offset distance 275. This may help ensure that the tip 248 contacts the incoming liquid to be treated stream before it reaches the anode tips 244. The offset distance 275 may be any suitable distance, and may be in the range of between about 10 mm and about 30 mm or more, based on variety of factors including industrial application, applicable flow rates, contaminants' integrity and physical properties, as well as many other factors.

In this example, the anode rods 242 are generally circular in cross-sectional shape and solid (i.e. liquid does not flow within the interior of the anode rods 242). This can help ensure that a desirable amount/mass of the anode rod material is provided in a relatively compact space/volume. This may be useful in applications in which the anode rods 242 are intended to be consumed, as it may help provide a desired quantity of metal to the reaction process, and may reduce the frequency at which the anode rods 242 require replacement.

Optionally, the base member 240 can include suitable conductive members to electrically connect the plurality of anode rods 242 to each other at a common potential. An optional electrical separator 232 (FIG. 8) can be provided to help inhibit sparks and arc flash, and may help reduce condensation at the electrodes.

Optionally, an anode separator 230 can be provided toward the lower end of the cathode sleeve 234 to receive and help maintain a desired separation distance between adjacent ones of the anode rods 242 and the central cathode rod 246.

Optionally, the housing 224 can be made from any suitable material, and preferably is not electrically conductive. Suitable materials can include plastics such as PVC, UPVC, CPVC, PE and/or PVDF. Some of these may be preferable in a given system based on different physical and chemical properties required by different industrial applications. Optionally, the anode assembly 226 can be made from 6061-T6 aluminum or other materials including suitable Aluminum Alloys, and suitable Magnesium Alloys. The cathode assembly can be made from any suitable material, including suitable Ferritic, Austenitic or Duplex types of stainless steel materials, and the like. The materials chosen for a given galvanic cell may be based on the physical and chemical properties desired for a given industrial applications.

### Second Processing Unit

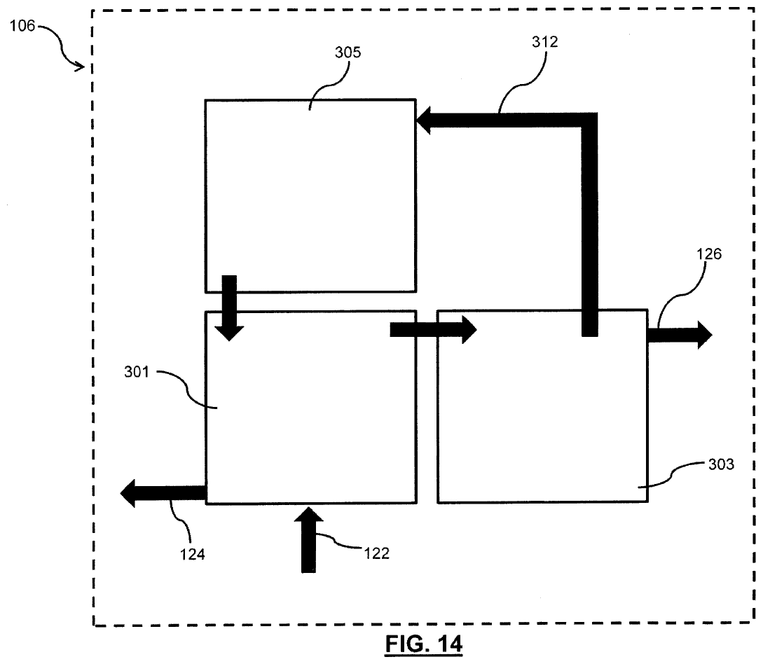

Referring now to FIG. 14, an example of second processing unit 106 of the system 100 includes a first holding tank 301 for receiving incoming, partially treated liquid to be treated from the first processing unit 104 via the inlet 122. A second holding tank 303 is connected in fluid communication with the first holding tank 301 such that liquid to be treated can be circulated between the holding tanks 301 and 303 as desired. The second processing unit 106 also includes at least one biological processing unit 305 that is fluidly connected to the holding tanks 301 and 303. Optionally, as illustrated, the biological processing unit 305 can be located substantially at a higher elevation than the first holding tank 301 and the second holding tank 303, which may help the liquid to be treated stream to percolate downwardly through the biological processing unit 305 via gravity. This may help contribute to electrical energy saving, as the liquid to be treated may require less pumping energy. In some situations where higher efficiency is required and cost of electricity is prohibitive, this may represent a further advantage of the invention.

In this arrangement, a bio/third flow path 312 is created whereby the liquid to be treated can circulate through the first tank 301, into the second tank 303, and then into the biological processing unit 305 before returning to the first tank 301. The liquid to be treated may be cycled in this manner for as long as desired to achieve a desired level of biological treatment. During this cycle, the liquid to be treated may flow through the biological processing unit 305 several times. Suitable pumps and valves for directing the flow in this manner can be provided. Optionally, during the course of an overall treatment cycle in the second processing unit 106, the liquid to be treated may be circulated through the biological processing unit 305 in a biological sub-cycle for a given amount of time, and then allowed to rest in the tanks 301 and/or 303 in a settlement sub-cycle. Each sub-cycle may be performed only once during the overall treatment cycle in the second processing unit 106, or may be performed multiple times within a given overall treatment cycle in the second processing unit 106 (i.e. prior to discharging the batch of liquid to be treated via the treated water outlet 126).

Sludge and other such debris accumulated during the second processing unit treatment cycle can be removed via a waste output stream 124. When treatment via the biological processing unit 305 is complete (i.e. the overall treatment cycle is complete), the liquid to be treated can be discharged from the second processing unit 106, and from system 100, via the treated water outlet 126. Optionally, the overall treatment cycle in the second processing unit 106 can be configured to have a duration that is generally similar to the treatment cycle duration in the first processing unit 104.

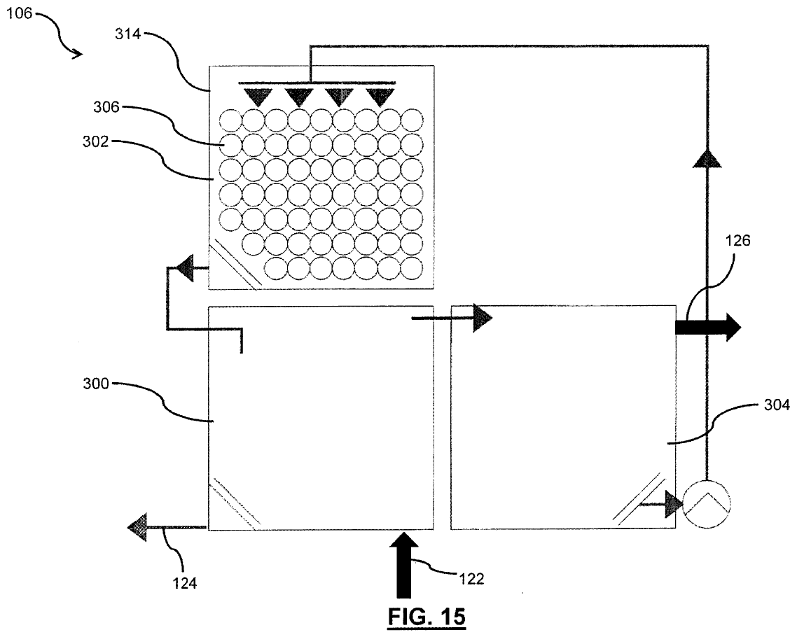

Referring to FIGS. 15-17, an example of a second processing unit 106 in one arrangement includes a first tank 301 that is provided in the form of a holding tank 300, a biological processing unit 305 that is provided in the form of a biological processing unit (BRU) 302, and a second tank 303 that is provided in the form of a collection tank 304. In this example, the effluent from the first processing unit 104 can enter the second processing unit 106 through the second effluent inlet 122 into the holding tank 300. The effluent can be held in this holding tank for a suitable time period, which can be selectable/adjusted based on sedimentation speed of contaminants, to help facilitate settlement and removal of sediment via the third waste output stream 124. The tanks 300 and 304 may not be empty when a current batch of effluent is received, and the incoming, relatively dirty effluent (i.e., not yet biologically treated) can be mixed with a quantity of relatively clean effluent (that has already been biologically treated). The effluent from tank 300 can move into the collection tank 304, from which it circulates into the BRU 302.

The biological processing unit 302 can be any suitable apparatus, and in this example has a shell 314 that can contain a plurality of biological support scaffolds that can be populated with suitable bio-organisms/biomass. In this example, the support scaffolds include a plurality of hollow spherical column packing balls 306. One example of a suitable column packing ball is the 2″ Kynar PVDF Tri Packs. The plurality of packing balls 306 could be contained within the BRU 302 at any suitable ratio, and in this example are configured with a ratio of about 1:10 litres of packing balls to expected litres of effluent to be treated. The BRU 302 reduces and eliminates any remaining organic components that are dissolved in the liquid to be treated, including BOD and nutrients such as TP and TKN, by using combined aerobic and/or anaerobic digestion processes.

After passing through the BRU 302, the liquid to be treated can recirculate back into the holding tank 300, and flow into the collection tank 304. If the biological treatment cycle includes more than one such sub-cycle, the liquid to be treated can again be pumped up into the BRU 302. This sub-cycle process can be repeated until the liquid to be treated is sufficiently retreated, at which point at least some of the liquid to be treated held in the tanks 300 and 304 can be released out of the treated water outlet 126 where it can be disposed of down the drain or sent for further processing. The second processing unit cycle requires 12-24 hours on average before effluent has been treated and can be removed via the treated water outlet 126.

The second processing unit could have a footprint of approximately 2 square meters, and could be modular to allow for expansion. For example, system 100 may include two or more second processing units 106 (and/or two or more first processing units 104) to accommodate different expected liquid flow rates and contaminants. As already recited, such substantial relative decrease in the footprint of the device may represent a further advantage of the invention.

In this example, the holding tank 300 has a volume of about at least 5000 L, while the BRU could be designed for approximately 20,000 Lit/day of treatment in some applications. This capacity can be changed upwardly or downwardly based on the severity of concentration and type of biological contaminants expected in the system.

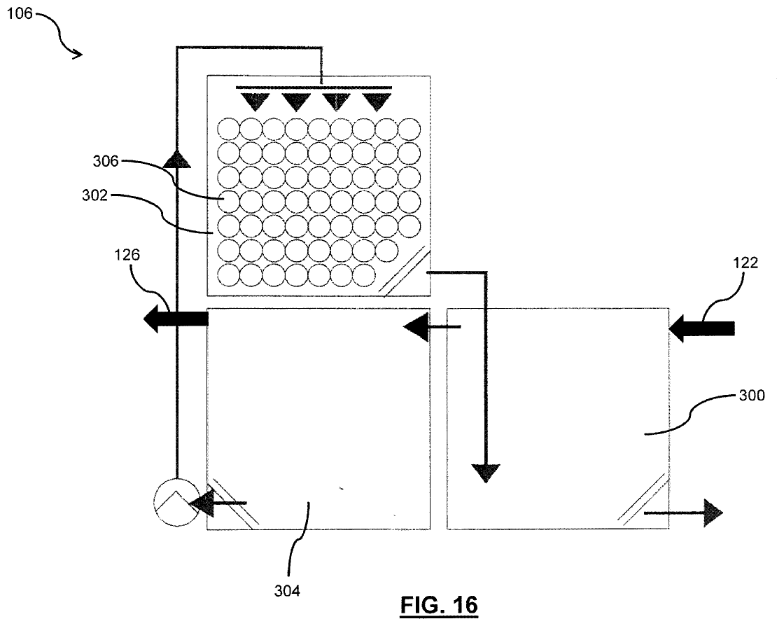

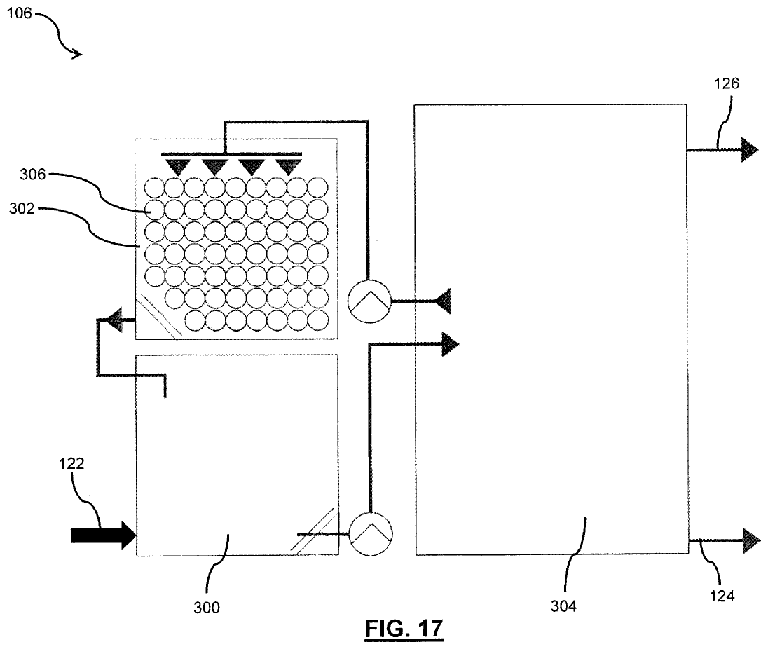

Referring to FIGS. 16 and 17, other configurations of a second processing unit 106 including a holding tank 300, a collection tank 304, and a BRU 302 with a plurality of packing balls 306. The effluent could enter the holding tank via the second effluent inlet 122, circulate into the collection tank 304, and then cycle through the BRU 302. Filtered effluent could then re-enter the collection tank 304, from which sediment could settle and be removed via the third waste output stream 124, and treated effluent could exit via the treated water outlet 126.

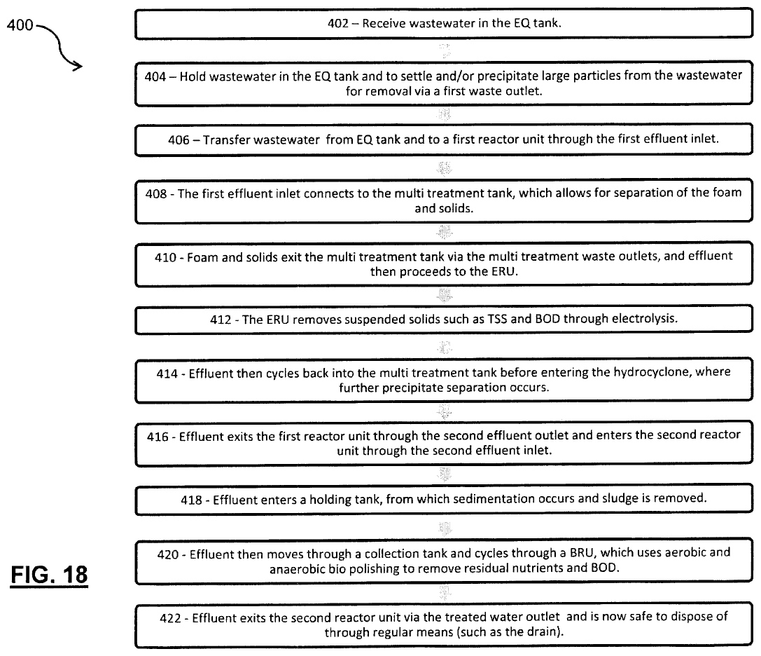

FIG. 18 concerns one example of method 400 of treating water using the system 100. In this example, the method can include the step of, at step 402, yellow effluent entering the EQ tank, and at step 404, effluent sitting until large waste has settled and been removed. The method can also include effluent flowing into the first processing unit (step 406) and entering the multi treatment tank where foam and solids are separated (step 408) and foam and solids exit the tank via the multi treatment waste outlets (step 410). The system then, at step 412, treats the effluent in the ERU. The method can also include cycling the effluent into the hydrocyclone (step 414) following which the effluent enters the second processing unit (step 416). The method can then include, at step 418, the effluent entering the holding tank of the second processing unit, following which it can cycle through the collection tank and BRU (step 420) to allow for bio polishing. Finally, the system can then, at step 422, allow the effluent to exit the second processing unit through the treated water outlet, at which point it is safe to dispose of normally.

In some examples of operating a liquid treatment system 100 described herein, an incoming influent flow can be directed into the balancing unit 102 and held for a predetermined period of time. Then, at least a portion of the liquid in the balancing unit 102 can be transferred to the first processing unit 104 and subjected to at least one first treatment cycle where it is treated by at least one mechanical separator and at least one electrical processing unit. Optionally, the first treatment cycle can include two or more sub-cycles, such as a mechanical sub-cycle, an electrical treatment sub-cycle, and a settling sub-cycle. The mechanical sub-cycle can include circulating the liquid to be treated between a holding tank and the mechanical separator for a desired number of times, without passing the flow through the electrical processing unit. After the mechanical sub-cycle has been completed, the electrical treatment sub-cycle can be performed. Following that, the settling sub-cycle can be completed, thereby completing the first treatment cycle.

When treatment at the first processing unit 104 has been completed, the batch of partially treated liquid to be treated can be moved to the second processing unit 106 to undergo at least one second treatment cycle. The second treatment cycle includes at least a biological treatment sub-cycle, and optionally may include a settling sub-cycle.

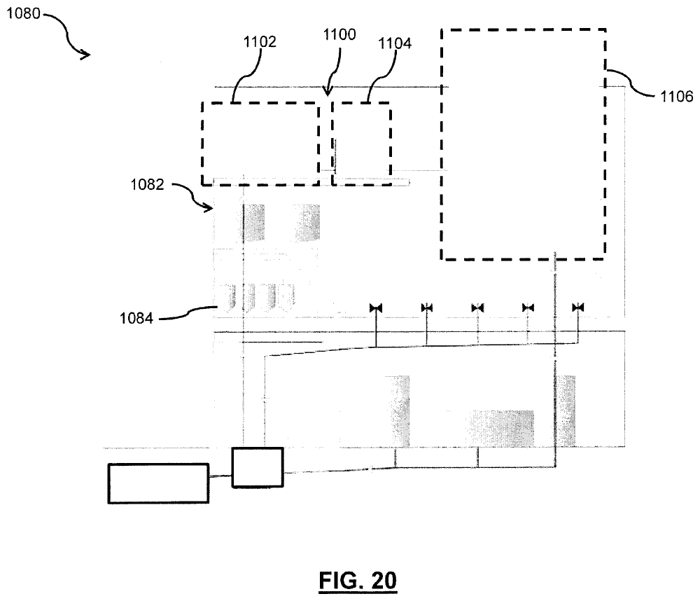

Based on the above, some embodiments of a treatment system 100 were completed and operated to help evaluate their performance. Referring to FIGS. 19 to 20, a schematic of one example of a water treatment system 1100 that is generally similar to water treatment system 100 is illustrated, with like features being annotated using like reference characters indexed by 1000. This system 1100 was tested at a brewery as shown in FIG. 20 and was generally configured as shown in FIG. 19. An example of the first processing unit 1104 from this system is shown in more detail in FIG. 19a. In this example, the system 1100 includes a balancing unit 1102, a first processing unit 1104, a second processing unit 1106, and a waste removal unit 1108. In this embodiment, the yellow liquid to be treated 1084 from the brewery 1082 is supplied to the water treatment system 1100.

In this example, the first processing unit 1104 includes two hydrocyclones 1202, and one ERU 1200. The effluent enters the multi treatment holding tank 1130 through the first effluent inlet 1116 and can then be cycled through the first flow path 1131 and through the hydrocyclones 1202, where it can undergo a mechanical treatment process to remove solids, colloidal solids (TSS), and the majority of BOD and nutrients (TP, TKN). The liquid to be treated can then be cycled through the ERU 1200 through the second flow path 1133. The liquid to be treated enters the ERU inlet 1210 and is subjected to electrolysis, following which it is cycled back into the multi treatment tank 1130 by exiting the ERU 1200 through the ERU outlet 1212.

This example of a treatment system 1100 was installed at a test brewery and the liquid to be treated was tested, with the water treatment outcomes provided in Table 1 below.

TABLE 1
Outcomes of the described water treatment system for a brewery with
reference to the components included.

| | | December | | | |
|---|---|---|---|---|---|
| | | 2016 | | Level 2 | |
| | | Auto | Level 1 | Treatment | |
| | Regulation | Sampler | Treatment | Full System | |
| | daily | With Side | ERU 200 | (with ERU 200 | Test |
| | Mg/l | streaming | System | and BRU 302) | Method |
| pH | 5.5 to 9 | 5.78 | 6.5 | 7.0 | CAM SOP- |
| | | | | | 00413 |
| TSS | 350 | 281 | 53 | 35 | CAM SOP- |
| | | | | | 00428 |
| TP | 10 | 25.4 | 11.6 | 2.6 | CAM SOP- |
| | | | | | 00407 |
| BOD | 300 | 3820 | 1240 | 99 | CAM SOP- |
| | | | | | 00427 |

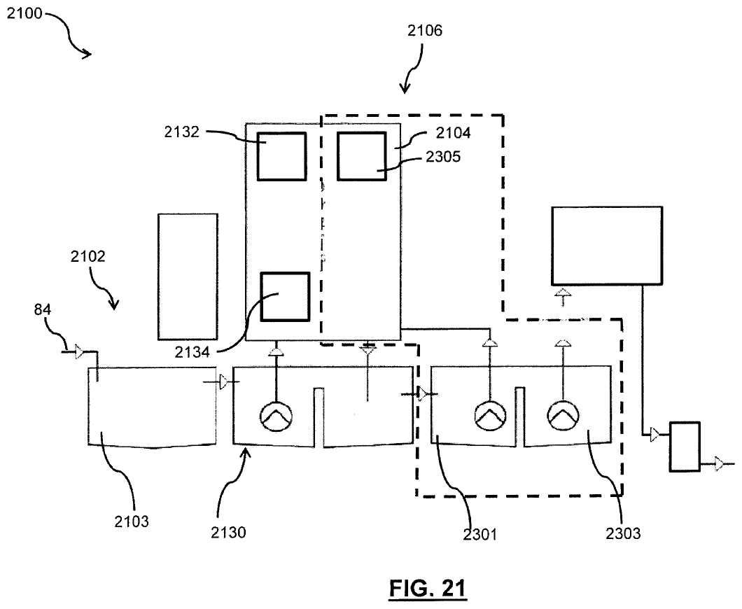

Referring to FIG. 21, yet another example of a treatment system 2100 was built and tested. The treatment system 2100 is generally similar to water treatment system 100 as illustrated, with like features being annotated using like reference characters indexed by 2000. The wastewater treatment system 2100 in this example includes a balancing unit 2102, a first reactor unit 2104, and a second reactor unit 2106. The system was run as described herein, and the water treatment outcomes are provided in Table 2 below.

TABLE 2
Outcomes of the described water treatment system for a brewery in
British Columbia with reference to the components included.

| | | | | | Full | |
|---|---|---|---|---|---|---|
| | | | | | Treatment | |
| | Effluent | | | | (ERU | |
| | Tank 3 | | | | 200 and | |
| | Feb. 25, | | | | BRU 302) | |
| | 2017 | | | | Treatment | |
| | sample | | | | Results | |
| | With Side | | | | Full System | |
| | streaming | Lagoon | Lagoon | Lagoon | (with BRU) | |
| | And pH | Sep. 24, | Jan. 24, | Feb. 25, | Replaced | Test |
| | adjustment | 2016 | 2017 | 2017 | Lagoon | Method |
| pH | 6.43 | 5.07 | 4.79 | 5.89 | 6.7 | APHA 4500 |
| | | | | | | H |
| TSS | 151 | 131 | 74 | 96.7 | 52 | APHA 2540 |
| TP | 24 | NA | NA | NA | NA | NA |
| BOD | 3738 | 3650 | 2030 | 1320 | 234 | APHA 5210 |

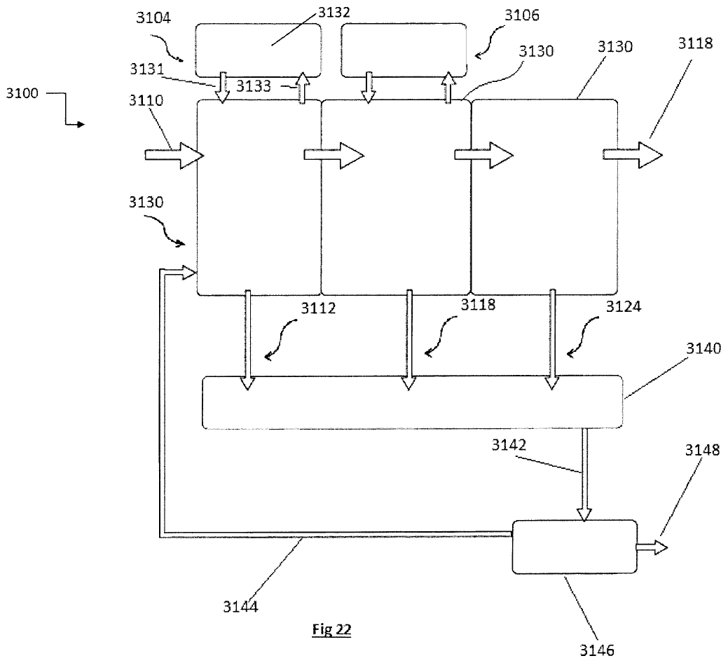

Referring to FIG. 22, yet another example of a treatment system 3100 is depicted. In this embodiment, the system 3100 includes a first processing unit 3104 (including an electrical treatment apparatus 3132 that is configured to recirculate liquid to and from the tank 3130) and a second processing unit 3106. 3106 in this embodiment is a sterilization system such as an AOP system that combines ozone and ultraviolet light. This embodiment also includes a reject/waste tank 3140 that is configured to receive waste removed from tanks 3130 via paths 3112, 3118, and 3124 and passes it via path 3142 to a dewatering stage 3146, whereupon water removed from the waste will cycle back through the system via path 3144 and the soil or other solids may be either disposed of or reused via path 3148. This system is suited for use in treating effluent from a vegetable processing plant where the effluent may have elevated levels of suspended solids and/or organic material such as bacteria or other pathogens.

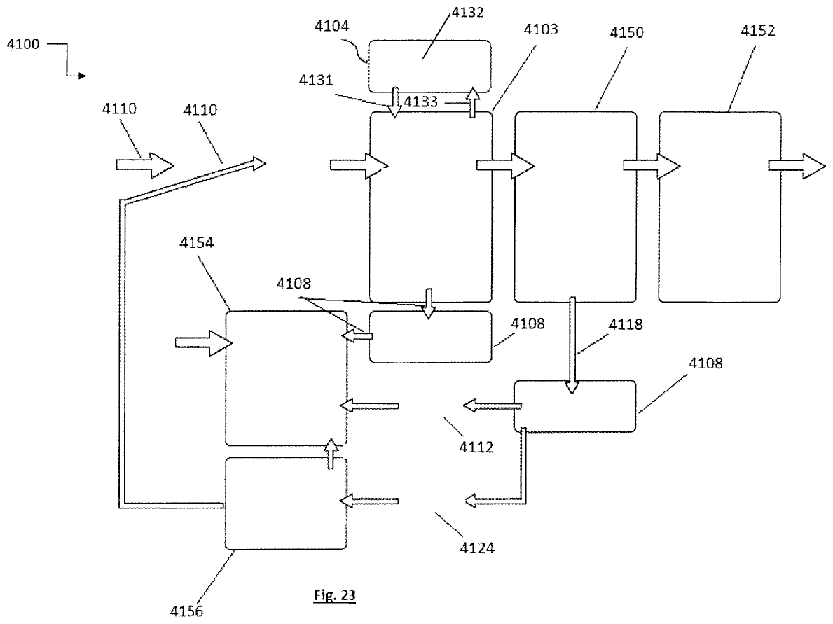

FIG. 23 depicts yet another example of a treatment system 4100. This system is generally similar to water treatment system 100 as illustrated, with like features being annotated with like numbers. In this embodiment, the system 4100 includes a first processing unit 4104 (including an electrical treatment apparatus 4132 that is configured to recirculate liquid to and from the tank 4103) and a second processing unit 4106 (in the form of reverse osmosis unit 4156 instead of the biological reactors described in other embodiments).

In this alternate embodiment, the system 4100 includes a process tank 4150 that can be used to help disinfect the liquid being treated (for example by using UV light and/or reverse osmosis devices) while a tank 4152 holds clean, non-potable water for reuse, allowing for CIP washing and overflow to a ditch. Circulation path 4112 or 4124 may take waste removed from tank 4150 to tank 4154 for compost or agricultural reuse or a reverse osmosis unit 4156 for reduction of volume in reprocessing. This embodiment is best suited for use in treating effluent from a brewery, winery, or distillery where the user wishes to recycle their effluent in their operation. This allows the user to reduce their water consumption.

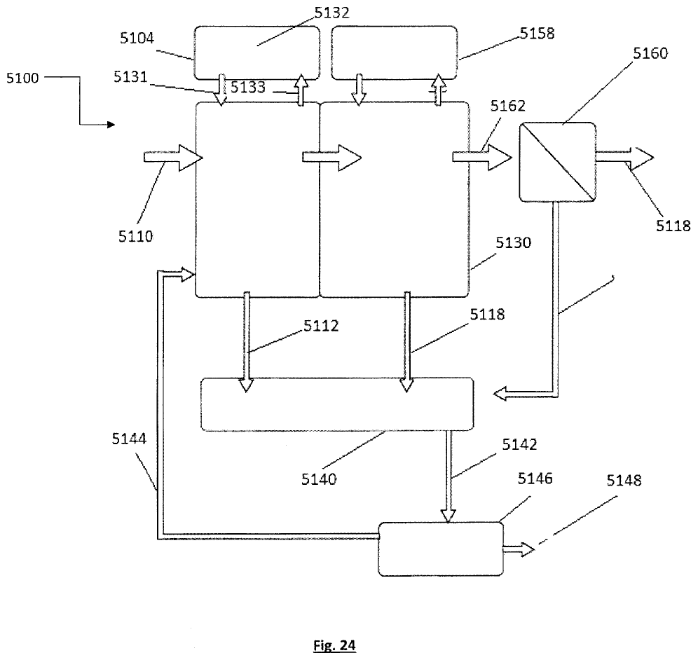

FIG. 24 depicts a treatment system 6100 similar to that of FIG. 22. A flowpath 6162 takes the liquid from the tanks 6130 to a filter 6160, which can be configured to act as a mechanical separator before the effluent leaves the system at 6118. Waste may be passed to the reject/waste tank 6140 via flow path 6164 from the filter 6160. This embodiment is best suited to situations where little to no suspended solids are permitted to leave with the effluent, such as a vegetable washing operation that uses the effluent as irrigation water.

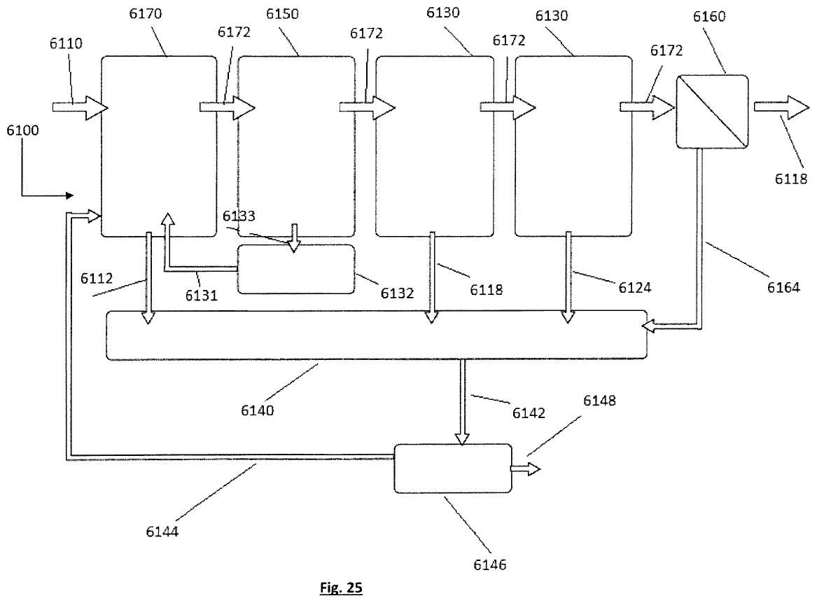

FIG. 25 depicts a treatment system 7100 substantially similar to FIGS. 22, 24, and 25. In this embodiment, the system 7100 includes a feed tank 7170 and multiple sedimentation tanks 7130. In this arrangement, the ERU 7132 receives water from the tank 7150, through a flow path 7133, and returns the water back into feed tank 7170 via path 7131. In this example, the reactor circulation flow path can include the ERU 7132 and both tanks 7150 and 7170.

This embodiment includes an optional membrane filter 7160 downstream from the two, sequentially arranged sedimentation tanks 7130. This may help facilitate removal of particulates that are unable to settle in tanks 7130. This embodiment is suitable for treating surface water from a pond, lake, stream, canal, or the like that may be contaminated with agricultural runoff such as soil and fertilizer.

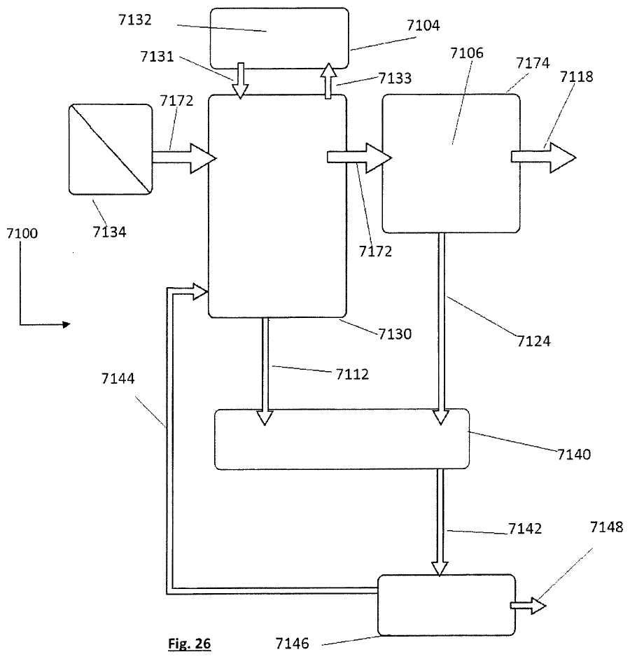

FIG. 26 depicts yet another embodiment of a liquid treatment system 8100 that is generally analogous to the system 100 described herein, with like features being annotated with like numbers indexed by 8000. In this example the system 8100 includes a first processing unit 8104 that includes a tank 8130 and associated ERU 8132 that are linked with a suitable reactor circulation flow path. A second processing unit 8106 is provided downstream from the first processing unit 8104, and may be of any configuration described herein. An optional mechanical separator 8134 is provided upstream from the tank 8130 to pre-screen solid debris from the influent passing through on its way along the flow path 8172 and into the tanks 8130. In this example, the system 8100 is configured to help remove solids and dirt from the incoming water and to output water that may be suitable for re-use.

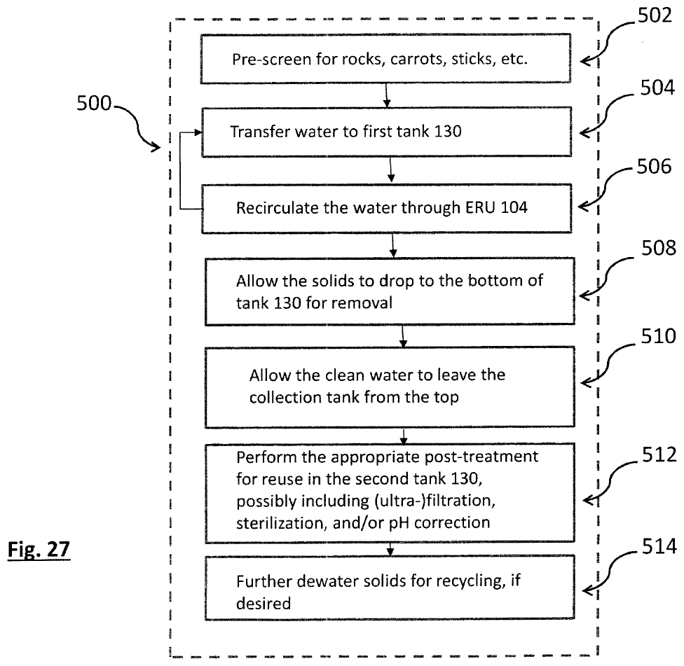

Optionally, this system 8100 can be operated in accordance with the exemplary method illustrated in FIG. 27. For example, the method 500 can include a first step 502 in which the incoming fluid flow is pre-screened to remove relatively large solid debris, such as rocks, sticks, dirt, carrots or other produce in an agricultural facility and the like. At step 504, the screened water can then be introduced into the tank 8130, and circulated through the associated ERU 8132 as many times as desired in the electrical treatment sub-cycle process at step 506.

When the electrical treatment sub-cycle is completed, the method can move to step 508 in which solids and other reaction products can be allowed to settle within the tank 8130 and can be extracted from the tank 8130 and sent to a reject/waste tank 8140.

At step 510, relatively cleaner water can be drawn from the upper portion of the tank 8130 and sent to the second processing unit 8106, 8174 for further processing in step 512 (which can be any suitable unit, including a BRU, a reverse osmosis apparatus and the like). This secondary processing can optionally include, filtration, ultra-filtration, sterilization, pH correction and any combination thereof and/or may include other suitable treatments.

Optionally, the water stream 8118 exiting the second processing unit 8106 can be of a condition such that it is suitable for reuse in a variety of ways, including, for example irrigating crops. Optionally, at least some of the solids that were separated by the first and/or second processing units 8104 and 8106 can be removed from the waste tank 8140, via path 8142 at optional step 514, and sent to a dewatering stage 8146, whereupon water removed from the waste may cycle back through the system via path 8144 and the soil or other solids may be either disposed of or reused.

A system configured in accordance with the system 8100 was operated in an experimental setting by processing wastewater from carrot washing at a farm in Ontario and used to process an incoming stream containing a mixture of suspended solids, E. coli bacterial contamination and having an incoming pH. Measurements on the stream before and after having been processed by the system 8100 are summarized in Table 3. Analysis was performed by ALS Environmental Lab in Ontario using the methods indicated.

TABLE 3
Results of use of system 8100 to treat exemplary incoming waste
water stream.

| Parameter | Before Treatment | After Treatment | Test Method |
|---|---|---|---|
| Total Suspended | 610 ppm | Below detection | APHA 2540 |
| Solids (TSS) | | limit | |
| e. Coli | 170,000 | Below detection | SM 9222D |
| | CFU/100 mL | limit | |
| pH | 7.57 | 9.47 | APHA 4500 H |

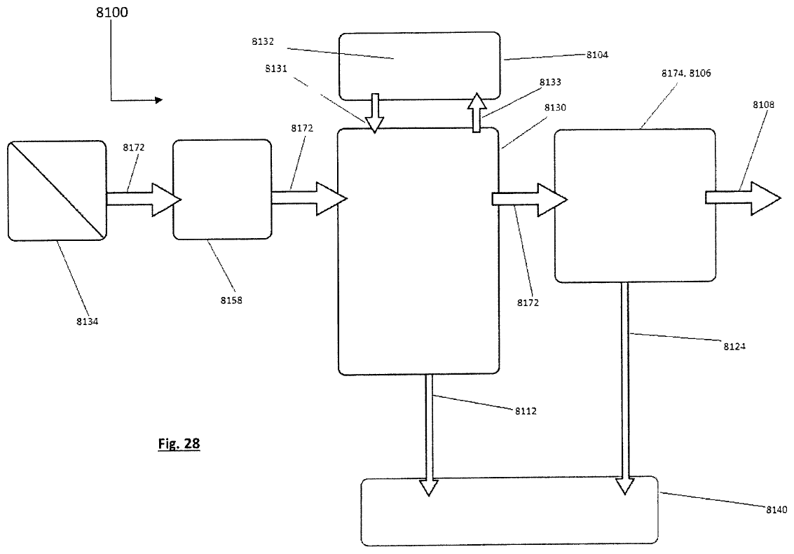

FIG. 28 depicts a treatment system 9100 that is configured similar to the previously described embodiments, and in which like features are identified using like reference characters beginning with 9000. In this example the system 9100 includes a first processing unit 9104 that includes a tank 9130 and associated ERU 9132 that are linked with a suitable reactor circulation flow path. A second processing unit 9106 is provided downstream from the first processing unit 9104, and may be of any configuration described herein. An optional mechanical separator 9134 is provided upstream from the tank 9130 to pre-screen solid debris from the influent passing through on its way along the flow path 9172 and into the tanks 9130.

Optionally, as shown in this example, the system can include an AOP apparatus 9158 (configured to perform suitable advanced oxidation processes, such as ozone injection combined with ultraviolet light]) that is provided in the fluid flow path 9172 between the mechanical separator 9134 and the first tank 9130. Utilizing such components in combination with the first processing unit 9104 and the second processing unit 9106, can enable the system 9100 to remove arsenic from surface water/drinking water sources.

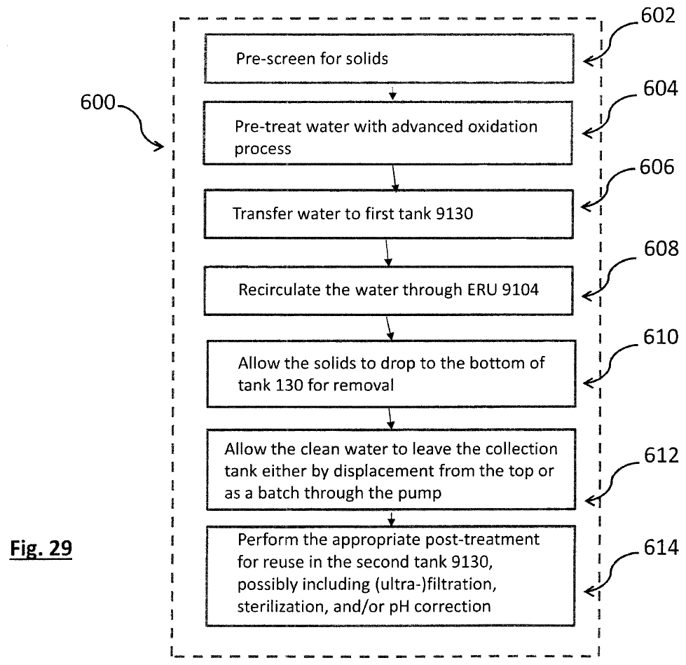

The system 9100 can be operated in accordance with the exemplary method illustrated in FIG. 29. For example, the method 600 can include a first step 602 in which the incoming fluid flow is pre-screen to remove relatively large solid debris, such as rocks, sticks, dirt, and other debris. At step 604, the screened water can then be introduced into the AOP apparatus 9158 and subjected to advanced oxidation processes. Having been processed in the AOP apparatus 9158, the water can, at step 606, flow into the tank 9130, and can be circulated through the associated ERU 9132 as many times as desired in the electrical treatment sub-cycle process, at step 608.

When the electrical treatment sub-cycle is completed, the method can move to step 610 in which solids and other reaction products can be allowed to settle within the tank 9130 and can be extracted from the tank 9130 and sent to a reject/waste tank 9140.

At step 612, relatively cleaner water can be drawn from the upper portion of the tank 9130 and sent to the second processing unit 9106, 9174 for further processing in step 614 (which can be any suitable unit, including a BRU, a reverse osmosis apparatus and the like). This secondary processing can optionally include, filtration, ultra-filtration, sterilization, pH correction and any combination thereof and/or may include other suitable treatments.

To validate the use of the system 9100 for the removal of arsenic from surface water, a pilot study was conducted on a surface water source at the Hamilton Conservation Authority (in Ancaster, Ontario) in which the arsenic level in a publicly accessible artesian well was exceeding permissible limits for drinking water. The process described in FIG. 29 was followed, with the duration of step 608 being 5 minutes at a flow rate of approximately 5 gallons per minute. The post-treatment described in step 614 was filtration to remove any residual suspended solids from the drinking water. Treated and untreated samples were sent to Maxxam Lab in Ontario for analysis, with the results of the pilot experiment summarized below in Table 4.

TABLE 4
Results of use of system 9100 to treat exemplary incoming
waste water stream.

| Parameter | Before Treatment | After Treatment | Test Method |
|---|---|---|---|
| Arsenic | 17.0 ppb | Below detection | CAM SOP- |
| | | limit (<1.0 ppb) | 00447 |

Optionally, a given system configuration may be suitable for more than one use/process. For example, the system 8100 of FIG. 26 can be used for the removal of dirt and debris as previously described, but may alternatively may be used in a process to help remove phosphorous from surface water sources (such as lakes, rivers, streams, canals, ponds and the like.

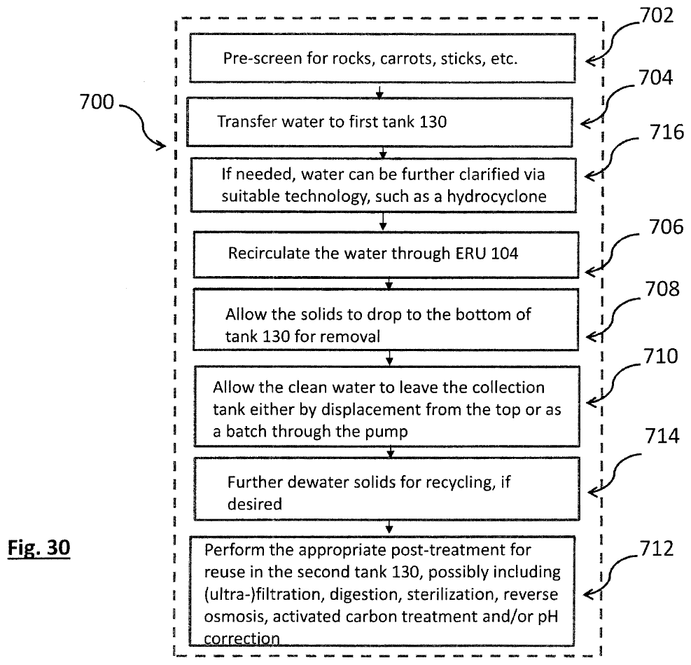

To that end, the system 8100 can be operated in accordance with another exemplary method 700 illustrated in FIG. 30. For example, the method 700 can include a first step 702 in which the incoming fluid flow is pre-screen to remove relatively large solid debris, such as rocks, sticks, dirt, wildlife and other physical debris from the ground water source. At step 704, the screened water can then be introduced into the tank 8130, and circulated through the associated ERU 8132 as many times as desired in the electrical treatment sub-cycle process at step 506.

When the electrical treatment sub-cycle is completed, the method can move to step 708 in which solids and other reaction products can be allowed to settle within the tank 8130 and can be extracted from the tank 8130 and sent to a reject/waste tank 8140.

At step 710, relatively cleaner water can be drawn from the upper portion of the tank 8130 and sent to the second processing unit 8106, 8174 for further processing in step 712 (which can be any suitable unit, including a BRU, a reverse osmosis apparatus and the like). This secondary processing can optionally include, filtration, ultra-filtration, sterilization, pH correction and any combination thereof and/or may include other suitable treatments.

Optionally, the water stream 8118 exiting the second processing unit 8106 can be of a condition such that it is suitable for reuse in a variety of ways, including, for example irrigating crops. Optionally, at least some of the solids that were separated by the first and/or second processing units 8104 and 8106 can be removed from the waste tank 8140, via path 8142 at optional step 714, and sent to a dewatering stage 8146, whereupon water removed from the waste may cycle back through the system via path 8144 and the soil or other solids may be either disposed of or reused.

To evaluate the performance of the system 8100 in removing phosphorous, a pilot experiment was conducted using a system configured as shown in FIG. 26 to evaluate the removal of phosphorous from a surface water source. The results of this testing as analyzed by Maxxam Lab in Ontario are summarized in Table 5.

TABLE 5
Results of use of system 8100 to treat exemplary incoming
waste water stream.

| | Before | After | |
|---|---|---|---|
| Parameter | Treatment | Treatment | Test Method |
| TSS | 423 ppm | 12.3 ppm | EPA 160 |
| pH | 7.63 | 8.21 | CAM SOP-00413 |
| TKN | 34.8 ppm | 2.75 ppm | EPA 351 |
| TP | 6.36 ppm | 0.164 ppm | EPA 365 |
| Orthophosphate- | 3.41 ppm | 0.0041 ppm | EPA 300 |
| Dissolved (as P) | | | |
| BOD Carbonaceous | 135 ppm | <3 ppm | EPA 405 |

The system 8100 can also be used to process effluent from a brewery in accordance with the methods generally described herein, including in FIG. 18. Table 6 summaries the results of another example of the use of the system in association with the effluent stream of a brewery (tested onsite at a brewery in Ontario). In this example, the electrical treatment sub-cycle was performed for about 30 minutes and the water flow rate was 20 gpm and the temperature was 15 C. Measurements were taken upstream and downstream from the system 8100 and analyzed by Maxxam Lab in Ontario with the results summarized below.

TABLE 6
Results of use of system 8100 to treat an exemplary brewery
effluent stream.

| | Before | After | |
|---|---|---|---|
| Parameter | Treatment | Treatment | Test Method |
| TSS | 5400 ppm | 35 ppm | CAM SOP-00428 |
| pH | 5.4 | 7.0 | CAM SOP-00413 |
| TKN | 190 ppm | 23 ppm | CAM SOP-00938 |
| TP | 93 ppm | 2.6 ppm | CAM SOP-00407 |
| BOD (discharge/ irrigation) | 6900 ppm | 99.0 ppm | CAM SOP-00427 |
| BOD (Reuse) | 6900 ppm | <10 ppm | CAM SOP-00427 |

The system 8100 can also be used to process effluent from a winery in accordance with the methods generally described herein, including in FIG. 18. Table 7 summaries the results of another example of the use of the system in association with the effluent stream of a brewery (tested onsite at a winery in Ontario). In this example, the electrical treatment sub-cycle was performed for about 40 minutes and the water flow rate was 10 gpm and the temperature was 12 C. Measurements were taken upstream and downstream from the system 8100 and analyzed by Maxxam Lab in Ontario with the results summarized below.

TABLE 7
Results of use of system 8100 to treat an exemplary winery effluent stream.

| | Before | After | |
|---|---|---|---|
| Parameter | Treatment | Treatment | Test Method |
| TSS | 600 ppm | 60 ppm | CAM SOP-00428 |
| pH | 6.35 | 8.22 | CAM SOP-00413 |
| TKN | 10 ppm | 2 ppm | CAM SOP-00938 |
| TP | 12 ppm | 2.5 ppm | CAM SOP-00407 |
| BOD (discharge/ irrigation) | 5500 ppm | 160 ppm | CAM SOP-00427 |
| BOD (Reuse) | 5500 ppm | <10 ppm | CAM SOP-00427 |

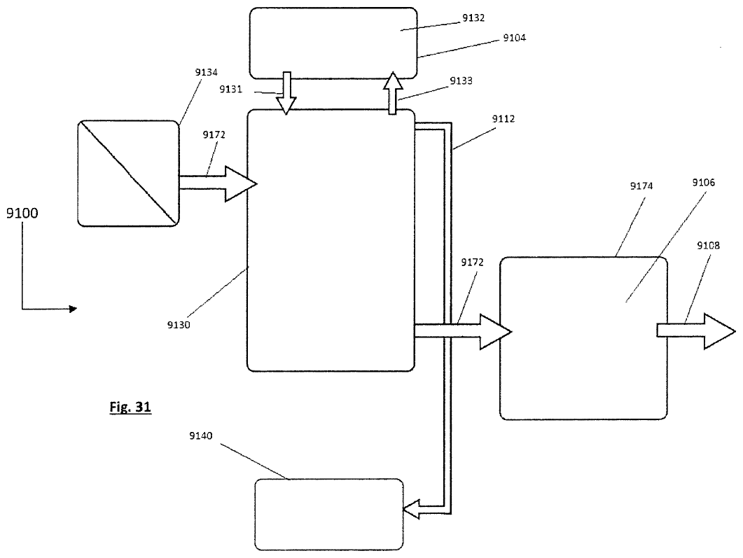

Referring to FIG. 31, another example of a system 10100 that is that is generally analogous to the system 100 described herein, with like features being annotated with like numbers indexed by 10,000. In this example the system 10100 includes a first processing unit 10104 that includes a tank 10130 and associated ERU 10132 that are linked with a suitable reactor circulation flow path. A second processing unit 10106 is provided downstream from the first processing unit 10104, and may be of any configuration described herein. An optional mechanical separator 10134 is provided upstream from the tank 10130 to pre-screen solid debris from the influent passing through on its way along the flow path 10172 and into the tanks 10130. In this example, the system 10100 is configured to help remove fats, oils, grease and the like from a wastewater or effluent stream. Solids in this example may tend to be coagulated fat and/or grease particles. The output water downstream from the second processing unit 10106 may be suitable for re-use in some configurations. This embodiment is suitable for treating effluent from a dairy or bakery.

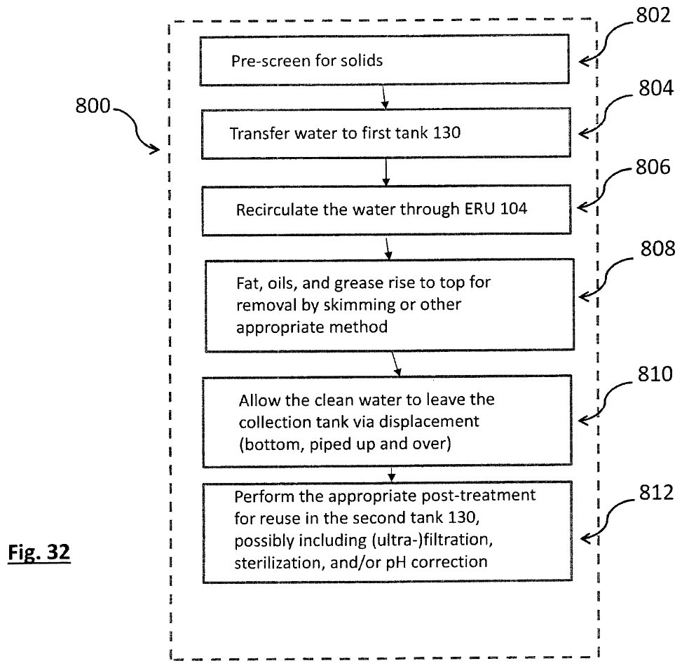

Optionally, this system 10100 can be operated in accordance with the exemplary method illustrated in FIG. 32. For example, the method 800 can include a first step 802 in which the incoming fluid flow is pre-screen to remove relatively large solid debris. At step 804, the screened water can then be introduced into the tank 10130, and circulated through the associated ERU 10132 as many times as desired in the electrical treatment sub-cycle process at step 806. In this embodiment, the water is circulated through the ERU 10132 for about 5 minutes.

When the electrical treatment sub-cycle is completed, the method can move to step 808 in which the fats, oils, grease and other particles, having been treated by the ERU 10132, can be allowed to float to the top of the tank 10130 and can be skimmed off or otherwise removed and sent to a reject/waste tank 10140.

At step 810, relatively cleaner water can be drawn from the upper portion of the tank 10130 and sent to the second processing unit 10106 for further processing in step 812 (which can be any suitable unit, including a BRU, a reverse osmosis apparatus and the like). This secondary processing can optionally include, filtration, ultra-filtration, sterilization, pH correction and any combination thereof and/or may include other suitable treatments.

A pilot test was conducted using emulsified olive oil in a prepared test water stream. The concentration of the oil was measured using turbidity as an analog for oil content. The test was conducted at approximately 15 C at a flow rate of 5 gpm for 5 minutes. The results of the pilot test are shown in Table 8.

TABLE 8
Results of use of system 10100 to treat an exemplary oil
emulsification effluent stream.

| Parameter | Before Treatment | After Treatment |
|---|---|---|
| Fats, Oils, Grease | 10,000 ppm | <100.0 ppm |

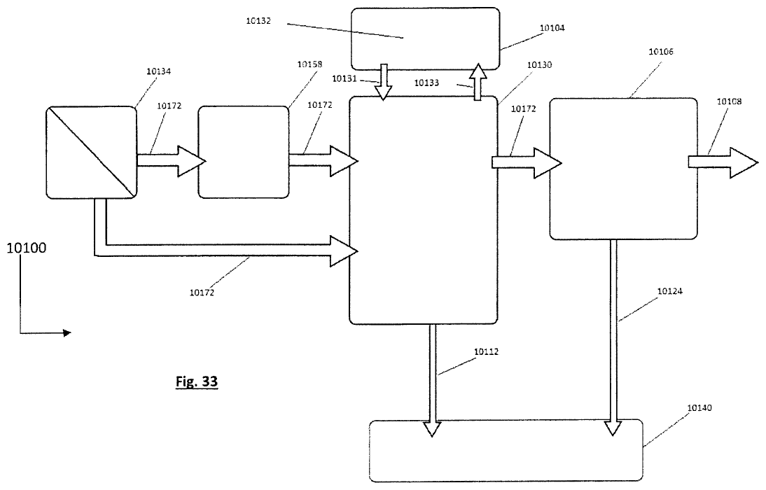

Referring to FIG. 33, a treatment system 11100 that is configured to similar to the previously described embodiments, and in which like features are identified using like reference characters beginning with 11,000. In this example the system 11100 includes a first processing unit 11104 that includes a tank 11130 and associated ERU 11132 that are linked with a suitable reactor circulation flow path. A second processing unit 11106 is provided downstream from the first processing unit 11104, and may be of any configuration described herein. An optional mechanical separator 11134 is provided upstream from the tank 11130 to pre-screen solid debris from the influent passing through on its way along the flow path 11172 and into the tanks 11130.

Optionally, as shown in this example, the system can include an AOP apparatus 11158 (configured to perform suitable advanced oxidation processes, such as ozone combined with ultraviolet light) that is provided in the fluid flow path 11172 between the mechanical separator 11134 and the first tank 11130. Utilizing such components in combination with the first processing unit 11104 and the second processing unit 11106, can enable the system 11100 to remove heavy metals from a waste water stream.

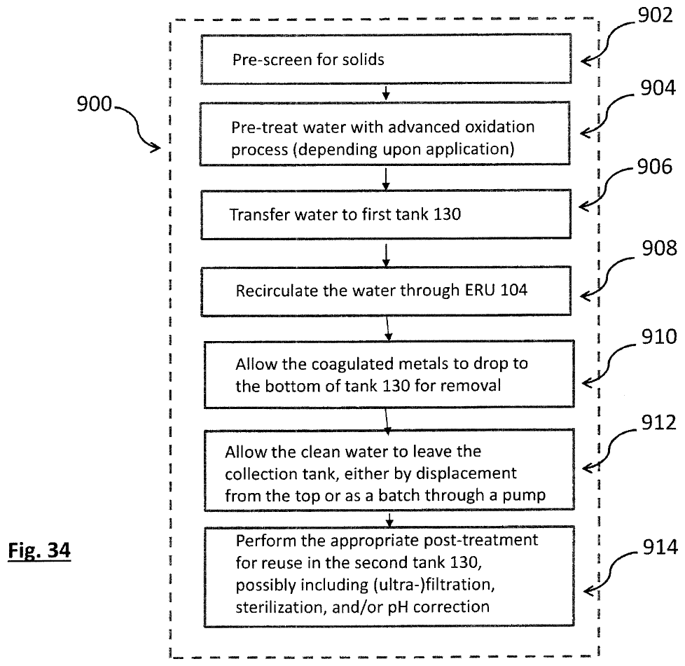

The system 11100 can be operated in accordance with the exemplary method 900 illustrated in FIG. 34. For example, the method 900 to remove heavy metals from a wastewater stream can include a first step 902 in which the incoming fluid flow is pre-screen to remove relatively large solid debris. At step 904, the screened water can then be introduced into the AOP apparatus 11158 and subjected to advanced oxidation processes. Having been processed in the AOP apparatus 11158, the water can, at step 906, flow into the tank 11130, and can be circulated through the associated ERU 11132 as many times as desired in the electrical treatment sub-cycle process to produce an electrocoagulation reaction of the dissolved metals at step 908.

When the electrical treatment sub-cycle is completed, the method can move to step 910 in which solids and other reaction products can be allowed to settle within the tank 11130 and can be extracted from the tank 11130 and sent to a reject/waste tank 11140.

At step 912, relatively cleaner water can be drawn from the upper portion of the tank 11130 and sent to the second processing unit 11106 for further processing in step 914 (which can be any suitable unit, including a BRU, a reverse osmosis apparatus and the like). This secondary processing can optionally include, filtration, ultra-filtration, sterilization, pH correction and any combination thereof and/or may include other suitable treatments.

Although some specific advantages have been enumerated above, various embodiments may include some, none, or all of the enumerated advantages. Other technical advantages may become readily apparent to one of ordinary skill in the art after review of the following figures and description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A system for treating an effluent stream from a food production facility, the system comprising:
a) a first reactor unit including a first reactor tank having a tank inlet for receiving an incoming stream of effluent containing at least base organic molecules, and an interior for holding a volume of effluent, and an electrical treatment reactor that is fluidly connected to the first reactor tank, whereby when the reactor assembly is in use the effluent travels along a reactor circulation flow path in which effluent is drawn from the first tank, flows through the electrical treatment reactor and is subjected to an electrical charge to breakdown the base organic molecules into intermediate organic molecules and then returns to the first tank, whereby a reaction initiated in the effluent by the electrical charge within the electrical treatment reactor continues when the effluent is returned to the first tank, wherein a partially treated effluent stream containing the intermediate organic molecules exits the first reactor unit; and
b) a second processing unit downstream from the first reactor unit to receive the partially treated effluent stream and configured to further process the partially treated effluent to eliminate at least a portion of the intermediate organic molecules thereby producing a treated output stream.

2. The system of claim 1, wherein the effluent travels through the reactor circulation flow path at least twice before exiting the first reactor unit.

3. The system of claim 1 or 2, wherein the effluent is circulated through the reactor circulation flow path for at least 15 minutes before exiting the first reactor unit.

4. The system of any one of claims 1 to 3, wherein the reactor circulation flow path is free from physical filter media.

5. The system of claim 1, wherein the second processing unit comprises a biological treatment unit configured to process the partially treated effluent stream via at least one of aerobic and anaerobic digestion to produce the treated output stream.

6. The system of claim 2, wherein the biological treatment unit comprises:
i. at least a second holding tank for receiving the partially treated stream; and
ii. at least a first biological reactor in fluid communication with the second holding tank via a bio flow path whereby the partially treated stream can circulate between the second holding tank and the first biological reactor.

7. The system of any one of claims 1 to 6, wherein the second processing unit comprises a reverse osmosis apparatus.

8. The system of any one of claims 1 to 7, further comprising at least a first mechanical separator configured to separate solid particles from the incoming stream of effluent flowing through the mechanical separator before the effluent flows into the electrical treatment unit.

9. The system of claim 8, wherein the first mechanical separator is fluidly connected to the first reactor tank via a mechanical flow path whereby the effluent can circulate between the first holding tank and the first mechanical separator along the mechanical flow path.

10. The system of claim 9, wherein effluent circulates through the mechanical flow path, and the first mechanical separator therein, at least twice before flowing into the electrical treatment unit.

11. The system of any one of claims 8 to 10, wherein the first mechanical separator comprises a hydrocyclone apparatus.

12. The system of any one of claims 9 to 11, whereby effluent circulating through the mechanical flow path travels between the first reactor tank and the first mechanical separator without passing through the electrical treatment reactor, and effluent circulating through the reactor circulation flow path travels between the first reactor tank and the electrical treatment reactor without passing through the first mechanical separator.

13. The system of claim 12, further comprising a changeover apparatus operable to selectably direct the effluent through the mechanical flow path or the reactor circulation flow path.

14. The system of any one of claims 1 to 13, further including a balancing tank located upstream from the first reactor unit and having a balancing inlet configured to receive the effluent from the food production facility and a balancing outlet fluidly connected to the first reactor tank to transfer the effluent from the balancing tank to the first reactor tank.

15. The system of any one of claims 1 to 14, wherein the first reactor unit further comprises a sludge removal apparatus fluidly connected to a lower end of the first reactor tank to extract sludge from the lower end of the first reactor tank.

16. The system of any one of claims 1 to 15, further comprising a second electrical treatment reactor provided in the reactor circulation flow path and operable to apply an electric charge to the effluent flowing through the second electrical treatment reactor.

17. The system of any one of claim 16, wherein the second electrical treatment reactor is fluidly connected in parallel with the first electrical treatment reactor.

18. The system of any one of claims 1 to 17, wherein the electrical treatment reactor comprises:
a) a housing having a lower end, an upper end spaced apart from the lower end along a reactor axis, and a sidewall extending therebetween;
b) a reactor inlet provided toward the lower end and through which effluent can enter the housing, the reactor inlet being in fluid communication with the first tank interior to receive effluent from the first tank;
c) a reactor outlet provided toward the upper end through which effluent can exit the housing, whereby the effluent flows generally axially through the housing from the lower end to the upper end, the reactor outlet being in fluid communication with the tank to return effluent to the first tank; and
d) a galvanic cell positionable at least partially axially between the reactor inlet and the reactor outlet within the housing to subject the liquid within the housing to the electrical charge, the galvanic cell comprising an elongate, axially extending cathode assembly and an anode assembly including at least one elongate, axially extending anode rod that is positioned generally parallel to and laterally spaced apart from the cathode assembly, wherein the anode assembly is at least partially consumed when the reactor is in use

19. The system of any one of claims 1 to 18, wherein the incoming effluent stream comprises at least one of organic molecules and inorganic molecules and polymers and wherein the first reactor unit is configured to convert these molecules via at least one of: electro-oxidation, electro-reduction, electro-flotation, electrocoagulation, electro-crystalization, or electrolysis.

20. The system of any one of claims 1 to 19, wherein the system is configured to process at least 10 m³/d of effluent and covers an area of less than 9 m².

21. The system of any of claims 18 to 20, wherein the liquid circulates through the reactor circulation flow path at least twice during an electrical treatment sub-cycle.

22. The system of any of claims 18 to 21, wherein the electrical treatment sub-cycle has a duration of about 15 minutes.

23. The system of any of claims 18 to 22, wherein the reaction initiated by exposure to the electrical charge within the water treatment reactor continues to completion while the liquid is in the tank.

24. The system of any of claims 18 to 23, wherein the reaction initiated by exposure to the electrical charge within the water treatment reactor comprises an electrocoagulation reaction configured to induce coagulation of particles within the liquid and wherein coagulated particles settle within the tank.

25. The system of any of claims 18 to 24, further comprising a first mechanical separator configured to separate solid particles from the liquid flowing through the mechanical separator, the first mechanical separator being fluidly connected to the tank wherein when the reactor assembly is in use liquid selectably travels through a mechanical separation flow path in which liquid is drawn from the tank, flows through the first mechanical separator and then returns to the tank.

26. The system of claim 25, wherein the first mechanical separator comprises at least one hydrocyclone configured to separate solid particles from the liquid.

27. The system of claim 25, wherein the liquid circulates through the mechanical separation flow path at least twice during a mechanical separation sub-cycle.

28. The system of any one of claims 18 to 27, wherein the electrical charge is applied to the liquid while it is flowing through the housing.

29. The system of any one of claims 18 to 28, wherein the tank further comprises a sludge removal apparatus fluidly connected to a lower end of the tank to selectably extract sludge from the lower end of the tank.

30. The system of any one of claims 18 to 29, wherein the reactor circulation flow path is free from physical filter media.

31. The system of any one of claims 18 to 30, wherein the reactor assembly covers an area of less than about 1 square meters and is operable to treat at least 10 m³/d of liquid from the source.

32. The system of any of claims 18 to 31, wherein the liquid is subjected to the electrical charge while flowing from the liquid inlet to the liquid outlet.

33. The system of any of claims 18 to 32, wherein liquid entering the reactor inlet travels in the axial direction and liquid exiting via the reactor outlet travels in a generally radial direction that is orthogonal to the reactor axis.

34. The system of any of claims 18 to 33, wherein the reactor outlet is provided in the sidewall.

35. The system of any of claims 18 to 34, wherein when the treatment reactor is in use the reactor axis is inclined relative to a vertical direction by a reactor angle that is between about 20 degrees and about 70 degrees, and may be between about 30 and 60 degrees and may be 45 degrees.

36. The system of any of claims 18 to 35, wherein when the treatment reactor is in use the reactor outlet is provided on a generally upwardly facing portion of the reactor.

37. The system of any of claims 18 to 36, wherein the reactor axis intersects the reactor inlet and is spaced apart from the reactor outlet.

38. The system of any of claims 18 to 37, further comprising a lid removably mounted to the upper end of the housing, and wherein the galvanic cell has a proximate end mounted to an inner surface of the lid and an axially opposing distal end, whereby when the lid is mounted to the upper end the galvanic cell is suspended within the housing and the distal end is spaced apart from the lower end of the housing, and when the lid is removed from the housing the galvanic cell is removed from the housing.

39. The system of any of claims 18 to 38, wherein the galvanic cell is removable from the housing while preserving fluid communication between the reactor inlet and reactor outlet.

40. The system of any of claims 18 to 39, wherein the cathode assembly further comprises an axially extending central cathode rod positioned within the cathode sleeve, wherein the anode rods are disposed laterally between the central cathode rod and the cathode sleeve.

41. The system of claim 40, wherein anode rods have an anode length in the axial direction, and wherein the central cathode rod has a cathode length that is greater than the anode length.

42. The system of any one of claim 40 or 41, wherein the galvanic cell comprises a flow directing surface which, when the galvanic cell is mounted to the housing, faces the reactor inlet to and is configured to direct the flow of liquid entering the reactor inlet into cathode sleeve.

43. The system of claim 42, wherein the flow directing surface comprises a generally convex, dome-shaped tip of the central cathode rod.

44. The system of claim 42 or 43, wherein the flow directing surface is axially spaced between the anode rods and a lower end of the cathode sleeve.

45. The system of any of claims 18 to 44, wherein the galvanic cell is configured so that liquid flowing through the housing travels substantially axially from the reactor inlet to the reactor outlet.

46. The system of any one of claims 18 to 45, wherein the at least one elongate, axially extending anode rod is solid.

47. The system of any of claims 18 to 46, wherein the sidewall comprises an upper portion having a generally constant cross-sectional area and a tapered portion disposed toward the lower end and generally expanding from the reactor inlet toward the upper portion.

48. The system of claim 47, wherein liquid entering the reactor inlet travels in the axial direction and liquid exiting via the reactor outlet travels in a generally radial direction that is orthogonal to the reactor axis.

49. The system of any one of claim 47 or 48, further comprising a lid removably mounted to the upper end of the housing, and wherein the galvanic cell has a proximate end mounted to an inner surface of the lid and an axially opposing distal end, whereby when the lid is mounted to the upper end the galvanic cell is suspended within the housing and the distal end is spaced apart from the lower end of the housing, and when the lid is removed from the housing the galvanic cell is removed from the housing.

50. The system of any one of claims 47 to 49, wherein the galvanic cell is removable from the housing while maintaining fluid connections at the reactor inlet and reactor outlet.

51. The system of any one of claims 18 to 50, wherein the flow directing surface is removable from the housing with the lid and galvanic cell.

52. The system of any one of claims 18 to 51, wherein the lid and galvanic cell are removable by translating in the axial direction.

53. The system of any one of claims 18 to 52, further comprising a second galvanic cell connected to an inner surface of a second lid that is configured to replace the lid and galvanic cell and is mountable to seal the upper end of the housing.

54. The system of any one of claims 18 to 53, wherein the housing is configured to retain a quantity of liquid while the lid and galvanic cell are removed from the housing.

55. A reactor assembly for use in a system for treating a liquid from a source, the reactor assembly, comprising:
a) a tank having a tank inlet for receiving an incoming stream of liquid and a tank interior for holding a volume of the liquid;
b) an electrical water treatment reactor having:
i. a housing having a lower end, an upper end spaced apart from the lower end along a reactor axis, and a sidewall extending therebetween;
ii. a reactor inlet provided toward the lower end and through which liquid can enter the housing, the reactor inlet being in fluid communication with the tank interior to receive liquid from the tank;
iii. a reactor outlet provided toward the upper end through which liquid can exit the housing, whereby the liquid flows generally axially through the housing from the lower end to the upper end, the reactor outlet being in fluid communication with the tank to return liquid to the tank; and
iv. a galvanic cell positionable at least partially axially between the reactor inlet and the reactor outlet within the housing to subject the liquid within the housing to an electrical charge, the galvanic cell comprising an elongate, axially extending cathode assembly and an anode assembly including at least one elongate, axially extending anode rod that is positioned generally parallel to and laterally spaced apart from the cathode assembly, wherein the anode assembly is at least partially consumed when the reactor is in use;
wherein when the reactor assembly is in use liquid travels through a reactor circulation flow path in which liquid is drawn from the tank, flows through the water treatment reactor and then returns to the tank, whereby an electrocoagulation reaction initiated in the liquid by exposure to the electrical charge within the water treatment reactor continues while the liquid is in the tank.

56. The reactor assembly of claim 55, wherein the liquid circulates through the reactor circulation flow path at least twice during an electrical treatment sub-cycle.

57. The reactor assembly of claim 56, wherein the electrical treatment sub-cycle has a duration of about 15 minutes.

58. The reactor assembly of any one of claim 55 or 57, wherein the reaction initiated by exposure to the electrical charge within the water treatment reactor continues to completion while the liquid is in the tank.

59. The reactor assembly of any one of claims 55 to 58, wherein the reaction initiated by exposure to the electrical charge within the water treatment reactor comprises an electrocoagulation reaction configured to induce coagulation of particles within the liquid and wherein coagulated particles settle within the tank.

60. The reactor assembly of any one of claims 55 to 59, further comprising a first mechanical separator configured to separate solid particles from the liquid flowing through the mechanical separator, the first mechanical separator being fluidly connected to the tank wherein when the reactor assembly is in use liquid selectably travels through a mechanical separation flow path in which liquid is drawn from the tank, flows through the first mechanical separator and then returns to the tank.

61. The reactor assembly of claim 60, wherein the first mechanical separator comprises at least one hydrocyclone configured to separate solid particles from the liquid.

62. The reactor assembly of claim 60, wherein the liquid circulates through the mechanical separation flow path at least twice during a mechanical separation sub-cycle.

63. The reactor assembly of any one of claims 55 to 61, wherein the electrical charge is applied to the liquid while it is flowing through the housing.

64. The reactor assembly of any one of claims 55 to 63, wherein the tank further comprises a sludge removal apparatus fluidly connected to a lower end of the tank to selectably extract sludge from the lower end of the tank.

65. The reactor assembly of any one of claims 55 to 64, wherein the reactor circulation flow path is free from physical filter media.

66. The reactor assembly of any one of claims 55 to 65, wherein the reactor assembly covers an area of less than about 1 square meters and is operable to treat at least 10 m³/d of liquid from the source.

67. The reactor assembly of any of claims 55 to 66 wherein the effluent travels through the reactor circulation flow path at least twice before exiting the first reactor unit.

68. The reactor assembly of any of claims 55 to 67, wherein the effluent is circulated through the reactor circulation flow path for at least 15 minutes before exiting the first reactor unit.

69. The reactor assembly of any of claims 55 to 68, wherein the reactor circulation flow path is free from physical filter media.

70. The reactor assembly of any of claims 55 to 69, further comprising at least a first mechanical separator configured to separate solid particles from the incoming stream of effluent flowing through the mechanical separator before the effluent flows into the electrical treatment unit.

71. The reactor assembly of claim 70, wherein the first mechanical separator is fluidly connected to the first reactor tank via a mechanical flow path whereby the effluent can circulate between the first holding tank and the first mechanical separator along the mechanical flow path.

72. The reactor assembly of claim 71, wherein effluent circulates through the mechanical flow path, and the first mechanical separator therein, at least twice before flowing into the electrical treatment unit.

73. The reactor assembly of any of claims 70 to 72, wherein the first mechanical separator comprises a hydrocyclone apparatus.

74. The reactor assembly of any one of claims 71 to 73, whereby effluent circulating through the mechanical flow path travels between the first reactor tank and the first mechanical separator without passing through the electrical treatment reactor, and effluent circulating through the reactor circulation flow path travels between the first reactor tank and the electrical treatment reactor without passing through the first mechanical separator.

75. The reactor assembly of claim 74, further comprising a changeover apparatus operable to selectably direct the effluent through the mechanical flow path or the reactor circulation flow path.

76. The reactor assembly of any of claims 55 to 75, further including a balancing tank located upstream from the first reactor unit and having a balancing inlet configured to receive the effluent from the food production facility and a balancing outlet fluidly connected to the first reactor tank to transfer the effluent from the balancing tank to the first reactor tank.

77. The reactor assembly of any of claims 55 to 76, further comprising a second electrical treatment reactor provided in the reactor circulation flow path and operable to apply an electric charge to the effluent flowing through the second electrical treatment reactor.

78. The reactor assembly of any of claims 55 to 77 wherein the second electrical treatment reactor is fluidly connected in parallel with the first electrical treatment reactor.

79. The reactor assembly of any of claims 55 to 78, wherein the incoming effluent stream comprises at least one of organic and inorganic molecules and polymers, and wherein the first reactor unit is configured to convert these molecules via at least one of: electro-oxidation, electro-reduction, electro-flotation, electrocoagulation, electro-crystalization, and electrolysis.

80. The reactor assembly of any of claims 55 to 79, wherein the reactor assembly is configured to process at least 10 m³/d of effluent and covers an area of less than 9 m².

81. The reactor assembly of any of claims 55 to 80, wherein the liquid is subjected to the electrical charge while flowing from the liquid inlet to the liquid outlet.

82. The reactor assembly of any of claims 55 to 81, wherein liquid entering the reactor inlet travels in the axial direction and liquid exiting via the reactor outlet travels in a generally radial direction that is orthogonal to the reactor axis.

83. The reactor of claim 82, wherein the reactor outlet is provided in the sidewall.

84. The reactor assembly of any of claims 55 to 83, wherein when the treatment reactor is in use the reactor axis is inclined relative to a vertical direction by a reactor angle that is between about 20 degrees and about 70 degrees, and may be between about 30 and 60 degrees and may be 45 degrees.

85. The reactor assembly of any of claims 55 to 84, wherein when the treatment reactor is in use the reactor outlet is provided on a generally upward facing portion of the reactor.

86. The reactor assembly of any of claims 55 to 85, wherein the reactor axis intersects the reactor inlet and is spaced apart from the reactor outlet.

87. The reactor assembly of any of claims 55 to 86, further comprising a lid removably mounted to the upper end of the housing, and wherein the galvanic cell has a proximate end mounted to an inner surface of the lid and an axially opposing distal end, whereby when the lid is mounted to the upper end the galvanic cell is suspended within the housing and the distal end is spaced apart from the lower end of the housing, and when the lid is removed from the housing the galvanic cell is removed from the housing.

88. The reactor assembly of any of claims 55 to 87, wherein the galvanic cell is removable from the housing while preserving fluid communication between the reactor inlet and reactor outlet.

89. The reactor assembly of any of claims 55 to 88, wherein the cathode assembly further comprises an axially extending central cathode rod positioned within the cathode sleeve, wherein the anode rods are disposed laterally between the central cathode rod and the cathode sleeve.

90. The reactor of claim 89, wherein anode rods have an anode length in the axial direction, and wherein the central cathode rod has a cathode length that is greater than the anode length.

91. The reactor of any one of claim 89 or 90, wherein the galvanic cell comprises a flow directing surface which, when the galvanic cell is mounted to the housing, faces the reactor inlet to and is configured to direct the flow of liquid entering the reactor inlet into cathode sleeve.

92. The reactor of claim 91, wherein the flow directing surface comprises a generally convex, dome-shaped tip of the central cathode rod.

93. The reactor of claim 91 or 92, wherein the flow directing surface is axially spaced between the anode rods and a lower end of the cathode sleeve.

94. The reactor of any one of claims 55 to 93, wherein the galvanic cell is configured so that liquid flowing through the housing travels substantially axially from the reactor inlet to the reactor outlet.

95. The reactor of any one of claims 55 to 94, wherein the at least one elongate, axially extending anode rod is solid.

96. The reactor of any one of claims 55 to 95, wherein the sidewall comprises an upper portion having a generally constant cross-sectional area and a tapered portion disposed toward the lower end and generally expanding from the reactor inlet toward the upper portion.

97. The reactor of any one of claims 55 to 96, wherein the reactor angle is between about 30 and 60 degrees and may be 45 degrees.

98. The reactor assembly of any of claims 55 to 97, wherein the galvanic cell comprises a flow directing surface which, when the galvanic cell is mounted to the housing, faces the reactor inlet to and is configured to direct the flow of liquid entering the reactor inlet into cathode sleeve.

99. The reactor assembly of any of claim 98, wherein the flow directing surface is removable from the housing with the lid and galvanic cell.

100. The reactor assembly of any of claims 55 to 99, wherein the cathode assembly further comprises an axially extending central cathode rod positioned within the cathode sleeve, wherein the anode rods are disposed laterally between the central cathode rod and the cathode sleeve, and the flow directing surface comprises a generally convex, dome-shaped tip of the central cathode rod.

101. The reactor of any one of claims 98 to 100, wherein the flow directing surface is axially spaced between the anode rods and a lower end of the cathode sleeve.

102. The reactor of any one of claims 87 to 101, wherein the lid and galvanic cell are removable by translating in the axial direction.

103. The reactor assembly of any of claims 55 to 102, further comprising a second galvanic cell connected to an inner surface of a second lid that is configured to replace the lid and galvanic cell and is mountable to seal the upper end of the housing.

104. The reactor assembly of any of claims 55 to 103, wherein the housing is configured to retain a quantity of liquid while the lid and galvanic cell are removed from the housing.

105. A liquid treatment reactor, comprising:
a) a housing having a lower end, an upper end spaced apart from the lower end along a reactor axis, and a sidewall extending therebetween;
b) a reactor inlet provided toward the lower end through which a liquid can enter the housing;
c) a reactor outlet provided toward the upper end through which the liquid can exit the housing, whereby the liquid flows generally axially through the housing from the lower end to the upper end; and
d) a galvanic cell positionable at least partially axially between the reactor inlet and the reactor outlet within the housing to subject the liquid within the housing to an electrical charge, the galvanic cell comprising an elongate, axially extending cathode assembly and an anode assembly including at least one elongate, axially extending anode rod that is positioned generally parallel to and laterally spaced apart from the cathode assembly, wherein the anode assembly is at least partially consumed when the reactor is in use.

106. The reactor of claim 105, wherein the liquid is subjected to the electrical charge while flowing from the liquid inlet to the liquid outlet.

107. The reactor of claim 105 or 106, wherein liquid entering the reactor inlet travels in the axial direction and liquid exiting via the reactor outlet travels in a generally radial direction that is orthogonal to the reactor axis.

108. The reactor of claim 107, wherein the reactor outlet is provided in the sidewall.

109. The reactor of any one of claims 105 to 108, wherein when the treatment reactor is in use the reactor axis is inclined relative to a vertical direction by a reactor angle that is between about 20 degrees and about 70 degrees, and may be between about 30 and 60 degrees and may be 45 degrees.

110. The reactor of claim 109, wherein when the treatment reactor is in use the reactor outlet is provided on a generally upward facing portion of the reactor.

111. The reactor of any one of claims 105 to 110, wherein the reactor axis intersects the reactor inlet and is spaced apart from the reactor outlet.

112. The reactor of any one of claims 105 to 111, further comprising a lid removably mounted to the upper end of the housing, and wherein the galvanic cell has a proximate end mounted to an inner surface of the lid and an axially opposing distal end, whereby when the lid is mounted to the upper end the galvanic cell is suspended within the housing and the distal end is spaced apart from the lower end of the housing, and when the lid is removed from the housing the galvanic cell is removed from the housing.

113. The reactor of any one of claims 105 to 112, wherein the galvanic cell is removable from the housing while preserving fluid communication between the reactor inlet and reactor outlet.

114. The reactor of any one of claims 105 to 113, wherein the anode assembly comprises a plurality of axially extending anode rods laterally spaced apart from each other and wherein the cathode assembly comprises an axially extending cathode sleeve laterally surrounding the anode rods, the cathode sleeve having an open lower end comprising a sleeve liquid inlet that is in fluid communication with the reactor inlet and an upper end having a sleeve liquid outlet that it is in fluid communication with the reactor outlet, whereby the liquid flows through the cathode sleeve and along the length of the anode rods when the reactor is in use.

115. The reactor of claim 114, wherein the cathode assembly further comprises an axially extending central cathode rod positioned within the cathode sleeve, wherein the anode rods are disposed laterally between the central cathode rod and the cathode sleeve.

116. The reactor of claim 115, wherein anode rods have an anode length in the axial direction, and wherein the central cathode rod has a cathode length that is greater than the anode length.

117. The reactor of any one of claim 115 or 116, wherein the galvanic cell comprises a flow directing surface which, when the galvanic cell is mounted to the housing, faces the reactor inlet to and is configured to direct the flow of liquid entering the reactor inlet into cathode sleeve.

118. The reactor of claim 117, wherein the flow directing surface comprises a generally convex, dome-shaped tip of the central cathode rod.

119. The reactor of claim 117 or 118, wherein the flow directing surface is axially spaced between the anode rods and a lower end of the cathode sleeve.

120. The reactor of any one of claims 105 to 119, wherein the galvanic cell is configured so that liquid flowing through the housing travels substantially axially from the reactor inlet to the reactor outlet.

121. The reactor of any one of claims 105 to 120, wherein the at least one elongate, axially extending anode rod is solid.

122. The reactor of any one of claims 105 to 121, wherein the sidewall comprises an upper portion having a generally constant cross-sectional area and a tapered portion disposed toward the lower end and generally expanding from the reactor inlet toward the upper portion.

123. A liquid treatment reactor, comprising:
a) a housing having a lower end, an upper end spaced apart from the lower end along a reactor axis, and a sidewall extending therebetween, and when the treatment reactor is in use the reactor axis is inclined relative to a vertical direction by a reactor angle that is between about 20 degrees and about 70 degrees,
b) a reactor inlet through which a liquid can enter the housing in a first flow direction, the reactor inlet being provided at the lower end and being intersected by the reactor axis;
c) a reactor outlet through which the liquid can exit the housing in a second flow direction that is different than the first flow direction, the reactor outlet provided toward the upper end and in a portion of the sidewall that is, when the treatment reactor is in use, generally upwardly facing; and
d) a galvanic cell positionable at least partially axially between the reactor inlet and the reactor outlet within the housing to subject the liquid within the housing to an electrical charge.

124. The reactor of claim 123, wherein the liquid is subjected to the electrical charge while flowing from the liquid inlet to the liquid outlet.

125. The reactor of claim 123 or 124, wherein liquid entering the reactor inlet travels in the axial direction and liquid exiting via the reactor outlet travels in a generally radial direction that is orthogonal to the reactor axis.

126. The reactor of any one of claims 123 to 125, further comprising a lid removably mounted to the upper end of the housing, and wherein the galvanic cell has a proximate end mounted to an inner surface of the lid and an axially opposing distal end, whereby when the lid is mounted to the upper end the galvanic cell is suspended within the housing and the distal end is spaced apart from the lower end of the housing, and when the lid is removed from the housing the galvanic cell is removed from the housing.

127. The reactor of any one of claims 123 to 126, wherein the galvanic cell is removable from the housing while maintaining fluid connections at the reactor inlet and reactor outlet.

128. The reactor of any one of claims 123 to 127, wherein the anode assembly comprises a plurality of axially extending anode rods laterally spaced apart from each other and wherein the cathode assembly comprises an axially extending cathode sleeve laterally surrounding the anode rods, the cathode sleeve having an open lower end comprising a sleeve liquid inlet that is in fluid communication with the reactor inlet and an upper end having a sleeve liquid outlet that it is in fluid communication with the reactor outlet, whereby the liquid flows through the cathode sleeve and along the length of the anode rods when the reactor is in use.

129. The reactor of claim 128, wherein the cathode assembly further comprises an axially extending central cathode rod positioned within the cathode sleeve, wherein the anode rods are disposed laterally between the central cathode rod and the cathode sleeve.

130. The reactor of claim 129, wherein anode rods have an anode length in the axial direction, and wherein the central cathode rod has a cathode length that is greater than the anode length.

131. The reactor of any one of claim 129 or 130, wherein the galvanic cell comprises a flow directing surface which, when the galvanic cell is mounted to the housing, faces the reactor inlet and is configured to direct the flow of liquid entering the reactor inlet into cathode sleeve.

132. The reactor of claim 131, wherein the flow directing surface comprises a generally convex, dome-shaped tip of the central cathode rod.

133. The reactor of claim 131 or 132, wherein the flow directing surface is axially spaced between the anode rods and a lower end of the cathode sleeve.

134. The reactor of any one of claims 123 to 133, wherein the galvanic cell is configured so that liquid flowing through the housing travels substantially axially from the reactor inlet to the reactor outlet.

135. The reactor of any one of claims 123 to 134, wherein the at least one elongate, axially extending anode rod is solid.

136. The reactor of any one of claims 123 to 135, wherein the sidewall comprises an upper portion having a generally constant cross-sectional area and a tapered portion disposed toward the lower end and generally expanding from the reactor inlet toward the upper portion.

137. The reactor of any one of claims 123 to 136, wherein the reactor angle is between about 30 and 60 degrees and may be 45 degrees.

138. A liquid treatment reactor, comprising:
a) a housing having a closed lower end, an open upper end spaced apart from the lower end along a reactor axis, and a sidewall extending therebetween
b) a reactor inlet through which a liquid can enter the housing in a first flow direction, the reactor inlet being provided toward the lower end;
c) a reactor outlet through which the liquid can exit the housing in a second flow direction that is different than the first flow direction, the reactor outlet provided in a portion of the sidewall that is, when the treatment reactor is in use, generally upwardly facing;
d) a lid removably mounted to the housing and having an inner surface such that, when the lid is mounted to the housing, the lid seals the upper end and the inner surface faces the reactor inlet; and
e) a galvanic cell positionable at least partially axially between the reactor inlet and the reactor outlet within the housing to subject the liquid within the housing to an electrical charge, the galvanic cell comprising a plurality of elongate anode rods that extend generally axially from the inner surface of the lid and are laterally spaced apart from each other, and a cathode sleeve extending axially from the inner surface and laterally surrounding the anode rods, whereby when the lid is mounted to the upper end the galvanic cell is suspended within the housing and cathode sleeve and anode rods are spaced apart from the lower end of the housing, and when the lid is removed from the housing the galvanic cell is removed from the housing, and wherein the lid and galvanic cell are removable from the housing while maintaining fluid connections at the reactor inlet and reactor outlet.

139. The reactor of claim 138, wherein the galvanic cell comprises a flow directing surface which, when the galvanic cell is mounted to the housing, faces the reactor inlet to and is configured to direct the flow of liquid entering the reactor inlet into cathode sleeve.

140. The reactor of claim 139, wherein the flow directing surface is removable from the housing with the lid and galvanic cell.

141. The reactor of claim 139 or 140, wherein the cathode assembly further comprises an axially extending central cathode rod positioned within the cathode sleeve, wherein the anode rods are disposed laterally between the central cathode rod and the cathode sleeve, and the flow directing surface comprises a generally convex, dome-shaped tip of the central cathode rod.

142. The reactor of any one of claims 139 to 141, wherein the flow directing surface is axially spaced between the anode rods and a lower end of the cathode sleeve.

143. The reactor of any one of claims 138 to 142, wherein the lid and galvanic cell are removable by translating in the axial direction.

144. The reactor of any one of claims 138 to 143, further comprising a second galvanic cell connected to an inner surface of a second lid that is configured to replace the lid and galvanic cell and is mountable to seal the upper end of the housing.

145. The reactor of any one of claims 138 to 144, wherein the housing is configured to retain a quantity of liquid while the lid and galvanic cell are removed from the housing.

146. The reactor of any one of claims 138 to 145, further comprising a sludge removal apparatus fluidly connected to a lower end of the first reactor tank to extract sludge from the lower end of the first reactor tank.

147. The reactor of any one of claims 138 to 146, wherein the incoming effluent stream comprises at least one of organic molecules and inorganic molecules and polymers and wherein the first reactor unit is configured to convert these molecules via at least one of: electro-oxidation, electro-reduction, electro-flotation, electrocoagulation, electro-crystalization, and electrolysis.

148. The reactor of any one of claims 138 to 147, wherein the reactor is configured to process at least 10 m³/d of effluent and covers an area of less than 9 m².

149. The reactor of any one of claims 138 to 148, wherein the electrical treatment cycle has a duration of about 15 minutes.

150. The reactor of any one of claims 138 to 149, further comprising a first mechanical separator configured to separate solid particles from the liquid flowing through the mechanical separator, the first mechanical separator being fluidly connected to the tank wherein when the reactor assembly is in use liquid selectably travels through a mechanical separation flow path in which liquid is drawn from the tank, flows through the first mechanical separator and then returns to the tank.

151. The reactor assembly of claim 150, wherein the first mechanical separator comprises at least one hydrocyclone configured to separate solid particles from the liquid.

152. The reactor assembly of claim 150, wherein the liquid circulates through the mechanical separation flow path at least twice.

153. The reactor of any one of claims 138 to 152, wherein the electrical charge is applied to the liquid while it is flowing through the housing.

154. The reactor of any one of claims 138 to 153, wherein the reactor assembly covers an area of less than about 1 square meters and is operable to treat at least 10 m³/d of liquid from the source.

155. The reactor of any one of claims 138 to 154, wherein the liquid is subjected to the electrical charge while flowing from the liquid inlet to the liquid outlet.

156. The reactor of any one of claims 138 to 155, wherein liquid entering the reactor inlet travels in the axial direction and liquid exiting via the reactor outlet travels in a generally radial direction that is orthogonal to the reactor axis.

157. The reactor of claim 156, wherein the reactor outlet is provided in the sidewall.

158. The reactor of any one of claims 138 to 157, wherein when the treatment reactor is in use the reactor axis is inclined relative to a vertical direction by a reactor angle that is between about 20 degrees and about 70 degrees, and may be between about 30 and 60 degrees and may be 45 degrees.

159. The reactor of claim 158, wherein when the treatment reactor is in use the reactor outlet is provided on a generally upwardly facing portion of the reactor.

160. The reactor of any one of claims 138 to 159, wherein the reactor axis intersects the reactor inlet and is spaced apart from the reactor outlet.

161. The reactor of any one of claims 105 to 160, further comprising a lid removably mounted to the upper end of the housing, and wherein the galvanic cell has a proximate end mounted to an inner surface of the lid and an axially opposing distal end, whereby when the lid is mounted to the upper end the galvanic cell is suspended within the housing and the distal end is spaced apart from the lower end of the housing, and when the lid is removed from the housing the galvanic cell is removed from the housing.

162. The reactor of any one of claims 105 to 161, wherein the galvanic cell is removable from the housing while preserving fluid communication between the reactor inlet and reactor outlet.

163. The reactor of any one of claims 105 to 162, wherein the anode assembly comprises a plurality of axially extending anode rods laterally spaced apart from each other and wherein the cathode assembly comprises an axially extending cathode sleeve laterally surrounding the anode rods, the cathode sleeve having an open lower end comprising a sleeve liquid inlet that is in fluid communication with the reactor inlet and an upper end having a sleeve liquid outlet that it is in fluid communication with the reactor outlet, whereby the liquid flows through the cathode sleeve and along the length of the anode rods when the reactor is in use.

164. The reactor of claim 163, wherein the cathode assembly further comprises an axially extending central cathode rod positioned within the cathode sleeve, wherein the anode rods are disposed laterally between the central cathode rod and the cathode sleeve.

165. The reactor of claim 164, wherein anode rods have an anode length in the axial direction, and wherein the central cathode rod has a cathode length that is greater than the anode length.

166. The reactor of any one of claim 164 or 165, wherein the galvanic cell comprises a flow directing surface which, when the galvanic cell is mounted to the housing, faces the reactor inlet to and is configured to direct the flow of liquid entering the reactor inlet into cathode sleeve.

167. The reactor of claim 166, wherein the flow directing surface comprises a generally convex, dome-shaped tip of the central cathode rod.

168. The reactor of claim 166 or 167, wherein the flow directing surface is axially spaced between the anode rods and a lower end of the cathode sleeve.

169. The reactor of any one of claims 138 to 168, wherein the galvanic cell is configured so that liquid flowing through the housing travels substantially axially from the reactor inlet to the reactor outlet.

170. The reactor of any one of claims 138 to 169, wherein the at least one elongate, axially extending anode rod is solid.

171. The reactor of any one of claims 138 to 170, wherein the sidewall comprises an upper portion having a generally constant cross-sectional area and a tapered portion disposed toward the lower end and generally expanding from the reactor inlet toward the upper portion.

172. The reactor of claim 171, wherein the liquid is subjected to the electrical charge while flowing from the liquid inlet to the liquid outlet.

173. The reactor of claim 171 or 172, wherein liquid entering the reactor inlet travels in the axial direction and liquid exiting via the reactor outlet travels in a generally radial direction that is orthogonal to the reactor axis.

174. The reactor of any one of claims 138 to 173, wherein the cathode assembly further comprises an axially extending central cathode rod positioned within the cathode sleeve, wherein the anode rods are disposed laterally between the central cathode rod and the cathode sleeve.

175. The reactor of claim 174, wherein anode rods have an anode length in the axial direction, and wherein the central cathode rod has a cathode length that is greater than the anode length.

176. The reactor of any one of claims 138 to 175, wherein the galvanic cell comprises a flow directing surface which, when the galvanic cell is mounted to the housing, faces the reactor inlet and is configured to direct the flow of liquid entering the reactor inlet into cathode sleeve.

177. The reactor of claim 176, wherein the flow directing surface comprises a generally convex, dome-shaped tip of the central cathode rod.

178. The reactor of claim 176 or 177, wherein the flow directing surface is axially spaced between the anode rods and a lower end of the cathode sleeve.

179. The reactor of any one of claims 138 to 178, wherein the galvanic cell is configured so that liquid flowing through the housing travels substantially axially from the reactor inlet to the reactor outlet.

180. The reactor of any one of claims 138 to 179, wherein the at least one elongate, axially extending anode rod is solid.

181. The reactor of any one of claims 138 to 180, wherein the sidewall comprises an upper portion having a generally constant cross-sectional area and a tapered portion disposed toward the lower end and generally expanding from the reactor inlet toward the upper portion.

182. A process for treating a liquid, the process including:
a) receiving an incoming stream of liquid from a source in a reactor tank;
b) performing an electrical treatment sub-cycle including circulating the liquid between the reactor tank and an electrical treatment reactor at least twice, the electrical treatment reactor configured to subject the liquid to a first treatment process in which an electrical charge is applied to the liquid the convert the incoming stream of liquid into a partially treated stream;
c) receiving the partially treated stream in a second processing unit and subjecting the partially treated stream to a different, second treatment process to convert the partially treated stream to a treated outlet stream.

183. The process of claim 182, wherein step b) comprises passing the liquid generally upwardly through the electrical treatment reactor whereby reaction products created by exposure to the electrical charge are carried from the electrical treatment reactor into the reactor tank.

184. The process of claim 182, wherein the electrical treatment reactor has an axially extending housing extending in a direction of liquid flow through the electrical treatment reactor, at least one elongate axially extending cathode and at least one elongate axially extending anode rod positioned adjacent the cathode, and wherein the at anode rod is at least partially consumed during the electrical treatment sub-cycle.

185. The process of claim 182, wherein the electrical treatment sub-cycle lasts at least 10 minutes, and/or includes at least 2 circulations through the electrical treatment reactor.

186. The process of any one of claims 182 to 185, further comprising extracting sludge that has accumulated during the electrical treatment sub-cycle from the reactor tank.

187. The process of any one of claims 182 to 186, further comprising performing a mechanical separation sub-cycle prior to performing the electrical treatment sub-cycle, the mechanical separation sub-cycle including circulating the incoming stream of liquid through at least a first mechanical separation unit that is configured to extract physical particles from the liquid at least twice.

188. The process of claim 187, further comprising performing the mechanical separation sub-cycle after performing the electrical treatment sub-cycle and before the partially treated stream is received by the second processing unit.

189. The process of claim 188, wherein the partially treated stream is re-circulated through the first mechanical separation unit at least twice before being received by the second processing unit

190. The process of any one of claims 182 to 189, wherein the second treatment process comprises subjecting the partially treated stream to at least one of aerobic and anaerobic digestion.

191. The process of claim 190, further comprising circulating the partially treated stream between a second holding tank and at least a first biological reactor in fluid communication with the second holding tank via a bio flow path.

192. The process of claim 191, wherein the partially treated stream is circulated through the bio flow path at least twice before being discharged as the treated output stream.

193. A process for removing phosphorus from surface water, the process including:
a) receiving an incoming stream of liquid from a source in a reactor tank;
b) performing an electrical treatment sub-cycle lasting at least 5 minutes which includes circulating the liquid between the reactor tank and an electrical treatment reactor at least twice, the electrical treatment reactor configured to subject the liquid to a first treatment process in which an electrical charge is applied to the liquid to convert the incoming stream of liquid into a partially treated stream;
c) receiving the partially treated stream in a second processing unit and subjecting the partially treated stream to a different, second treatment process to convert the partially treated stream to a treated outlet stream.

194. The process of claim 193, wherein step b) comprises passing the liquid generally upwardly through the electrical treatment reactor whereby reaction products created by exposure to the electrical charge are carried from the electrical treatment reactor into the reactor tank.

195. The process of claim 193 or 194, wherein the electrical treatment reactor has an axially extending housing extending in a direction of liquid flow through the electrical treatment reactor, at least one elongate axially extending cathode and at least one elongate axially extending anode rod positioned adjacent the cathode, and wherein the anode rod is at least partially consumed during the electrical treatment sub-cycle.

196. The process of any one of claims 193 to 195, further comprising extracting sludge that has accumulated during the electrical treatment sub-cycle from the reactor tank.

197. The process of any one of claims 193 to 196, further comprising performing a mechanical separation sub-cycle prior to or after performing the electrical treatment sub-cycle, the mechanical separation sub-cycle including circulating the incoming stream of liquid through at least a first mechanical separation unit that is configured to extract physical particles from the liquid.

198. The process of any one of claims 193 to 197, wherein the second treatment process comprises subjecting the partially treated stream to at least one of a sterilization and a pH correction process.
